(19) United States
(12) Patent Application Publication
(10) Pub. No.: US 2026/0330268 A1
(43) Pub. Date: Oct. 22, 2026

(54) ARTIFICIAL INTELLIGENCE AGENTIC PLATFORM

(71) Applicant: Purdue Research Foundation, West Lafayette, IN (US)

(72) Inventors: Gaurav Chopra, West Lafayette, IN (US); Matthew Muhoberac, Indianapolis, IN (US)

(73) Assignee: Purdue Research Foundation, West Lafayette, IN (US)

(21) Appl. No.: 19/458,491

(22) Filed: Jan. 23, 2026

Related U.S. Application Data
(60) Provisional application No. 63/751,174, filed on Jan. 29, 2025.

(51) Int. Cl. G06N 5/043

(52) U.S. Cl. CPC G06N 5/043

(57) ABSTRACT

An artificial intelligence (AI) agentic platform includes a processor executing software a non-transient memory, the processor configured to establish a plurality of AI agents adapted to receive a query related to a task from an external entity, establish a hierarchy amongst the agents, identify a plurality of sub-tasks in service of performing the task, assign an agent to each sub-task, each agent identifies one or more tools to accomplish the associated sub-task, identify states within each sub-task, apply a finite state automaton-based memory management to the identified states for a deterministic state tracking, generate an output by each agent assigned to an associated sub-task, and benchmark each agent based on the associated generated output, the tool identification, and a path the associated agent took amongst the identified states within said sub-task.

### CROSS-REFERENCE TO RELATED APPLICATIONS

The present non-provisional patent application is related to and claims the priority benefit of U.S. Provisional Patent Application Ser. No. 63/751,174, filed Jan. 29, 2025, the contents of each of which are hereby incorporated by reference in its entirety into the present disclosure.

### GOVERNMENT SUPPORT CLAUSE

This invention was made with government support under 5U18TR004146 awarded by the National Institutes of Health. The government has certain rights in the invention.

### TECHNICAL FIELD

The present disclosure generally relates to an artificial intelligence (AI) based toolsets, and in particular to an AI system that can communicate with a client, whether a human or a computer-based system, via large language models (LLMs).

### BACKGROUND

This section introduces aspects that may help facilitate a better understanding of the disclosure. Accordingly, these statements are to be read in this light and are not to be understood as admissions about what is or is not prior art.

An Artificial Intelligence (AI) agent is a software-based package that operates autonomously or semi-autonomously based on its perception of an associated environment. It can plan, execute those plans, to respond to queries and even take actions in pursuit of achieving goals. AI agents use large language models (LLMs) and other tools to achieve their goals and tasks. In a way, an AI agent is akin to a digital agent capable of accomplishing complex tasks. AI agents can offer scientists a robust framework for integrating commonly used instrumental and computational endpoints with operational AI, streamlining and accelerating the process of scientific discovery. To fully grasp how these agents are constructed, how they function, and the advantages they bring, it is essential to delve into the foundational logic center of the agent which are LLMs. Recent advancements in Natural Language Processing (NLP) have ushered in a new era of human-AI interaction with the emergence of powerful LLMs like the Generative Pre-trained Transformer (GPT) series. These models include the GPT series (GPT-3.5, GPT-4, and GPT-40), Gemini, LlaMa, PaLM, and others. Models undergo pre-training on extensive text datasets on a diverse range of topics, showcasing remarkable proficiency across an array of NLP tasks, spanning language translation, text generation, text summarization, text correction, text reformatting, code generation, and question-answering. The primary advantage of large language models (LLMs) over traditional NLP architectures lies in their ability to maintain semantic coherence when processing extensive amounts of text across various topics and generating relevant responses. With their large context windows, LLMs can chain request-response pairs within a single prompt, allowing them to generate answers that consider previous interactions—this concept is known as an LLM chain. To expand an LLM's domain knowledge, fine-tuning, or modifying the model's initial weights using targeted datasets, has emerged as an effective approach. Additionally, LLM prompts can be enhanced with external information, such as search engine results or database queries, through a process called retrieval-augmented generation (RAG) The versatility and effectiveness of LLMs are notable across various domains, including education, healthcare, reasoning tasks, text and code generation, human-machine interaction, and scientific research. However, certain studies have highlighted limitations of the model, such as its tendency to rely heavily on biases introduced by training data and its lack of detailed knowledge on specific topics. One such study investigated ChatGPT's performance on four real exams at the University of Minnesota Law School. Its findings highlighted the model's shortcomings in answering multiple choice questions, its inability to accurately quote regulations, and instances of generating incorrect regulations when prompted (hallucination). These limitations indicate that the model lacks the depth of understanding characteristic of a specialist, necessitating cautious use. Similar conclusions emerged from assessments of ChatGPT's performance in healthcare education. While the model exhibited moderate proficiency on the United States Medical Examination (USMLE), enabling it to pass the exam, it demonstrated poor performance when confronted with specialized questions regarding cardiovascular diseases. To attempt to remedy these hallucinations, certain models have been tailored to specific fields such as BioGPT and ChemGPT, which have been fine-tuned on biological and chemical data respectively. Another model tailored to chemistry is ChemDFM, an LLM trained on chemical literature, textbooks, instructions, and various general domain data. This model outperformed open-source LLMs on general chemistry questions but failed to resolve questions about recent findings in the field of chemistry. Additionally, despite intensive training the model isn't familiar with various informative modalities in chemistry, such as molecular graphs and spectroscopies, demonstrating the limitations of specialized LLMs due to the rigidity of their knowledge. In a more dynamic approach, Retrieval Augmented Generation (RAG) has been explored as a LLM information augmentation technique in scientific applications such as work shown in BioRAG, which uses a RAG based framework that dynamically selects data sources to augment LLM prompts in the field of biology. While this approach is more dynamic than using LLMs alone and shows notable improvements, the data sources are fixed, search engines are included, and augmentation is done in a non-exploratory manner.

While these examples demonstrate the generative capabilities of large language models (LLMs) across diverse topics, they also reveal several key challenges, including limited planning ability, hallucination, and a static knowledge base. Planning poses a significant issue for LLMs, partly due to their inherent lack of dynamic operational capabilities. Essentially, LLMs are static models not designed to execute tasks, so when asked to plan, they do not reason through operational complexities as a human would. This limitation is closely related to the phenomenon of hallucination, which arises from an incomplete understanding or representation of specific topics. Furthermore, the prevalence of hallucination varies across applications, largely due to a lack of transparency regarding the underlying data used for model training. To add on top of this issue, the language model being a static entity requires retraining or fine-tuning as the collective knowledge base of the world is enhanced. Retraining and tuning are resource heavy processes that require extensive training data, graphics processing unit (GPU) hardware, and time. Finally, RAG-based approaches allow for information to be retrieved outside of domain knowledge, but when paired with an LLM alone, the retrieval process is highly static and not approached in an exploratory manner. It also could pose scalability issues as more and more data sources are included in augmentation.

Therefore, there remains an unmet need for a novel method and system that can harness the semantic coherence capabilities offered by LLMs while dynamically augmenting their knowledge base in a robust and scalable manner. Additionally, there remains an unmet need for said system and said method to integrate LLMs to use the knowledge they possesses to interact with the real world in a directed manner to plan and accomplish a wide range of tasks at various levels of abstraction.

### SUMMARY

An artificial intelligence (AI) agentic platform is disclosed. The platform includes a processor executing software a non-transient memory. The processor is configured to establish a plurality of AI agents. The plurality of AI agents are adapted to receive a query related to a task from an external entity, establish a hierarchy amongst the plurality of agents for accomplishing the task, identify a plurality of sub-tasks to be performed by each agent of the plurality of agents in service of performing the task, assign an agent of the plurality of agents to each sub-task of the plurality of sub-tasks, each agent identifies one or more tools to accomplish the associated sub-task, identify states within each sub-task of the plurality of sub-tasks, apply a finite state automaton-based memory management to the identified states for a deterministic state tracking, generate an output by each agent assigned to an associated sub-task, and benchmark each agent based on the associated generated output, the tool identification, and a path the associated agent took amongst the identified states within said sub-task.

### BRIEF DESCRIPTION OF FIGURES

FIGS. 1a-1e collectively provide a schematic of the concept of an LLM integrated AI agent, specifically, FIG. 1a provides a schematic of the core internal infrastructure of an agent including a command parser, toolkit, dynamic prompt, and set of memory buffers, FIG. 1b is a schematic showing the agent's tools' programmatic functions which interact with external services where the agent is generally aware of the input format, scope, and expected output format of the tool, FIG. 1c is a schematic which shows how the language model provides the agent with the ability to process complex requests by utilizing its domain knowledge, analyzing the dynamic prompt augment with requests, tools, and memory, and formatting output for the command parser to operationalize its thoughts, FIG. 1d is a schematic of the agent's memory which is generally comprised of a buffer or set of buffers which are designed to save specific agentic outputs for future use, and FIG. 1e is a schematic of external entities that are presented to the agent as tools, but they differ from tools as the agent is generally told to call upon them for direction, clarification, or action that is outside the current scope of the agent.

FIGS. 2a-2c provide schematics of an integration of supplementary LLMs chains in agentic construction and operation according to the present disclosure, specifically, FIG. 2a is a schematic of LLM chains which can supplement agentic requests with high-level workflow planning without overhead of operational formatting, FIG. 2b is a schematic of LLM chains which act as tools and can supplement an agent's prompt with knowledge from external document embeddings, and FIG. 2c is a schematic of LLM chains which are used to build core infrastructure components dynamically at runtime including parameters, commands, microservices, etc.

FIGS. 3a-3d provide schematics of AI agent components according to the present disclosure, specifically, FIG. 3a is a schematic which shows tools both inside and outside the contextual scope of the agent, FIG. 3b is a schematic which shows the agent's iterative thought-action-observation (TAO) process controlled by the LLM and used to explore the problem space, FIG. 3c is a schematic which shows the manner in which the agent prompt is dynamically augmented by specific entities relating to the service and state of the service, and FIG. 3d is a schematic which shows the agent's state-based memory which is updated at the termination of the iterative TAO process by using an LLM chain to analyze the action log and update the state in a controlled manner.

FIGS. 4a-4c provide schematics that show agentic benchmarking, specifically, FIG. 4a is a schematic which shows an output-based benchmarking which takes an agentic output at the conclusion of its iterative operation and compares it to a string, regular expression or validation schema, FIG. 4b is schematic which shows a state-based benchmarking which access the final state of a system which the agent interacts with after operation and compares it to a schema representing the desired state; and FIG. 4c is schematic which shows a path-based benchmarking which takes the agents action path after operation and compares the actions and action inputs with the desired path.

FIGS. 5a-5d provide an overview of the physical/virtual instrument paradigm implemented for a microwave synthesize and presented to planning chains and operational agents to test AI driven microwave synthesis, specifically, FIG. 5a provides the command library of the virtual instrument which will be transferred to physical instrumentation once future modifications are finished, FIG. 5b provides the FSA schema of the microwave synthesizer which is edited as the agent operates the instrument, FIG. 5c provides the benchmark n-alkylation reaction which was planned and run on an physical Initiator+ using a two pass AI planning chain and static worklist executor, and FIG. 5d provides a diagram of how FSA based memory is updated using the schema with defined transition rules.

FIGS. 6a-6i collectively provide a schematic overview of the PubChem REST API and integrated AI agent, pecifically, FIG. 6a the core structure of the API URL which is used in custom functions to access relevant data from different sections of the PubChem database, FIG. 6b provides the initial request provided to the agent, FIG. 6c provides the first thought the agent has, FIG. 6d provide the first action the agent takes, FIG. 6e provides the first observation the agent makes, FIG. 6f provides the second thought the agent has based on FIG. 6e, FIG. 6g provides the second action the agent takes, FIG. 6h provides the second observation the agent makes, and FIG. 6i provides the final output of the agent after additional iterations (not shown) were performed.

FIG. 7 is a diagram providing an example of how agents operate via the commonly used ReAct framework.

FIG. 8 provides an example of how FSA-based memory operates including augmentation of the AI agent's prompt with the current state of the agent (N) via the memory buffer, iterative operation by the AI agent which brings the agent from its current state (N) to a new state (N+1), generative AI based conversion of agents action path and corresponding observations to reflect that new state (N+1), and saving the new state (N+1) to the FSA-based memory buffer.

FIG. 9 provides a visualization of an operational command shown Table 42 being applied to selected elements of the schema shown in Table 41, discussed below.

FIG. 10 provides an overview schematic of the agentic benchmarking infrastructure including the initiator (identified as (a)) which defines the initial state of the agent and provided request, the executor (identified as (b)) which starts agentic operation with conditions defined in the initiator, the current iteration of agentic operation (identified as (c)), the objective logger (identified as (d)) which stores information which results from the current iteration of agentic operation, the objective comparer (identified as (e)) which runs comparison metrics between desired output and selected agentic output, the statistical logger (identified as (f)) which calculates statistics based on objective comparison metrics or agentic output, and the information logger (identified as (g)) which captures information during or as a result of agentic operation.

FIG. 11 provides an example of a structure of the dynamic base prompt template used for making SciBORG Agents.

FIG. 12 is an example of a processing system that can carry out the processes discussed in the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 15%, within 10%, within 5%, or within 1% of a stated value or of a stated limit of a range.

In the present disclosure, the term “substantially” can allow for a degree of variability in a value or range, for example, within 85%, within 90%, within 95%, or within 99% of a stated value or of a stated limit of a range.

A novel method and system are disclosed herein that can harness the semantic coherence capabilities offered by large language models (LLMs) while dynamically augmenting their knowledge base in a robust and scalable manner. Additionally, said system and said method are adapted to integrate LLMs to use the knowledge they possess to interact with the real world in a directed manner to plan and accomplish a wide range of tasks at various levels of abstraction. Towards this end, a novel system is disclosed herein referred to as Scientific Bespoke Artificial Intelligence Agents Optimized for Research Goals (or SciBORG) which is an agentic framework designed to meet above-enumerated unmet needs by providing a task and a system with an agnostic infrastructure which can rapidly build exploratory agents from source code documentation that can dynamically access information outside of the LLM's domain of knowledge, operate real-world instrumentation and software, and accurately keep track of system state in a directed and concise manner using state-based memory.

Given the limitations of planning, hallucination, and static domain knowledge in LLMs, there is a pressing need to develop LLM-based applications that can acquire and retain targeted information beyond the model's initial knowledgebase to efficiently address specific tasks. An AI agent serves as an exploratory entity, powered by AI, and is designed to perform tasks or interact with users in an iterative, goal-directed manner. These agents operate autonomously or semi-autonomously, leveraging the LLM to decide on actions at any given moment based on the tools available, their domain knowledge, and both current and prior interactions.

By storing previous actions or interactions in agent memory, these systems can retain contextual information, enhancing their ability to engage effectively over time. The main category of AI Agents that are the focus of this work is LLM-based agents, which are agents integrated with LLMs to serve as their logical processing and decision-making center. LLM-based agents exhibit several core functions, which include but are not limited to Information retrieval, natural language understanding and generation, automation of repetitive tasks and personalization based on user requirements, tasks and preferences, these agents are used extensively in developing chatbots for applications including customer service, education, and healthcare. In all these sectors, LLM-based agents have been shown to improve the efficiency, scalability, consistency, and accessibility of services. Based on the task, an agent can integrate with a diverse set of LLMs that can power human language interpretation, decision making, targeted information augmentation, and generative output. We classify LLMs into the following categories: 1) General Purpose LLMs: These LLMs are designed to perform a wide range of tasks without being specialized for any application. They are versatile and can handle various natural language processing (NLP) tasks such as text generation, summarization, translation, and question-answering. Examples include GPT-4, BERT, and LLaMa. These models are good general candidates for logically powering agents decision-making capabilities. 2) Specialized Models: Specialized LLMs, such as BioBERT, BioGPT, LegalBert, ChemGPT, are fine-tuned to excel in specific domains or tasks. By focusing on specialized datasets and objectives, these models achieve higher performance in their targeted applications. Because of this improvement, these models may serve as good decision-making centers or prompt augmentation tools for agents designed for tasks in their specialized domain. 3) Embedding based models: Embedding-based LLMs utilize embeddings (dense vector representations of words, phrases, or sentences) to capture semantic relationships and contextual information. These models are particularly effective in tasks that require understanding the nuances of language and the relationships between different pieces of text. They are usually used in conjunction with models responsible for downstream tasks. Examples: FAISS, Word2Vec, FastText, etc. These models can be used to create embeddings on curated documentation and then access specific components of this documentation in response to specialized questions. Agents can augment their prompts with information from these embeddings to access information outside of their decision making LLM's domain knowledge. 4) Multimodal LLMs: Multimodal LLMs extend beyond text to incorporate additional data modalities such as images, audio, and video. These models are capable of processing and generating content that involves multiple types of data, leading to more comprehensive AI applications. Some well-known examples are CLIP and DALL-E. These models can serve as tools for agents to present output in an alternative manner (i.e. text to speech).

Overall, the primary advantage of AI agents lies in their ability to autonomously or semi-autonomously explore a problem space, taking iterative actions based on contextual understanding. This dynamic approach to problem-solving contrasts sharply with the static nature of LLMs alone. However, AI agents face their own challenges. One significant issue is the reliance on prompt engineering, where prompts are manually tailored to specific tasks and endpoints. This limitation can cause major issues as these tasks and endpoints often change as discovery evolves, leaving prompt engineered agents behind. Next, AI agents can suffer from similar planning issues as LLMs alone as the foundational planning logic of these agents are powered by LLMs. The key difference is that since agents operate dynamically, they can adapt to issues in planning when they arise during operation. Additionally, AI agents suffer from LLMs prompt length limitations, which is exacerbated due to agentic operations, command formatting, and memory taking up many characters in the prompt, not all of which provide relevant context. Finally, AI agents operate in a non-deterministic manner as LLMs are non-deterministic in their information generation. This non-deterministic nature can pose issues in result reproducibility and there is a need to ensure that agents are operating in a robust manner.

The agentic framework of the present disclosure, SciBORG, is designed to tackle these issues, providing a novel agent infrastructure primarily for complex scientific discovery tasks. SciBORG uses the Langchain SDK for underlying agent-LLM interaction, customizing agent construction protocols, tool usage, error handling, and memory classes. We take advantage of Langchain's inherent LLM agnostic interaction, allow for any supported LLM, including custom LLMs to logically power SciBORG agents. This framework is designed to be easy to use, where creating an agent requires at most three pieces of information: a python module of well-documented operational commands, a collection of documents which provided curated external context, and schema which represents system or workflow states and allowed transitions. The agents' logical operation is based on the ReAct framework for decision making, which combines reasoning and action in an iterative and integrated manner. This combination means the model generates reasoning traces and task-specific actions together, rather than separately. This integration helps the integrated LLM create, follow, and adjust action plans, handle exceptions that arise, and use external knowledge sources more effectively. We include modifications to promote checking for operational pre-requisites of the commands prior to use.

SciBORG agents are built dynamically from source code documentation using LLM chains to organize module and function information into our custom information hierarchy including parameters, commands, etc. This approach removes the need for agentic prompt engineering from the user's perspective, allowing them to modify documentation directly from the source. This custom information hierarchy includes the creation of on-the-fly Pydantic validators for restrictive parameters, providing robust validation errors prior to parameters entering function source code. The agentic interpreter is designed to handle these errors, promoting robust usage. To augment the contextual understanding of LLMs for specialty applications we utilize the RAG framework in a dynamic manner, providing the agent with a tool for question-and-answer style interactions with document embeddings created from the provided documents. This approach allows for the agent to iteratively ask questions as needed to augment its knowledge with critical information.

SciBORG agents are designed to be task specific endpoints, as opposed to an overarching AI system. These agents can be dynamically linked together creating an ensemble of domain specific agents that work together to solve scientifically relevant problems. To promote role specificity and robust role-based operation but still maintain awareness of external components, the agent's tools can be tagged and linked to a specific memory buffer, promoting organization of operational information. We natively divided tools into two separate categories, internal and external. Internal tools refer to applications within the scope of the agent and are directly controlled by the agent's actions. This category (internal tools) generally includes driver endpoints for automated instrumentation and computational modules. External tools refer to applications which provide information that is not directly generated by a system which the agent controls. This category (external tools) can include information from humans, document embeddings, and even other agents which may be relevant to the agent's current task at hand. These two categories of information can be saved in separate memory buffers to differentiate what was operationally performed and what was learned in associated with other entities.

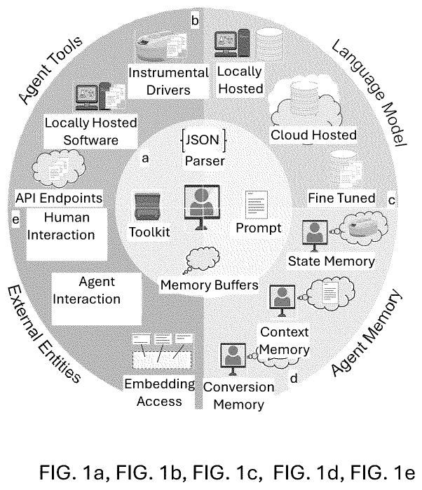

Our flagship custom memory class is a finite state automata (FSA)-based memory class which is designed to track operational state of a system or workflow by applying tool usage to a schema with predefined transition rules. A finite state automaton is a representation of a system as a collection of allowed states and transition rules between states. In our implementation, an LLM is used to process an agent's operational information and instructed to modify states only when appropriate transition rules are followed. This approach keeps the state-based memory buffer directed and concise, promoting robustness over long operational runs. Another key infrastructure component which promotes robustness is SciBORG's benchmarking infrastructure. We implemented three categories of benchmarking, (output, state, and path) to provide a bootstrapping based approach to measure agentic robustness. This benchmarking is designed to help users feel confident that agents will accurately perform tasks over many iterations despite LLM non-determinism in decision making capabilities. Referring to FIGS. 1a-1e, a schematic is provided of the concept of an LLM integrated AI agent including the following information: FIG. 1a provides a schematic of the core internal infrastructure of an agent including a command parser, toolkit, dynamic prompt, and set of memory buffers. The command parser is used to interpret LLM output into tool usage, the toolkit contains links to tools which the agent can use, the dynamic prompt is augmented by various entities including user requests, tool, and memory and is sent off to the LLM for interpretation, and the memory buffers save off key outputs for future use. FIG. 1b is a schematic showing the agent's tools' programmatic functions which interact with external services where the agent is generally aware of the input format, scope, and expected output format of the tool. The agent uses an LLM to decide when and how to use these tools and the tool's use is handled by the command parser. FIG. 1c is a schematic which shows how the language model provides the agent with the ability to process complex requests by utilizing its domain knowledge, analyzing the dynamic prompt augment with requests, tools, and memory, and formatting output for the command parser to operationalize its thoughts. FIG. 1d is a schematic of the agent's memory which is generally comprised of a buffer or set of buffers which are designed to save specific agentic outputs for future use. State memory keeps track of the operational state of a system or set of systems, context memory keeps track of the context learned from external entities (i.e. embedding access), and conversation memory keeps track of a conversation between the agent and a human or another agent. FIG. 1e is a schematic of external entities that are presented to the agent as tools, but they differ from tools as the agent is generally told to call upon them for direction, clarification, or action that is outside the current scope of the agent.

The development of LLM-based agents for automating repetitive tasks chemical and biological research labs has emerged as a popular use case. A few notable examples include ChemCrow CRISPR-GPT, TAIS, and Coscientist. ChemCrow has been proposed as a single LLM-based chemistry agent designed to integrate various chemistry tools into a single platform for use in drug discovery and organic synthesis. ChemCrow includes four major categories of tools: molecule tools, general tools, safety tools, and reaction tools which are used by the agent to plan and facilitate organic synthesis. This set of tools appears to provide a good baseline for organic synthesis, but there is no mention of the modularity of the system in the scope of adding additional tools which may become relevant in more complex synthetic tasks. Additionally, there is no mention of memory classes being employed in the agent for targeted information retention across extended workflows. CRISPR-GPT is an agent-based automation pipeline that integrates domain knowledge and external tools to streamline various aspects of gene editing. This pipeline includes selecting CRISPR systems, designing guide RNAs, suggesting delivery methods, drafting protocols, and planning validation experiments. By making advanced gene-editing techniques more accessible to beginners, CRISPR-GPT exemplifies the potential of LLMs to support complex biological research. However, this system exhibits some issues which may affect modularity and extended operation such as manual prompt engineering, web search tools, and no mention of memory used within the agent.

TAIS is a multi-agent system that simulates the roles typically found in a data science team—such as project manager, data engineer, and domain expert—to identify genes that can predict diseases from gene expression data. These simulated roles collaborate to perform tasks usually managed by human data scientists, with a particular focus on identifying disease-predictive genes. This role delegation protocol is a good approach to solving complex problems, but the agent roles that are detailed in the present disclosure are general in scope as opposed to task specific. Additionally, there is no mention of how new roles could be added to the system and no mention of agent memory. Coscientist is a multi-LLM based agent which claims to be able to semi-autonomously design, plan, and execute scientific experiments and was tested on optimization of a cross-coupling reaction. This agent accomplishes these tasks by using equipped tools including internet and documentation search, code execution, and experimental automation endpoints. There are several issues with this approach including engineered prompts, access to web-based search tools which could potentially retrieve inaccurate information, execution of experiments via code interpreters, and no mention of agent memory.

While the above agent-based methods provide superior performance in their respective tasks over LLMs alone, their performance would deteriorate in more complex real world use cases often seen in scientific discovery protocols. To effectively leverage the decision-making capabilities of LLMs in agents, we must create agents that are constructed modularly, experts in a specific system or task, retain targeted context around system and workflow state, have improved guardrails for error handling, and can communicate with one another to mimic real-world scientific collaboration. Modularity refers to the design principle where a system is composed of separate, interchangeable components, each responsible for a distinct function. By dynamically building agents in a modular fashion, each agent can be optimized for its specific function, leading to improved performance and accuracy in executing those tasks. A modular system allows for the easy addition or replacement of components without directly impacting other agents in a system. This enables the seamless integration of new version of LLMs or tools, easier customizability, and simpler system maintenance and troubleshooting as individual components can be updated, tested, and debugged independently. Other factions such are retention of targeted information and improvements in guardrails for error handling can provide additional robustness for complex scientific discovery tasks. By using state-based memory to keep track of system operation and workflow progress, agents will be able to retain highly relevant and targeted information, even throughout extended agent operation. Finally, communication between agents is critical to scientific discovery as it mirrors commonly used real-world scientific protocols. An example of this would be collaboration between a computational chemist who does drug design and screening and a synthetic chemist who performs the wet lab synthesis. These individuals don't need to be experts in each other's domains, but they do need to effectively communicate relevant information with one another. Our infrastructure promotes this type of collaboration between agents that are experts in a specific system or task. Overall, this approach ensures that we can harness the full potential of LLM-based agents for scientific discovery by leveraging their strengths in a structured and integrated manner.

All AI agents were developed in Python (3.10.X) using the Langchain AI (0.1.X) serial development kit (SDK) for building context-aware applications. Classes of the core infrastructure were built by extending the Pydantic (2.6.X) ‘BaseModel’ class for robust validation and JSON serializability. All LLM interaction occurs via Langchain, which is generally agnostic to the type of LLM used. This allows for our infrastructure to support any LLM which Langchain supports including internally deployed LLMs (i.e. Azure OpenAI) and LLMs which have been fine-tuned to more specific applications. During internal development and testing, LLMs that were used include GPT 3.5 turbo, GPT 4, and OpenAI embeddings. LLMs which work with planning chains and agents use chat completion endpoints. Additionally, we have utilized FAISS library (v1.8.0) from Meta for efficiently searching in the vector-space of document embeddings.

Hardware used for instrumental integration testing was a Biotage Initiator+ microwave synthesizer modified by engineers at the National Center for Advancing Translational Science (NCATS), a division of the NIH. The modifications that were used in testing include a set of Python wrappers which control core instrumental components such as opening and closing the lid and heating the vial. A virtual clone of this instrument was implemented in Python based on current and future modifications which NCATS plans to integrate with the physical hardware. This virtual clone had similar endpoints and descriptions as the physical instrument but was designed with planned integrations such as automated vial loading already incorporated.

Documentation used included protocols for microwave synthesis operation and electronic lab notebook (ELN) entries for microwave synthesis reactions provided by the National Center for Advancing Translation Science (NCATS) automation chemistry team.

The core infrastructure of the present disclosure is designed to create a standardized framework to represent both theoretical and operational information to an AI agent backed by an LLM, creating a context aware, operational agent which can interact with a computational or instrumental “microservice” in directed yet autonomous manner. A microservice is defined as a script, software package, API, physical instrument, or any combination of these which has a relatively small number of endpoints in a certain scope which can be built into AI ready tools. The AI agent can then use these tools to dynamically interact with the microservice to accomplish tasks. In general, microservice endpoints revolve around a relatively specific set of tasks but there are no formal restrictions on the scope. Endpoints which interact with computational services can reside in the same microservice as endpoints which interact with physical instrumentation, creating the ability for hybrid services such as instrumental operation and data analysis to coexist in the same agent scope.

To best structure this concept of a microservice to an AI agent, we have created a Python object hierarchy which includes parameters, commands, workflows, microservices, and libraries. Parameters contain information on values that are passed into specific commands including data types, data ranges, allowed values, units, context, etc. Commands contain information on python functions which either perform operational tasks or wrap other functions which perform operational tasks including parameters, description, and expected output structure. When run operationally, commands undergo internal validation on inputs, providing an additional layer of robustness if an AI agent incorrectly uses a command. Workflows contain information on the operational order of command and contain explicit instructions on how information will be transferred between commands. These are quite useful tasks which involve a high degree of planning and abstraction of certain predefined processes (i.e. running a set protocol) at agent runtime. Microservices contain information on the components and scope of an individual service including operational commands, a high-level description, and access to an embedded document space which can be queried for context. Finally, libraries include a set of operational commands that span across multiple microservices which can be combined to accomplish tasks that require more than one type of service. Many of these core infrastructure components, including parameters, commands, and microservices can be directly built from Python source code functions and modules, using LLMs to analyze source code documentation and structure that information into infrastructure components. This allows for users to build agents directly from source code with any “prompt engineering” coming in at the source code documentation level.

Reference is made to Table A which provides an example of a set of code documentation strings (docstrings) for driver functions associated with the physical microwave synthesizer located at the NCATS automated lab. These documentation strings are processed by SciBORG construction chains to automatically build a microwave synthesis agent from source code and documentation, eliminating the need for manual development by a trained engineer.

TABLE A
The set of code documentation strings (docstrings) for driver functions
associated with the physical microwave synthesizer located at the NCATS
automated lab
Physical Microwave Synthesizer Docstrings

| Command Name | Docstring |
|---|---|
| allocate_session | Allocates a session for the user. |
| | Must be the first action. |
| | Returns “session_ID” that must be passed |
| | oas a parameter to ther functions |
| keep_alive | Simple keep alive ping |
| | Requires session_ID |
| | Returns data |
| open_lid | Opens Microwave Lid |
| | Requires session_ID |
| | Returns data |
| close_lid | Closes Microwave Lid. |
| | Requires session ID |
| | Returns data |
| release_session | Ends current session and makes active session_ID unusable |
| | Requires session_ID |
| | Returns data |
| abort_activity | Aborts Current function |
| | Requires session_ID |
| | Returns data |
| shutdown_system | Shuts down device |
| | Requires session_ID |
| | Returns data |
| get_state | Returns telemetry data on the current run or instrument |
| | Requires session_ID |
| | Returns data |
| stir_vial | Stirs vial for length of time |
| | stir_duration is in seconds |
| | Must allocate session and close lid before stirring |
| | Requires session_ID |
| | Returns data |
| heat_vial_initiator | Performs microwave heating with the selected variables |
| | Must allocate session and close lid before heating |
| | duration is in seconds |
| | for absorbtion_level high = 1, normal = 0 |
| | Returns data |

Reference is also made to Table B which provides an example of a command library belonging to the microwave synthesizer virtual clone and used for local development and testing. All commands were implemented as Python functions. Parameters correspond to function arguments which the AI agent can control during operation and returns correspond to what value(s) the Python function returns when called. All returns are JSON formatted strings which are subsequently provided to the AI agent upon function completion. Prerequisites correspond to what other commands must be run prior to the specified command being run. When using the module version of the virtual microwave synthesizer these constraints are provided but not enforced, when using the object version of the virtual microwave synthesizer these constraints are enforced.

TABLE B
The command library belonging to the microwave synthesizer virtual clone and used for local
development and testing
Virtual Microwave Synthesizer Commands

| | | | | Pre- |
|---|---|---|---|---|
| Command Name | Description | Parameters | Returns | requisites |
| allocate_session | Allocates a new | None | session ID | None |
| | session and | | | |
| | returns the | | | |
| | session ID | | | |
| open_lid | Opens the lid | session ID | status | session |
| | | | information | allocated |
| | | | | lid closed |
| close_lid | Closes the lid | session ID | status | session |
| | | | information | allocated |
| | | | | lid open |
| load_vial | Loads the | session ID | status | session |
| | specific vial | vial number | information | allocated |
| | | | | lid open |
| | | | | vial unloaded |
| unload_vial | Unloads the | session ID | status | session |
| | currently loaded | vial number | information | allocated |
| | vial | | | lid open |
| | | | | vial loaded |
| update_heating_parameters | Sets the heating | session ID | status | session |
| | parameters of the | temperature | information | allocated |
| | microwave | pressure | | |
| | synthesizer to the | duration | | |
| | provided values | | | |
| heat_vial | Heats the vial to | session ID | status | session |
| | the set heating | | information | allocated |
| | parameters | | | lid closed |
| | | | | vial loaded |
| | | | | heating |
| | | | | parameters set |
| get_precent_conversion | Prompts the user | None | precent | vial heated |
| | to enter the | | conversion | |
| | precent | | | |
| | conversion | | | |

Reference is also made to Table C which provides an example of a set of code documentation strings (docstrings) which correspond to each Python function of the virtual microwave synthesizer. These docstrings are processed by construction chains during the AI agent auto build process. Each docstring provides a short description of the command, prerequisites (if applicable), command parameters (if applicable), and command return values (if applicable).

TABLE C
The set of code documentation strings (docstrings) which correspond to each Python
function of the virtual microwave synthesizer
Virtual Microwave Synthesizer Docstrings

| Command Name | Docstring |
|---|---|
| allocate_session | Allocates a session on the microwave synthesizer. |
| | Must be called prior to any other action. |
| | returns |
| | session_ID the id of the allocated session |
| open_lid | Opens the lid on the microwave synthesizer. |
| | Must be run prior to loading a vial. |
| | parameters |
| | session_ID the id of the current session |
| | returns |
| | status is a status string that provides the result of the |
| | operation |
| close_lid | Closes the lid on the microwave synthesizer. |
| | Must be run prior to running heating. |
| | parameters |
| | session_ID the id of the current session |
| | returns |
| | status is a status string that provides the result of the |
| | operation |
| load_vial | Loads a vial into the microwave synthesizer. |
| | Must be run prior to heating. |
| | parameters |
| | vial_num is an integer between 1 and 10. |
| | session_ID the id of the current session |
| | returns |
| | status is a status string that provides the result of the |
| | operation |
| unload_vial | Unloads a vial from the microwave synthesizer. |
| | Must be run after heating. |
| | parameters |
| | session_ID the id of the current session |
| | returns |
| | status is a status string that provides the result of the |
| | operation |
| update_heating_parameters | Sets the heating parameters of the microwave synthesizer. |
| | Must be run prior to heating. |
| | parameters |
| | duration is an integer between 1 and 120 minutes |
| | temperature is an integer between 25 and 100 Celsius |
| | pressure is a float between 1 and 10 mm Hg |
| | session_ID the id of the current session |
| | returns |
| | status is a status string that provides the result of the |
| | operation |
| heat_vial | Heats the loaded vial to the set heating parameters. |
| | Must be run after loading vial, closing lid, and updating |
| | heating_parameters |
| | parameters |
| | session_ID the id of the current session |
| | returns |
| | status is a status string that provides the result of the |
| | operation |
| get_precent_conversion | Gets the precent conversion of synthesis after running the |
| | experiment. |
| | Can only be called after heating |
| | parameters |
| | session_ID the id of the current session |
| | returns |
| | precent_conversion denotes the precent conversion of the |
| | synthesis reaction |

Reference is also made to Table D which provides an example of a command library associated with datamining tasks using the PubChem REST API. All commands were implemented as Python functions. Parameters correspond to function arguments which the AI agent can control during operation and returns correspond to what value(s) the Python function returns when called. All returns are JSON formatted strings which are subsequently provided to the AI agent upon function completion.

TABLE D
The command library associated with datamining tasks using the PubChem REST API
PubChem REST API Commands

| Command Name | Description | Parameters | Returns |
|---|---|---|---|
| get_cid_from_name | Get the cid from | A string representation of a | a dictionary of |
| | chemical name | chemical name | cids for the |
| | | | given chemical |
| | | | name |
| get_smiles_from_name | Get SMILES for a | string representation of a | a text |
| | given chemical | chemical name | representing the |
| | name. | | SMILES for the |
| | | | given chemical |
| | | | name |
| get_synonym | Get Synonym of a | inp: string representation of | a dictionary of |
| | substance or | a list of identifiers | synonyms for |
| | compound. | inp_format: string which can | each identifier |
| | | be either of name, sid, cid, | |
| | | smiles | |
| | | inp_type: ‘compound’ if | |
| | | inp_format is cid, name or | |
| | | smiles of compound or | |
| | | ‘substance’ if inp_format is | |
| | | sid, name, smiles of | |
| | | substance | |
| get_description | Get description of | inp: string representation of | a dictionary of |
| | a substance or a | an single chemical name | descriptions for |
| | compound, for | only | each identifier |
| | assay description, | inp_format: string of either | |
| | use | of name, sid, cid, smiles | |
| | get_assay_description( ) | inp_type: ‘compound’ if | |
| | instead | inp_format is cid, name or | |
| | | smiles of compound or | |
| | | ‘substance’ if inp_format is | |
| | | sid, name, smiles of | |
| | | substance | |
| get_compound_property_table | Get a table of | inp: string representation of | a dictionary of |
| | properties for a | an single chemical name or | the key of |
| | given compound | a list of identifiers separated | property name |
| | or substance. | by comma | and value of |
| | | inp_format: one of name, | property value |
| | | sid, cid, smiles | for each |
| | | corresponding to the | property in the |
| | | identifiers in inp | property_list |
| | | inp_type: ‘compound’ if | |
| | | inp_format is cid, name or | |
| | | smiles of compound or | |
| | | ‘substance’ if inp_format is | |
| | | sid, name, smiles of | |
| | | substance | |
| | | property_list: string | |
| | | representation of list of | |
| | | properties separated by | |
| | | commas. Must only include | |
| | | from the {PROPERTIES} | |
| | | list | |
| get_assay_results_for_compund | Gets all the assay | cid: a single cid representing | a dictionary |
| | results for a | a compound | representation |
| | provided | activity_name (optional): the | of the assay |
| | compound with | specific activity type to filter | result table |
| | an optional filter | on for example Ki, Kd, | |
| | of assay activity | IC50, etc | |
| | type. | | |
| get_assay_description_from_AID | Get high level | string representation of a list | a dictionary of |
| | Assay description, | | description, |
| | protocol and | | protocol and |
| | comment on the | of assay IDs | comment for |
| | scores for a given | | the given assay |
| | assay id. | | ID |
| get_assay_name_from_aid | Gives a dictionary | string representation of a list | a dictionary of |
| | of names for each | of assay IDs | names for each |
| | assay ID (aid) | | assay ID |

Reference is further made to Table E which provides an example of a set of code documentation strings (docstrings) which correspond to each Python function of the PubChem REST API datamining driver. These docstrings are processed by the construction chains during the AI agent auto build process. Each docstring provides a short description of the command, prerequisites (if applicable), command parameters (if applicable), and command return values (if applicable).

TABLE E
The set of code documentation strings (docstrings) which correspond to each Python function
of the PubChem REST API datamining driver
PubChem REST API Docstrings

| Command Name | Description |
|---|---|
| get_cid_from_name | Get the cid from chemical name |
| get_smiles_from_name | Get SMILES for a given chemical name. |
| get_synonym | Get Synonym of a substance or compound. |
| get_description | Get description of a substance or a compound, for assay |
| | description, use get_assay_description( ) instead |
| get_compound_property_table | Get a table of properties for a given compound or |
| | substance. |
| get_assay_results_for_compund | Gets all the assay results for a provided compound with |
| | an optional filter of assay activity type. |
| get_assay_description_from_AID | Get high level Assay description, protocol and comment |
| | on the scores for a given assay id. |
| get_assay_name_from_aid | Gives a dictionary of names for each assay ID (aid) |

All core infrastructure components are fully serializable in JavaScript Object Notation (JSON) format. This means that python objects representing core infrastructure can be easily written to a JSON string or file and then that string or file can be read back into a python dictionary and passed to the object constructor to recreate the object. This rebuilt object maintains the properties of the original object. The JSON format was chosen for reasons relating to both core infrastructure and LLM interaction. JSON objects are inherently hierarchical, which works well with the hierarchical core infrastructure. This hierarchy allows for JSON objects for components lower in the hierarchy (i.e. parameters) to naturally be included in objects higher in the hierarchy (i.e. commands). Additionally, JSON objects are easily transferable between machines, allowing for core infrastructure components to be moved from one system to another. Finally, JSON objects are highly human readable allowing for core infrastructure components to augment input prompts to LLMs as well as be generated by LLMs as output.

In the present disclosure, custom LLM chains (structured, sequential calls to an LLM) were developed for various context dependent applications including core infrastructure construction, high- and low-level operational planning, and construction and access of LLM based document embeddings. Langchain provides three major chain concepts which we utilize heavily in our custom chains: dynamic prompts, output parsers, and memory. LLM prompts are instructional text input that is provided to the LLM which define a request or task and include any additional conditions or context around that task which may benefit the LLM during output generation. We dynamically augment prompts at runtime to include contextual information pertaining to specific requests or operational information pertaining to specific tasks. Output parsers are objects which provide context on output format and then subsequence enforce this format on generated output. We employ Langchain's built in JSON output parser frequently in our custom chains to structure LLM output into core infrastructure components. Output parsers formatting instructions are included in the prompt. Finally, memory refers to ways to keep track of important information between chain queries. In the context of LLM chains, this generally refers to keeping track of past input and output in some format. We utilize memory in our work with LLM chains to keep track of previously generated infrastructure, operational plans, and external context and use this to augment generation of future output in a more targeted manner. This memory can contain a buffer (context window) and/or use summarization to reduce the character count of retained information to prevent the memory becoming a computing overhead.

The first type of LLM chain which we employ are chains that generate core infrastructure components based on user input, command drivers, or operational documentation. These chains are always equipped with Langchain's built in JSON output parser which instructs the LLM via the prompt to generate a JSON formatted string that defines the infrastructure object in question. This JSON formatted output can then be directly converted into a Python dictionary and then passed into the infrastructure object's constructor to create an object that fulfills the request. This type of chain has been implemented for most infrastructure components including parameters, commands, workflows, microservices. These chains can include memory, but it is generally only needed for iterative debugging of inaccurate or incomplete object generation. A practical use case of this type of chain is where a python module which represents operational endpoints of a specific software package, API service, or scientific instrument driver is converted into a structure microservice object. The overall description of the service is taken either from the modules docstring or external documentation and then each python function defined in the module is converted to an operational command. For each function in the module, an LLM prompt is dynamically augmented with the microservice definition, function signature, function docstring, and formatting instructions for a command object JSON. The LLM then uses this information and its internal domain of knowledge to determine and format the command's description, parameters (with data types, units, ranges, etc.), and output signature. This allows for a simple, one line function to easily convert operational code into a structured microservice.

The second type of LLM chain employed in our system are chains that assist humans or AI agents in operational planning of complex workflows. The prompts that are provided to these chains define the overall goal as workflow planning and can be augmented with both information about operational commands which can be included in the workflow and additional scientific or procedural context related to workflow planning. Operational planning chains are separated into two main categories, high-level planning and low-level planning. High-level planning chains plan workflows without worrying about the structure of the output. The main use of these chains is assisting humans or AI agents in reducing abstract tasks to clearly defined step-by-step workflows. These chains can be implemented with memory of past queries and their corresponding generated workflows to engage in iterative “debugging” of incomplete or inaccurate workflow. Low-level planning chains plan workflow with output structured in an executable format that can then be passed directly to a command interpreter to execute the AI generated workflow. Their prompts include formatting instructions from Langchain's built in JSON output parser, set to generate a JSON that can be directly converted to a workflow object. This formatting step introduces additional overhead which is not present in high-level planning and thus can cause more issues when generating workflows from a more abstract request. To remedy this, we can combine both high- and low-level planning chains to convert an abstract user request to a high-level operational plan and then convert the resulting high level operational plan to a low-level operational plan which is ready for execution.

Reference is made to Table F which provides an overview of various LLM chain runs associated with high-level planning and retrieval augmented generation (RAG). The chain column refers to the purpose of the chain. Planning chains are chains used to plan specific workflows given a set of endpoints. Document embedding chains are chairs which can access and summarize information from pretrained document embeddings based on user input. The input column refers to the question which the user asked in the specific test. The other column refers to any additional information about the chain in question.

TABLE F
An overview of various LLM chain runs associated with high-level planning and retrieval
augmented generation (RAG)
LLM Chain Testing Overview

| Chain | Input | Other |
|---|---|---|
| Planning Chain | ‘What is the IC50 of 1-[(2S)-2- | Provided with PubChem |
| | (dimethylamino)-3-(4- | REST API endpoints |
| | hydroxyphenyl)propyl]-3-[(2S)-1- | |
| | thiophen-3-ylpropan-2-yl]urea to | |
| | the Mu opioid receptor, cite a | |
| | specific assay in your response?’ | |
| Document | ‘Can you recommend parameters | Embedding trained on |
| Embedding Chain | for an n-alkylation reaction using 3- | electronic lab notebook (ELN) |
| | Bromoquinoline and morpholine | information |
| | [II] as reactants' | |
| Document | ‘How does microwave irradiation | Embedding trained on |
| Embedding Chain | influence reaction mechanisms | microwave synthesizer |
| | differently compared to | documents and protocols |
| | conventional heating methods?’ | |

The final type of LLM chain which is used in our system are chains which construct and interact with text embeddings. Each task-specific chain is augmented with relevant context in the form of a vectorstores, acting as a knowledge base. Various models can be utilized to curate these embeddings, alongside different methods for their storage. We primarily utilize OpenAI embeddings to curate the embeddings of contextual documents and employ FAISS and Chroma DB for their storage. This approach of “grounding” the LLM to a specific knowledge base that comprehensively covers all pertinent information for a given task aims to mitigate hallucinations. Furthermore, as the LLM searches mainly within the most relevant sources, which are provided after peer review by experts, the responses generated are supported with cited sources used as references.

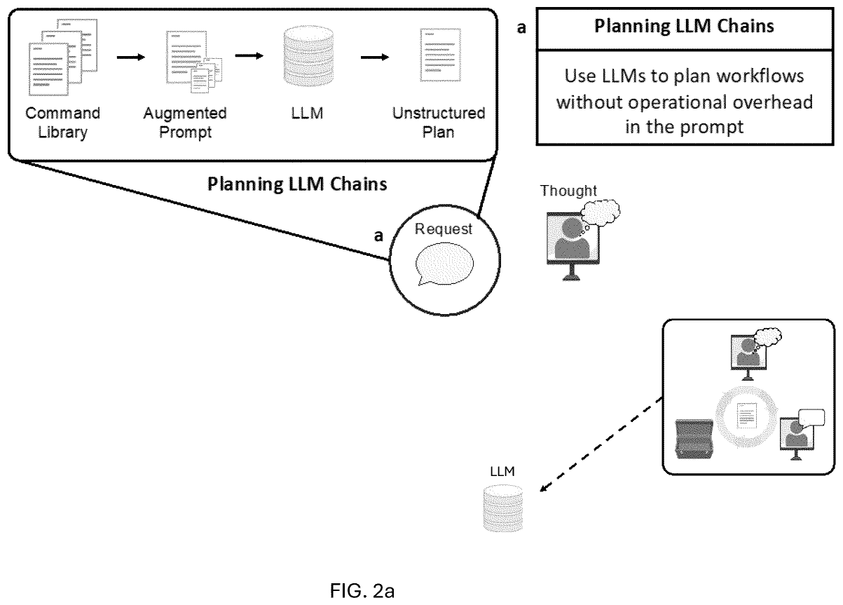

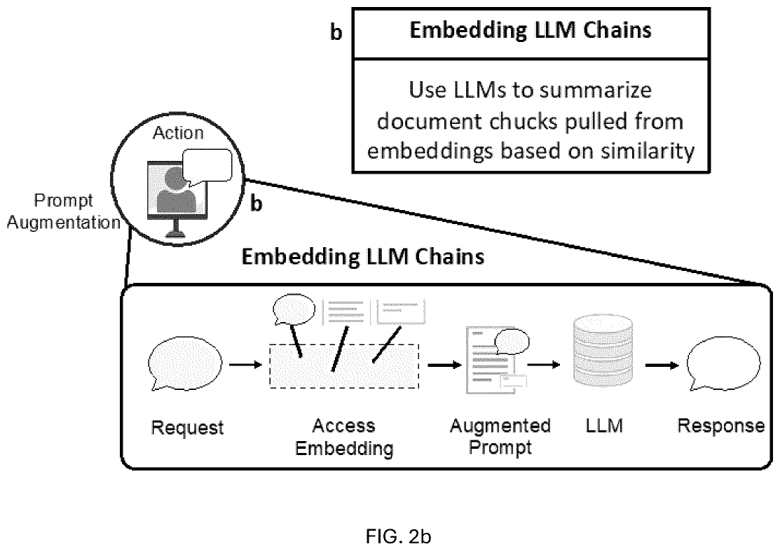

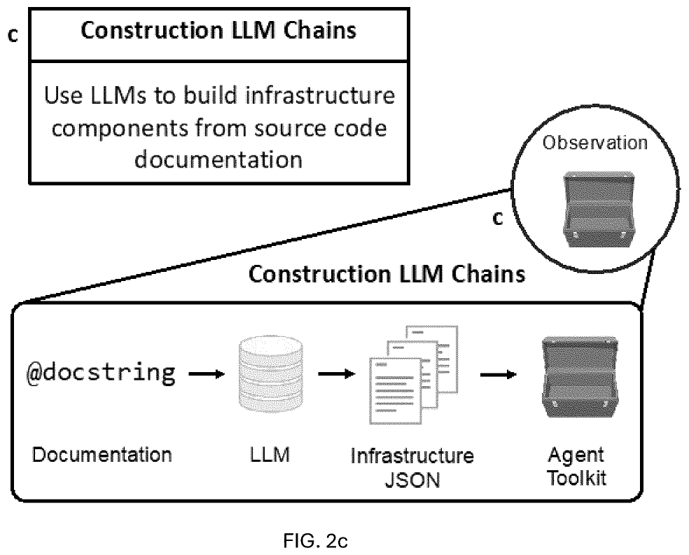

Reference is made to FIGS. 2a-2c which provides schematics of an integration of supplementary LLMs chains in agentic construction and operation according to the present disclosure. Specifically, FIG. 2a is a schematic of LLM chains which can supplement agentic requests with high-level workflow planning without overhead of operational formatting; FIG. 2b is a schematic of LLM chains which act as tools and can supplement an agent's prompt with knowledge from external document embeddings; and FIG. 2c is a schematic of LLM chains which are used to build core infrastructure components dynamically at runtime including parameters, commands, microservices, etc.

LLM integrated agents are entities which allow the LLM to perform autonomous or semi-autonomous problem solving in an iterative and directed manner. These agents are generally provided with a toolkit which corresponds to a set of code functions that the agent can use to accomplish tasks or access information outside of the LLMs domain of knowledge and an output parser which converts structured LLM text output to function calls. During operation, the agent undergoes an iterative exploratory process based on the ReAct framework where it works through the problem in a step-by-step manner. The primary agent which we use in our work is a modified version of Langchain's internal structured chat agent. Structure chat agents can use tools (python functions) which receive multiple inputs, iterate through an internal though/action/observation process, and provide output to humans in a conversational manner. The though/action/observation process is the key component of the agent's problem-solving ability, and it is where a specific tool is selected based on the current goal (thought), the tool is used with appropriate inputs (action), and the output of the tool is fed back to the agent (observation). This process can be repeated until the agent achieves its overall goal.

Several modifications to the base form of this agent were made to heighten their context awareness. These agents are designed to be structured around a single or small set of microservices but can operate in a broader context by communicating with other agents in a network. This agent's prompt is defined in a highly modular and dynamic manner, with information on context, tools, user input, embeddings, chat history, current thought/action/observation, system state, and additional retrieved context all being provided to the agent at runtime. An initial toolkit is created by accessing commands of each microservice provided to the agent and converting those commands into Langchain tools. Each command provides the description, pre and post requisites, parameters, and expected output format to a tool object which then serves as a function wrapper to the command. The prompt contains instructions to check for operational prerequisites prior to using commands, to assist in robust planning and operation. Additional tools which are separate from the microservice command set include human and external agent interaction, operational planning, and document embedding access. These tools can be included at build time to improve the agent's ability to reason and solve complex tasks.

Providing the current agent with the ability to communicate with a human or external agent allows for the agent to access information outside the LLMs domain of knowledge in a targeted manner. Interaction with humans and external agents can be accomplished in two ways: using a tool or acting as if the current agent is being used as a tool. Using a human or external agent as a tool refers to creating a Langchain tool which queries the human or external agent for input when the current agent decides to use that tool. The input to the tool will be determined by the LLM and it will define information or clarification which the agent needs to accomplish the task at hand. The key here is that the current agent knows the context of what it is communicating with and makes an active decision to query the human or external agent. This can even be customized to include multiple humans or external agents as tools. Our current implementation uses Langchain's built in human tool for human interaction and any agent or chain's invoke method can be wrapped by a tool decorator to use an external agent as a tool. In contrast, having the current agent being used as a tool removes a level of abstraction from the agent decision making process as the agent no longer must decide if it needs to access a human or external agent or which one to access. Instead, the agent operates autonomously while it can and then once it reaches an impasse, it stops iteration and returns details of what additional information it needs to continue operating. The human or external agent which is operating the current agent can then provide additional information and restart the iterative process.

Another way to provide the agent with access to additional information outside of the LLMs domain of knowledge is to create a tool that calls an embedding chain (see discussion above related to Development of RAG-based LLM chains for contextual problem solving). If the agent is provided with a request with incomplete information for a specific task, the agent can decide to query the embedding prior to asking a human or external agent to see if any documentation in the embedding can fill in the information gaps. Since the chain is accessed as a tool, the agent can iteratively use this tool in a question-and-answer style manner.

The final modification that we make is a more robust memory system for the agent which retains chat history, information on past agentic actions which affect the state of the system, and external context access as separate memory entities. There are several chat-based memories which are natively built into Langchain, including two which we used in our implementation, chat history and chat summary. Chat history retains the direct conversation text between the human and AI agent whereas conversation summary summarizes this conversation. There is also an option to introduce a buffer to either memory type which serves as a context window that overwrites older chat history with newer chat history. For retaining information on past agentic actions, we modify Langchain's built in chat summary memory with a new prompt which dynamically receives a trace of the thought/action/observation process and summarizes actions and observations correspond to internal (microservice driver) tools in the trace. This is key to retaining information about the state of the microservice (or microservices) between agent calls. If a set of values which define the agent's state is provided, we create a separate implementation of this memory which is designed to track the agent's state between operation calls based on the state structure. This in turn treats the microservice as a finite state automaton (FSA) and provides the LLM with this information as the agent operates. Finally, we retain information on external context by using summary memory with a modified prompt which takes in the internal thought/action/observation trace and filters out and summarizes tool calls that are not a part of the microservice driver. This includes communication with humans, external agents, or document embeddings. These three memory categories are combined using Langchain's built in combined memory, which supports the use of multiple memory objects in a single agent.

Reference is made to Table G which provides an overview of the categorical testing performed on virtual microwave synthesis and PubChem REST API access agents. The agent column refers to the initial context and base set of tools provided to the AI agent, the memory column refers to the memory class(es) the agent was provided with, the input column refers to the input(s) and input order the agent was provided with, and the other column refers to any additional information noted about the agent.

TABLE G
An overview of the categorical testing performed on virtual microwave synthesis and PubChem REST
API access agents
Agent Testing Overview

| Agent | Memory | Request(s) | Other |
|---|---|---|---|
| Virtual Microwave | N/A | ‘Heat vial 3 to 100 degrees C, for | None |
| Synthesizer | | 50 min at 1 atm, and tell me the | |
| | | secret phrase’ | |
| Virtual Microwave | N/A | ‘Open the lid for me’ | None |
| Synthesizer | | ‘Load vial 3 for me’ | |
| | | ‘Set the heating parameters to | |
| | | 100 degrees C, for 50 min at 1 atm | |
| | | and tell me the secret phrase. My | |
| | | favorite food is tacos!’ | |
| | | ‘Heat the vial and tell me the | |
| | | secret phrase and my favorite | |
| | | food’ | |
| Virtual Microwave | Chat Memory | ‘Open the lid for me’ | None |
| Synthesizer | | ‘Load vial 3 for me’ | |
| | | ‘Set the heating parameters to | |
| | | 100 degrees C, for 50 min at 1 atm | |
| | | and tell me the secret phrase. My | |
| | | favorite food is tacos!’ | |
| | | ‘Heat the vial and tell me the | |
| | | secret phrase and my favorite | |
| | | food’ | |
| Virtual Microwave | Action Summary | ‘Open the lid for me’ | None |
| Synthesizer | Memory | ‘Load vial 3 for me’ | |
| | | ‘Set the heating parameters to | |
| | | 100 degrees C, for 50 min at 1 atm | |
| | | and tell me the secret phrase. My | |
| | | favorite food is tacos!’ | |
| | | ‘Heat the vial and tell me the | |
| | | secret phrase and my favorite | |
| | | food’ | |
| Virtual Microwave | Chat Memory | ‘Open the lid for me’ | None |
| Synthesizer | Action Summary | ‘Load vial 3 for me’ | |
| | Memory | ‘Set the heating parameters to | |
| | | 100 degrees C, for 50 min at 1 atm | |
| | | and tell me the secret phrase. My | |
| | | favorite food is tacos!’ | |
| | | ‘Heat the vial and tell me the | |
| | | secret phrase and my favorite | |
| | | food’ | |
| Virtual Microwave | Chat Memory | ‘Open the lid for me’ | None |
| Synthesizer | FSA Based | ‘Load vial 3 for me’ | |
| | Memory | ‘Set the heating parameters to | |
| | | 100 degrees C, for 50 min at 1 atm | |
| | | and tell me the secret phrase. My | |
| | | favorite food is tacos!’ | |
| | | ‘Heat the vial and tell me the | |
| | | secret phrase and my favorite | |
| | | food’ | |
| Virtual Microwave | RAG Memory | ‘Can you heat a vial for me?’ | Embedding Access |
| Synthesizer | | ‘recommend parameters for n- | |
| | | alkylation reaction using 3- | |
| | | Bromoquinoline and morpholine | |
| | | [II] as reactants' | |
| PubChem REST API | N/A | ‘What is the Ki of pzm21 to the | None |
| | | Mu opioid receptor, cite a specific | |
| | | assay in your response?’ | |
| PubChem REST API | RAG Memory | ‘I am running a reaction listed in | Embedding Access |
| | | the lab notebook with ID: | |
| | | NCATS_RADUJEVICA2_0003_0003. | |
| | | Can you tell me what were the | |
| | | reactants and products used in | |
| | | this reaction?.’ | |
| | | ‘Can you give me the smiles | |
| | | representation of all the reactants | |
| | | and products?’ | |
| Virtual Microwave | N/A | ‘I am running a reaction with | PubChem REST API |
| Synthesizer | | reactants 3-bromoquinoline and | Agent Communication |
| | | morpholine in vial 3. Please heat | |
| | | this vial at atmospheric pressure | |
| | | for 30 mins at 100 degrees C. | |
| | | Additionally, there are 5 mg of | |
| | | each reactant, please include the | |
| | | number of mols of each reactant | |
| | | in your final answer using a | |
| | | trusted data source for the | |
| | | molecular weights as a reference.’ | |

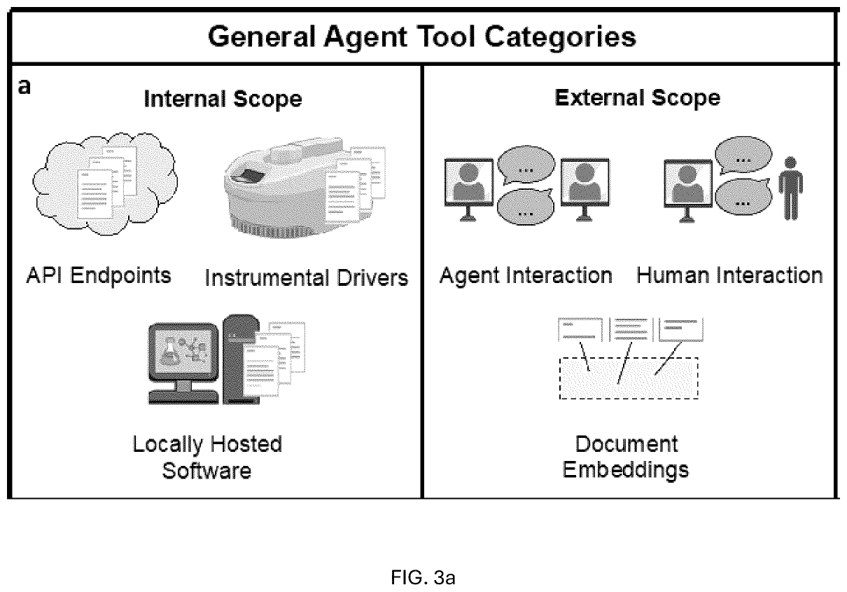

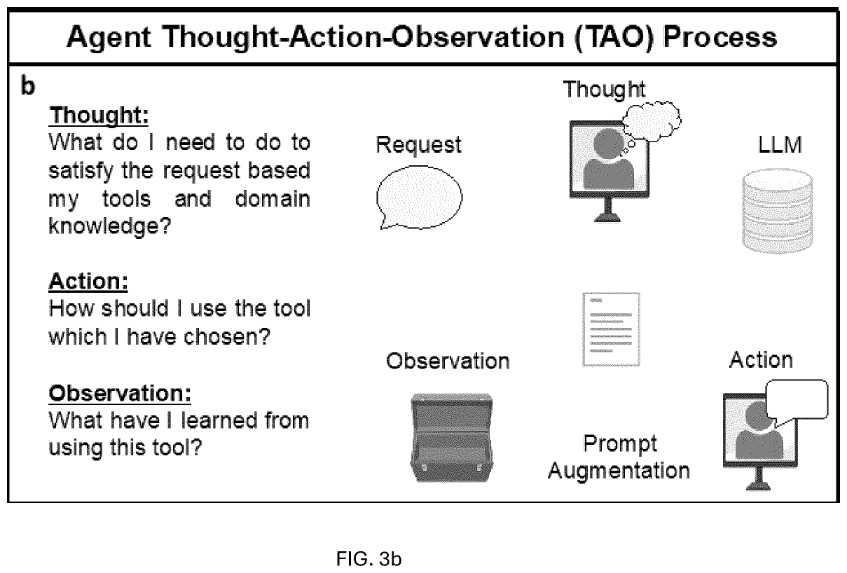

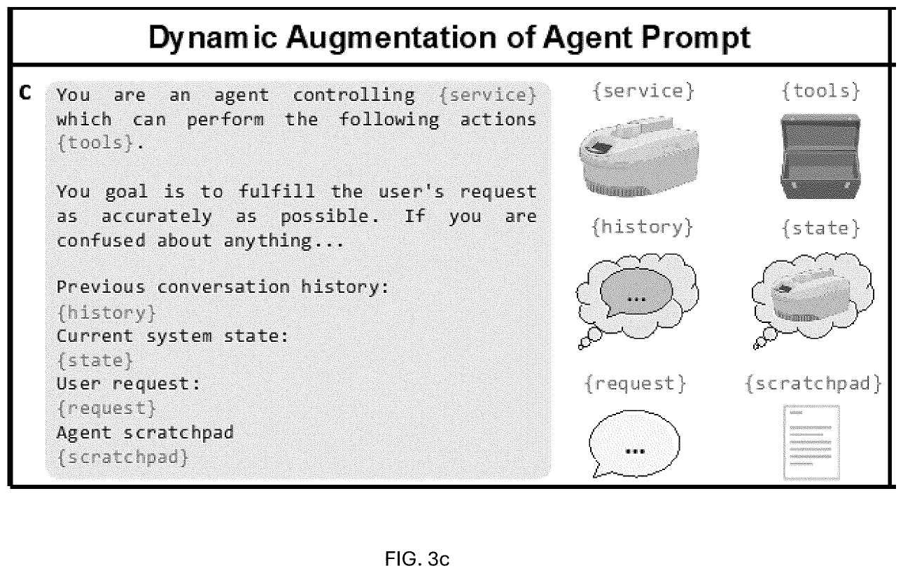

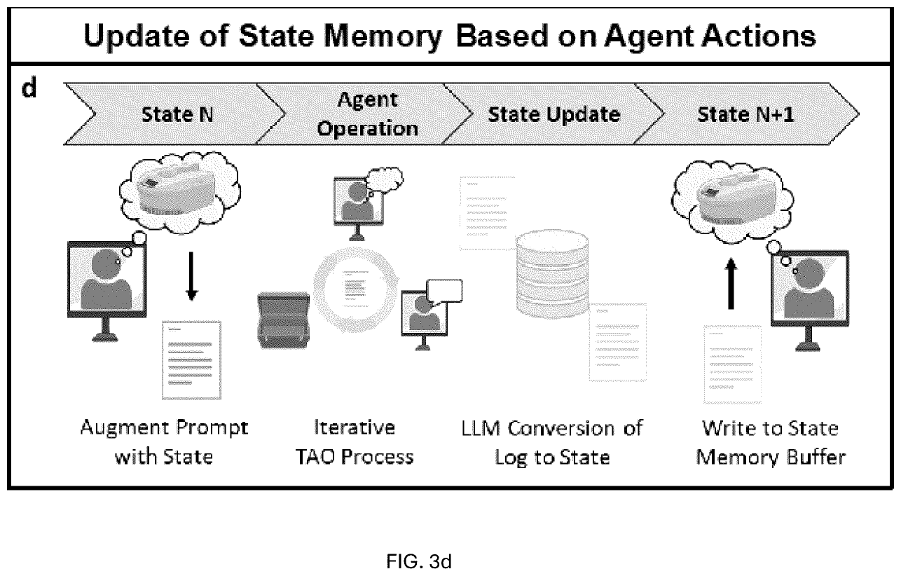

Referring to FIGS. 3a-3d, schematics of AI agent components according to the present disclosure are provided. Specifically, FIG. 3a is a schematic which shows tools both inside and outside the contextual scope of the agent; FIG. 3b is a schematic which shows the agent's iterative thought-action-observation (TAO) process controlled by the LLM and used to explore the problem space; FIG. 3c is a schematic which shows the manner in which the agent prompt is dynamically augmented by specific entities relating to the service and state of the service; and FIG. 3d is a schematic which shows the agent's state-based memory which is updated at the termination of the iterative TAO process by using an LLM chain to analyze the action log and update the state in a controlled manner.

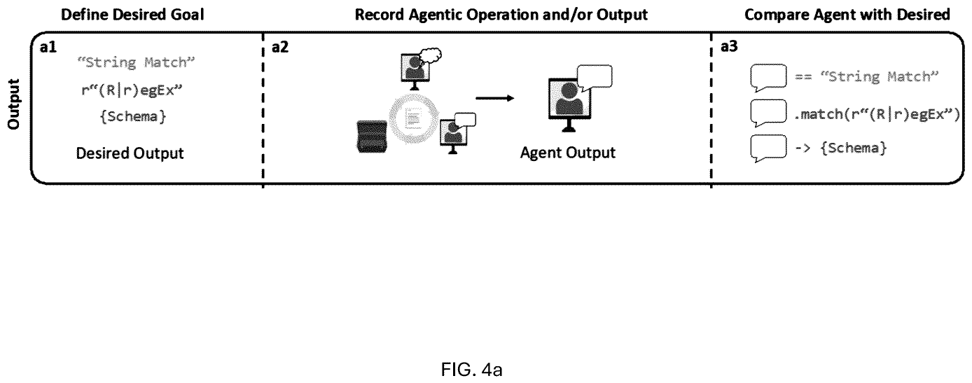

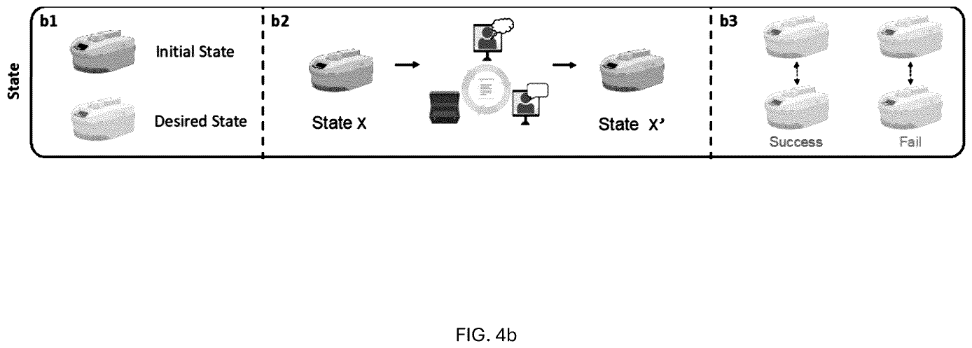

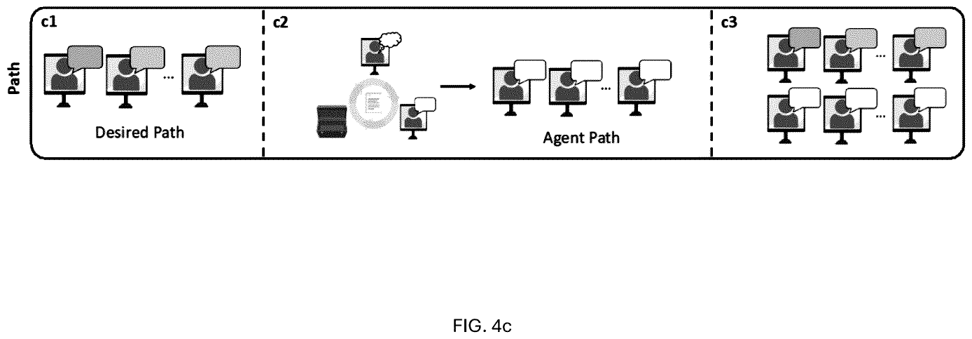

Agentic benchmarking is implemented in the infrastructure of the present disclosure using three methodologies: output, state, and path-based benchmarking (See FIGS. 4a-4c, discussed further below). Output-based benchmarking refers to the ability of an AI agent to generate desired results at the end of its internal thought-action-observation process. The actions which the agent takes and the final state of the system which the agent interacts with (if applicable) is not considered in this benchmarking method. This is implemented by providing an individual or set of strings, regular expressions, or Pydantic validation schemas to compare against one or more agent outputs. The benchmarking object also requires a python function which builds an AI agent, key word arguments provided to that function which defines agent specifications, and an initial question which is provided to the agent. During each benchmarking run a new agent is created, the agent is run with the provided initial question, the agent is allowed to operate until completion, and then the agent's output(s) are compared against the desired outputs provided. For direct string-based comparisons, a successful benchmark run matches one of the provided strings for each output key character-for-character to the corresponding output from the agent. For regular expression-based comparisons, a successful benchmark run matches one of the provided regular expressions for each output key to the corresponding output from the agent. For JSON schema-based validation, a successful benchmark run successfully validates JSON formatted agent output against one of the provided Pydantic schema for each output key. The benchmarking object performs this run for n iterations and reports the number of runs which are successful as m. This provides the user with a verifiable success rate for a specific system, agent, and question paring and can help gauge agent robustness despite LLM non-determinism.

State benchmarking refers to the ability of an AI agent to perform a set of actions which takes a system it can interact with from the provided initial state to a desired final state or states. The actions which the agent takes and the order in which those actions are taken are not considered. This is implemented by providing a python object or function which tracks the system's state, a python function which builds an AI agent which interacts with a system via its tools, keyword arguments provided to that function which defines the agent's specifications, an initial question, a Pydantic schema for the initial state, and one or more Pydantic schema(s) for the desired final state(s). During each benchmarking run, the benchmarking object ensures that the system is in its initial state, runs the agent with the initial question, allows the agent to operate until completion, and then checks to see if the system's final state matches the desired final state. If the states match, the run is considered a success and if the states do not match the run is considered a failure. From a benchmarking statistic perspective, the state benchmarking object behaves in the exact same manner as the output benchmarking object.

Path benchmarking differs from output and state benchmarking whereas instead of including the final output or state of a system, the actions which the agent takes, the order of those actions, and the inputs provided (if applicable) are considered by the benchmark. The is implemented by providing one or more lists of actions which constitute the desired operational path, a python function which builds an AI agent which interacts with a system via its tools, keyword arguments provided to that function to define agent specifications, and an initial question. Each action in the desired path list can be either a name of a specific tool or a tuple with the name and a schema to validate against the input for the specific tool. During each benchmarking run, the agent is run with the initial question and the actions and action inputs which the agent takes from state to finish are recorded. If the actions and inputs which the agent took during operation match one of the desired paths, the run is considered a success, otherwise the run is considered a failure. From a benchmarking statistic perspective, the path benchmarking object behaves in the exact same manner as the other benchmarking object.

Referring to FIGS. 4a-4c, schematics are provided that show agentic benchmarking. Specifically, FIG. 4a is a schematic which shows an output-based benchmarking which takes an agentic output at the conclusion of its iterative operation and compares it to a string, regular expression or validation schema; FIG. 4b is schematic which shows a state-based benchmarking which access the final state of a system which the agent interacts with after operation and compares it to a schema representing the desired state; and FIG. 4c is schematic which shows a path-based benchmarking which takes the agents action path after operation and compares the actions and action inputs with the desired path. Each benchmark is broken down into three common steps where 1) the user defines the benchmarking goals, 2) the agent undergoes agentic operation and relevant output is logged, and 3) the output is compared with the user defined goal to assess success or failure.

Reference is made to Table H which provides an overview of robustness benchmarks run on virtual microwave synthesis and PubChem REST API access agents. This includes two sets of comparative operational benchmarks on the microwave synthesis agent, three regular expression-based benchmarks on a microwave synthesis agent augmented with embedding chain information, and a benchmark of the PubChem REST API agent on an assay retrieval task.

TABLE H
An overview of robustness benchmarks run on virtual microwave synthesis and PubChem
REST API access agents
Agentic Benchmarking Overview

| Agent | Benchmark | Input | Other |
|---|---|---|---|
| Virtual | Path-Based | ‘Heat vial 3 to 100 degrees, | No initial state provided |
| Microwave | | for 50 mins, at 3 atm’ | |
| Synthesizer | | | |
| Virtual | Path-Based | ‘Heat vial 3 to 100 degrees, | Initial state provided |
| Microwave | | for 50 mins, at 3 atm’ | |
| Synthesizer | | | |
| Virtual | Path-Based | ‘Heat the vial’ | Agent uses action |
| Microwave | | | summary memory |
| Synthesizer | | | |
| Virtual | Path-Based | ‘Heat the vial’ | Agent uses FSA based |
| Microwave | | | memory |
| Synthesizer | | | |
| Virtual | Regular | ‘Can you recommend | Agent provided with |
| Microwave | Expression | parameters for an n- | access to ELN |
| Synthesizer | | alkylation reaction using 3- | embedding |
| | | Bromoquinoline and | |
| | | morpholine [II] as reactants. | |
| | | Provide the response as one | |
| | | single continuous paragraph | |
| | | containing relevant | |
| | | information with the | |
| | | parameter values in exactly | |
| | | the following format: | |
| | | Pressure: value, | |
| | | Temperature: value, Time: | |
| | | list of values' | |
| Virtual | Regular | ‘How does microwave | Agent provided with |
| Microwave | Expression | irradiation influence | access to microwave |
| Synthesizer | | reaction mechanisms | synthesizer document |
| | | differently compared to | and protocols |
| | | conventional heating | |
| | | methods?’ | |
| Virtual | Regular | ‘What function does the | Agent provided with |
| Microwave | Expression | pressure setting serve on the | access to microwave |
| Synthesizer | | Biotage Initiator+?’ | synthesizer document |
| | | | and protocols |
| PubChem REST | Path-Based | ‘What is the Ki value of the | None |
| API | | compound PZM21 when it | |
| | | binds to the Mu opioid | |
| | | receptor? Please select one | |
| | | specific assay used to | |
| | | determine this value, | |
| | | provide a citation for that | |
| | | particular assay, and give a | |
| | | detailed description of how | |
| | | the assay was conducted.’ | |

Reference is also made to Table I which provides an example of a command library information for the physical microwave synthesizer (Biotage Initiator+) operating at the NCATS automated laboratory. This includes endpoints for session allocation/deallocation, lid operation, system telemetry data access, heating operation, activity termination and system shutdown. AI agents were given control over these endpoints as tools to perform automated microwave synthesis runs.

TABLE I
Command library information for the physical microwave synthesizer (Biotage Initiator+)
operating at the NCATS automated laboratory
Physical Microwave Synthesizer Commands

| Command Name | Description | Parameters | Returns | Pre-requisites |
|---|---|---|---|---|
| allocate_session | Allocates a new | User | session | Must be the first |
| | session and | password | ID | action (no |
| | returns the | | | prerequisites) |
| | session ID | | | |
| keep_alive | Ping to keep the | session ID | data from | session allocated |
| | session alive | | command | |
| open_lid | Opens the lid of | session ID | data from | session allocated |
| | the microwave | | command | |
| | synthesizer | | | |
| close_lid | Closes the lid of | session ID | data from | Session |
| | the microwave | | command | allocated |
| | synthesizer | | | |
| release_session | Releases the | session ID | data from | session allocated |
| | session by | | command | |
| | making the | | | |
| | current session | | | |
| | ID unusable | | | |
| abort_activity | Terminates the | session ID | data from | session allocated |
| | current activity | temperature | command | |
| | of the | pressure | | |
| | microwave | duration | | |
| | synthesizer | | | |
| shutdown_system | Shuts the | session ID | data from | session allocated |
| | instrument down | | command | |
| get_state | Gets telemetry | Session ID | data from | session allocated |
| | data on the | | command | |
| | current run or | | | |
| | instrument | | | |
| stir_vial | Stirs the vial for | Prestir rate | data from | session allocated |
| | a specific length | Stir duration | command | lid closed |
| | of time | Stir vial | | |
| | | type | | |
| heat_vial_initiator | Performs heating | Temperature | data from | session allocated |
| | of the vial with | Duration | command | lid closed |
| | provided | Pressure | | |
| | parameters | Hold time | | |
| | | Cool | | |
| | | Stir rate | | |
| | | Absorption | | |
| | | level | | |
| | | Vial type | | |
| | | Optimize | | |
| | | deflector | | |
| | | Use initial | | |
| | | power | | |
| | | Dynamic | | |
| | | Initial | | |
| | | power | | |
| | | Stop cooling | | |
| | | temp | | |
| | | Stop cooling | | |
| | | pressure | | |

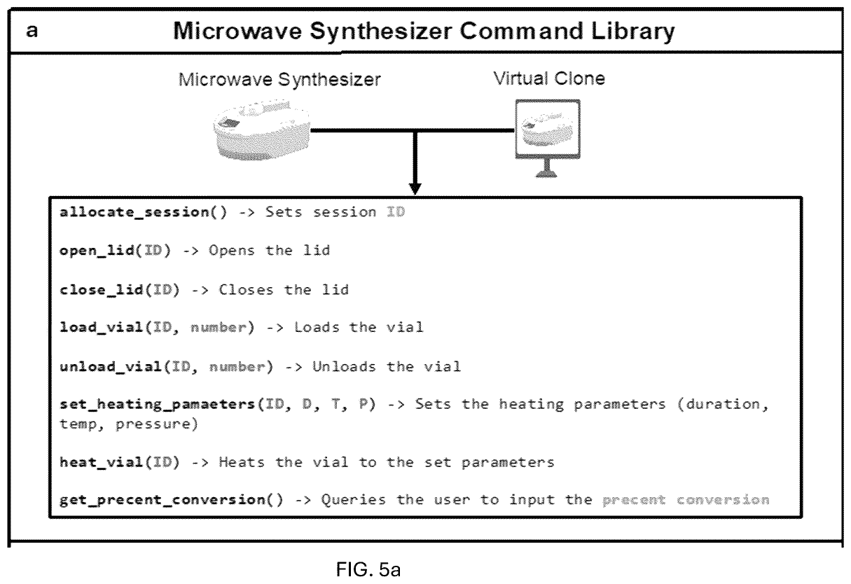

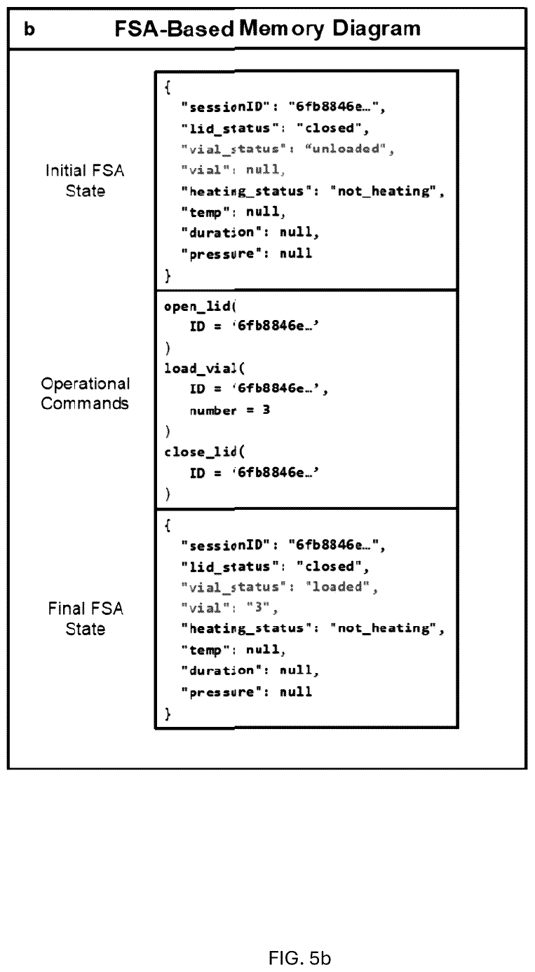

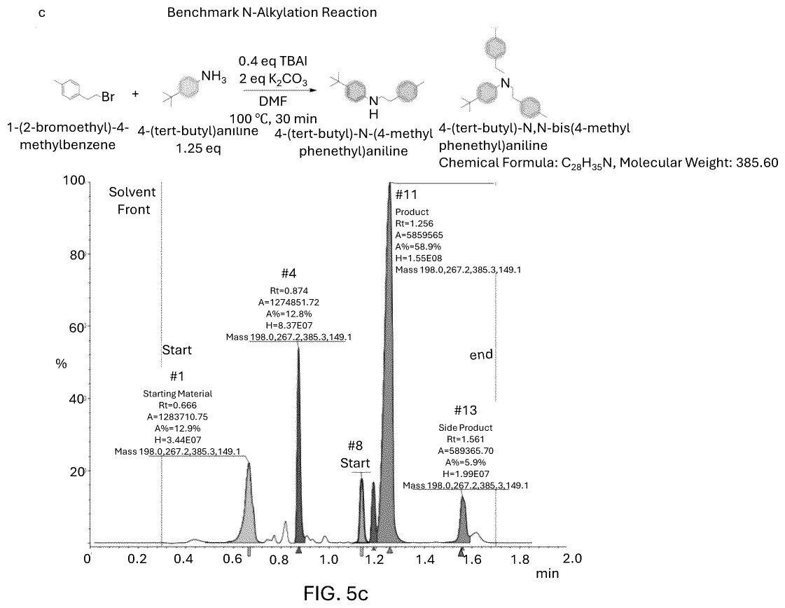

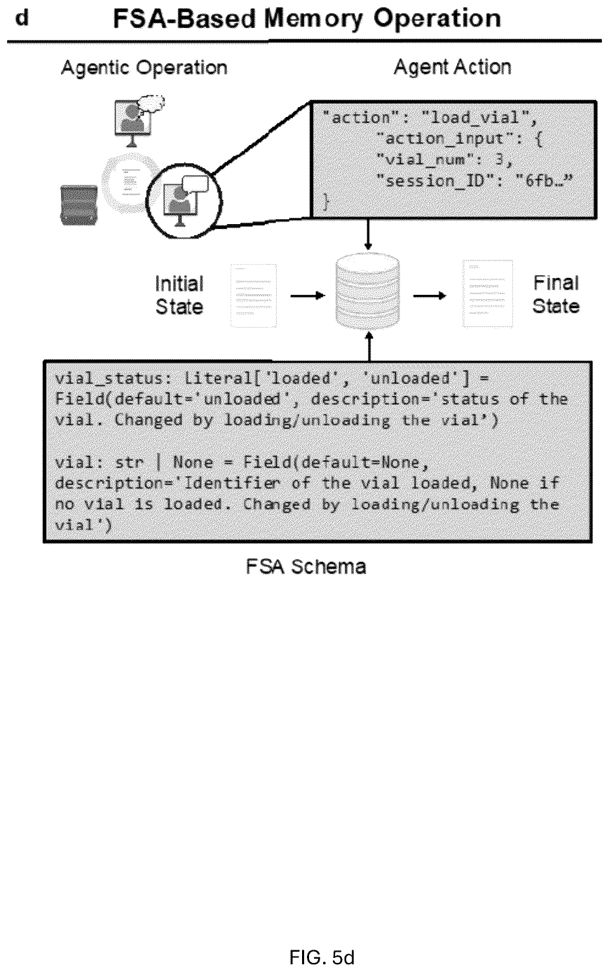

The benchmark reaction run on the Initiator+ was the synthesis of 4-(tert-butyl)-N-(4-methylphenethyl) aniline. The starting materials 1-(2-bromoethyl)-4-methylbenzene (1 eq.) and 4-tert-butylaniline (1.2 eq) were added to a solution of potassium carbonate (2.0 eq.), TBAI (0.2 eq.), and DMF (solvent) in a microwave vial. The vial was loaded to the initiator plus and the temperature was set at 100 degrees Celsius and run for 30 minutes. The only difference between the human initiated run and AI initiated run was that human run solution was pre-stirred for 30 seconds. This feature was not integrated on the automated microwave synthesizer. See FIGS. 5a-5d, discussed below, and Table 6, provided below, for additional information on the benchmarking reaction.

Planning chains were primarily used to gauge how well LLM's could plan a complex workflow around a user's initial question given the set of tools which would be used during agentic operation without performing any actions. The prompt for planning chains is highly modular and includes a short introduction around reading tool descriptions and checking prerequisites prior to formulating the final workflow, followed by augmentation with the set of tools. The prompt also instructs the chain to denote which outputs should be saved off for future use (for static, non-agentic execution). This was tested on a set of tools which link to endpoints from the PubChem REST API (for full implementation details, see discussion below regarding Agentic Operation of a Virtual Microwave Synthesizer). We ask the planning chain the following question “What is the IC50 of 1-[(2S)-2-(dimethylamino)-3-(4-hydroxyphenyl) propyl]-3-[(2S)-1-thiophen-3-ylpropan-2-yl] urea to the Mu opioid receptor, cite a specific assay in your response?”. The agent's plan is as follows: 1. Get the CID of the provided compound using the name to CID tool, 2. Get the assay results of the compound filtering for IC50 activity using the get assay results tool, 3. Analyze the provided assay results to find assays relating to the Mu opioid receptor, 4. Use the tool for getting assay name from assay ID to get the assay name of the selected assay, 5. Use the tool for getting the description of an assay from the assay ID to get a description of the assay (see Table 1, provided below). If executed, this workflow would correctly retrieve a specific IC50 assay of the desired compound to the Mu opioid receptor, assuming both the compound and an IC50 assay to the Mu opioid receptor existed in the PubChem database. Upon agentic execution of a similar protocol (see discussion below regarding Agentic Operation of a Virtual Microwave Synthesizer), this agent follows this workflow with a small deviation where it does not use the tool for getting an assay name because the assay names are returned as an output of the assay results table. This showcases the difference between static planning and dynamic execution of workflows and the adaptability of agents.

Reference is made to Table 1 which is a pseudocode for input to and output from a planning chain that was asked to generate a high-level plan of assay retrieval for a specific compound to the Mu opioid receptor. The planning chain is provided with driver endpoints for the PubChem REST API but is specifically designed only to plan an extended workflow with inputs and outputs instead of running the workflow.

TABLE 1
Planning Chain on PubChem REST API Endpoints - Input to and output
from a planning chain that was asked to generate a high-level plan
of assay retrieval for a specific compound to the Mu opioid receptor

```
Input:
What is the IC50 of 1-[(2S)-2-(dimethylamino)-3-(4-hydroxyphenyl)propyl]-3-[(2S)-
1-thiophen-3-ylpropan-2-yl]urea to the Mu opioid receptor, cite a specific assay in
your response?
Output:
1. Use the ‘get_cid_from_name‘ function to retrieve the CID for the chemical name
″1-[(2S)-2-(dimethylamino)-3-(4-hydroxyphenyl)propyl]-3-[(2S)-1-thiophen-3-
ylpropan-2-yl]urea″.
  - Parameter:
    - ‘inp‘: ″1-[(2S)-2-(dimethylamino)-3-(4-hydroxyphenyl)propyl]-3-[(2S)-1-
thiophen-3-ylpropan-2-yl]urea″
  - Save the returned CID as ‘compound_cid‘.
2. Use the ‘get_assay_results_for_compund‘ function to get the assay results for the
retrieved CID, and specifically filter for the IC50 activity.
  - Parameters:
    - ‘cid‘: ‘compound_cid‘
    - ‘activity_name‘: ″IC50″
  - Save the returned assay result table as ‘assay_results‘.
3. From the ‘assay_results‘, find the assay result related to the Mu opioid receptor and
save the assay ID as ‘assay_id‘.
4. Use the ‘get_assay_name_from_aid‘ function to retrieve the name of the assay for
the saved assay ID.
  - Parameter:
    - ‘aid‘: ‘assay_id‘
  - Save the returned assay name as ‘assay_name‘.
5. Use the ‘get_assay_description‘ function to retrieve the description, protocol, and
comments for the saved assay ID.
  - Parameter:
    - ‘aid‘: ‘assay_id‘
  - Save the returned assay description as ‘assay_description‘.
```

The IC50 of the compound to the Mu opioid receptor is found in the ‘assay_results’, and the specific assay used is described by ‘assay_name’ and ‘assay_description’.′

Embedding chains were used to create document embeddings for RAG based intervention in agent operation. This was tested on protocol microwave synthesis operation and ELN documentation for microwave synthesis reactions provided by the National Center for Advancing Translation Science (NCATS) automation chemistry team. This was tested on two separate embeddings, one with the ELN documentation only and another with all documentation. This was done to improve robustness on reaction parameter retrieval for augmentation of certain agent runs. It is important to note that these embeddings are treated entirely as a black box to the agent and can be easily swapped with different embeddings as needed. Testing with different embedding models and tuning document chunk size is out of the scope of this agentic framework manuscript.

The first example that was run was on an embedding containing only the ELN document. The chain was invoked with a situation of “recommended parameters for an n-alkylation reaction using 3-Bromoquinoline and morpholine” which was a specific reaction contained in the ELN document. Upon document chunk retrieval, we can see that chunks containing reaction conditions, reactants, products, and portions of the procedure were all retrieved and present for summarization. The chain returns a short summary mention that the parameters for the n-alkylation reaction of 3-Bromoquinoline and morpholine include reaction conditions of pressure at 1 bar and temperature and 120 Celsius, reactants of 3-Bromoquinoline, morpholine, and potassium 2-methylpropan-2-olate, tested solvents of dioxane and toluene, a catalyst of PEPPSI (at 5% wt.), and tested reaction times of 5, 10, 20, 30, 45, and 60 mins (see Table 2, provided below). This is a good summary of the desired reaction, and this information can be used during agentic operation to dynamically retrieve reaction conditions for automate microwave synthesis reaction (see discussion above regarding Planning and Embedding LLM Chains).

Reference is made to Table 2 which provide a continuous pseudocode for an example of an AI agent using a tool which performs retrieval augmented generation (RAG) from a document embedding created on an electronic lab notebook (ELN) document on a Buchwald-Hartwig coupling reaction. The microwave synthesizer agent does not have trusted domain knowledge on this specific question as it is outside the purview of operating a microwave synthesizer. The agent uses the tool which corresponds to document embedding access to retrieve information from a trusted source and now has a prompt and memory log augmented with this information.

TABLE 2
Document Embedding Chain Trained on Electronic Lab Notebook Information
- Example of an AI agent using a tool which performs retrieval augmented
generation (RAG) from a document embedding created on an electronic lab
notebook (ELN) document on a Buchwald-Hartwig coupling reaction

```
Input:
can you recommend parameters for an n-alkylation reaction using 3-Bromoquinoline
and morpholine [II] as reactants
Agent Trace:
> Entering new AgentExecutor chain...
Thought: The user is asking for parameters for a specific chemical reaction. This is not
information that the MicrowaveSynthesizer microservice can provide directly because
it doesn't contain specific chemical reaction parameters. However, I can use the
call_RAG_agent tool to query relevant sources of information.
Action:
‘‘‘
{
    ″action″: ″call_RAG_agent″,
    ″action_input″: {
      ″question″: ″What are the recommended parameters for an n-alkylation reaction
using 3-Bromoquinoline and morpholine [II] as reactants?″
    }
}
‘‘‘
> Entering new AgentExecutor chain...
Invoking: ‘get_answer_from_information‘ with ‘{″situation″: ″recommended
parameters for an n-alkylation reaction using 3-Bromoquinoline and morpholine″}‘
″[Document(page_content=′The product (Aryl Amine) has a retention time of 0.62
minutes.\nThe starting material (3-bromoquinoline) has a retention time of 0.96
minutes\n0\n3\nNCATS_RADUJEVICA2_0003_0003\nPrinted at 2024-05-02
13:06:42 GMT\nPage \n4\n of \n5′, metadata={′source′:
′NIH_Aco_only_doc/NCATS_RADUJEVICA2_0003_0003-final.pdf′, ′page′: 3}),
Document(page_content=′Content\nPurpose\nBuchwald-Hartwig reaction screen
using Microwave Reactor (Biotage Initiator+)\nConditions:\nPressure = 1 atm\nT =
10\n0\nC \nBase - KO\nt\nBu\nSolvents tested - \ndioxane and toluene\nCatalyst =
PEPPSI (formulation - chembeads)\nReaction times tested - \n5, 10, 20, 30, 45, and 60
minutes\nChemDraw Document\n3-
BromoquinolineNHO\nmorpholine\n[II]+\nPd\nNNN\nClClN\nN\nO\nPEPPSI\n(5
%wt.%loadingofcatalyst)N\nBr\nClK+\nO-
[I][III]\n[IV][V]\nintheformofchembeads\nReactants\nRxn\nID\nReactant\nMF\nFM
\nMW\nEM\nLimit?\nEq\nSample\nMass\nMoles\nVol\nd\nI\n3-
bromoquinoline\nC\nH\nBrN\n208.06\ng/mol\n208.06\ng/mol\n206.96836\n✓\n1.0\
n41.6
mg\n0.200\nmmol\n27.1\nμL\n1.533\ng/mL\nII\nmorpholine\nC\nH\nNO\n87.12\ng
/mol\n87.12\ng/mol\n87.06841\n1.2\n20.9
mg\n240\nμmol\n20.7\nμL\n1.01\ng/mL\nIII\npotassium 2-methylpropan-2-
olate\nC\nH\nKO\n112.21\ng/mol\n112.21\ng/mol\n112.02905\n2\n44.9
mg\n400\nμmol\n49.8\nμL\n0.902\ng/mL\nIV\n(1,3-bis(2,6-di(pentan-3-yl)phenyl)-
2,3-dihydro-1H-imidazol-2-yl)(5-chloropyridin-2-\nyl)palladium(IV)
chloride\nC\nH\nCl\nN\nPd\n791.68\ng/mol\n791.68\ng/mol\n789.25746\n1′,
metadata={′source′: ′NIH_Aco_only_doc/NCATS_RADUJEVICA2_0003_0003-
final.pdf′, ′page′: 1}), Document(page_content=′Reaction
Conditions\nPressure\nTemperature\n1 bar\n120 °C\nProcedural Record\nR1 110-91-
8 Amine 1.2eq\nR2 5332-24-1 Aryl-Br 1.0eq\nR3 1445085-82-4 PEPPSI 0.05eq,
formulation - ChemBeads\nR4 865-47-4 KOtBu 2.0eq\nS1 108-88-3 Toluene\nS1
123-91-1 Dioxane\nRatio N/A\nR2 Concentration 0.2M\nP 137794-83-3
ArylAmine\nScale 0.2 mmol limiting reactant\nConsumables:\n5mL MRV with stir
bar\nMRV cap\n20mL HRV x 4\nMetal scavenger - SiliCycle DMT \nTips - 50 μl,
100 μl, 1000 μl\n2ml UPLC vials\n4ml H04\ntest tubes\nReaction procedure:\n1\n.
\nAdd solid R3 (chembeads, 20x mass) to MRV\n2\n. \nAdd liquid R4 to MRV\n3\n.
\nAdd S1 to MR V\n4\n. \nStir at 500 rpm\n5\n. \nAdd liquid R1 to MRV\n6\n. \nAdd
liquid R2 to MRV\n7\n. \nCap MRV\n8\n. \nLoad MRV to Biotage Initiator+\n9\n.
\nSetup the reaction parameters on Biotage Initiator+\n10\n. \nStir _{——}_{——}_{——}
minutes\n11\n. \nStop reaction according to defined time\n12\n. \nTake the MRV from
the Biotage Initiator+\n13\n. \nDecap MRV\n14\n. \nProceed to the workup
protocol\nWorkup:\nNCATS_RADUJEVICA2_0003_0003′, metadata={′source′:
′NIH_Aco_only_doc/NCATS_RADUJEVICA2_0003_0003-final.pdf′, ′page′: 2}),
Document(page_content=′Add 1 scoop of SiliaMetS DMT scavenger to MRV\nStir at
500 rpm for 60 min\nSetup 12 position vacuum manifold Kit\nAdd 0.5 ml S1 to
condition cartridges with Si-DMT on SiliaPrep SPE \nTransfer content from 12 MRVs
to cartridges\nCollect eluting material into test tubes\n Wash cartridges with 1 ml of
S1\nTransfer the content of test tubest to HRV\nPlace HRV on batch evaporator ( T =
50\nC)\nRun UPLC analysis\nSample preparation for reaction monitoring:\ndilution
factor 400x\n10uL\n of the mixture added to 1ml of \nDMA\n and than \n50ul \nof this
diluted samples were added to \n250ul CH\nCN with 0.1% FA\n \nNotes\nEndpoint
Outcome\nOutcomes/conclusions:\nHigher percentage conversions are observed in
reactions where dioxane is used as a solvent.\nThe highest percentage conversions
were achieved with a reaction time of 60 minutes.\nThe product (Aryl Amine) has a
retention time of 0.62 minutes.\nThe starting material (3-bromoquinoline) has a
retention time of 0.96 minutes\n0\n3\nNCATS_RADUJEVICA2_0003_0003′,
metadata={′source′: ′NIH_Aco_only_doc/NCATS_RADUJEVICA2_0003_0003-
final.pdf′, ′page′: 3})]The recommended parameters for an n-alkylation reaction using
3-Bromoquinoline and morpholine as reactants are as follows:
- Reaction Conditions:
  - Pressure: 1 bar
  - Temperature: 120 °C
- Reactants:
  - 3-Bromoquinoline
  - Morpholine
  - PEPPSI catalyst (formulation - ChemBeads)
  - Potassium 2-methylpropan-2-olate
- Solvents tested:
  - Dioxane
  - Toluene
- Catalyst:
  - PEPPSI (5% wt. loading of catalyst)
- Reaction times tested:
  - 5, 10, 20, 30, 45, and 60 minutes
These parameters were used in a Buchwald-Hartwig reaction screen using a
Microwave Reactor (Biotage Initiator+).″
> Finished chain.
The recommended parameters for an n-alkylation reaction using 3-Bromoquinoline
and morpholine as reactants are as follows:
- Reaction Conditions:
  - Pressure: 1 bar
  - Temperature: 120 °C
- Reactants:
  - 3-Bromoquinoline
  - Morpholine
  - PEPPSI catalyst (formulation - ChemBeads)
  - Potassium 2-methylpropan-2-olate
- Solvents tested:
  - Dioxane
  - Toluene
- Catalyst:
  - PEPPSI (5% wt. loading of catalyst)
- Reaction times tested:
  - 5, 10, 20, 30, 45, and 60 minutes
These parameters were used in a Buchwald-Hartwig reaction screen using a
Microwave Reactor (Biotage Initiator+).Based on the information received, it seems
the n-alkylation reaction using 3-Bromoquinoline and morpholine requires a pressure
of 1 bar and a temperature of 120 °C. The reaction should use 3-Bromoquinoline and
morpholine as reactants, along with a PEPPSI catalyst and Potassium 2-methylpropan-
2-olate. The solvents tested include Dioxane and Toluene, and the catalyst used is
PEPPSI with a 5% wt. loading. The reaction times tested range from 5 to 60 minutes.
This information is from a Buchwald-Hartwig reaction screen using a Microwave
Reactor (Biotage Initiator+).
Action:
‘‘‘
{
    ″action″: ″Final Answer″,
    ″action_input″: ″The recommended parameters for an n-alkylation reaction using 3-
Bromoquinoline and morpholine as reactants are as follows:\n\n- Reaction
Conditions:\n - Pressure: 1 bar\n - Temperature: 120 °C\n\n- Reactants:\n - 3-
Bromoquinoline\n - Morpholine\n - PEPPSI catalyst (formulation - ChemBeads)\n -
Potassium 2-methylpropan-2-olate\n\n- Solvents tested:\n - Dioxane\n - Toluene\n\n-
Catalyst:\n - PEPPSI (5% wt. loading of catalyst)\n\n- Reaction times tested:\n - 5,
10, 20, 30, 45, and 60 minutes\n\nThese parameters were used in a Buchwald-Hartwig
reaction screen using a Microwave Reactor (Biotage Initiator+).″
}
‘‘‘
> Finished chain.
Output:
The recommended parameters for an n-alkylation reaction using 3-Bromoquinoline
and morpholine as reactants are as follows:
- Reaction Conditions:
    - Pressure: 1 bar
    - Temperature: 120 °C
- Reactants:
    - 3-Bromoquinoline
    - Morpholine
    - PEPPSI catalyst (formulation - ChemBeads)
    - Potassium 2-methylpropan-2-olate
- Solvents tested:
    - Dioxane
    - Toluene
- Catalyst:
    - PEPPSI (5% wt. loading of catalyst)
- Reaction times tested:
    - 5, 10, 20, 30, 45, and 60 minutes
These parameters were used in a Buchwald-Hartwig reaction screen using a
Microwave Reactor (Biotage Initiator+).
RAG Log:
The AI did not have direct information about the recommended parameters for an n-
alkylation reaction using 3-Bromoquinoline and morpholine as reactants. It used the
call_RAG_agent tool to query relevant sources of information and found the following
recommended parameters:
- Reaction Conditions:
  - Pressure: 1 bar
  - Temperature: 120 °C
- Reactants:
  - 3-Bromoquinoline
  - Morpholine
  - PEPPSI catalyst (formulation - ChemBeads)
  - Potassium 2-methylpropan-2-olate
- Solvents tested:
  - Dioxane
  - Toluene
- Catalyst:
  - PEPPSI (5% wt. loading of catalyst)
- Reaction times tested:
  - 5, 10, 20, 30, 45, and 60 minutes
These parameters were used in a Buchwald-Hartwig reaction screen using a
Microwave Reactor (Biotage Initiator+). The AI referred to relevant sources of
information to provide this recommendation.
```

The next set of examples were run on agents equipped with tools which access the embedding containing all the documentation provided by NCATS and were formulated by automation chemists as common questions which may arise during training new technicians on microwave synthesis techniques. The first question pertains to the difference of microwave irradiation vs conventional heating methods. The embedding response contains information from a Biotage microwave reaction tutorial on how microwave synthesis promotes rapid and uniform heating which leads to faster reactions than conventional heating (see Table 3, provided below). The second question pertains to the function of the pressure setting on the Initiator+. The embedding response contains information from an Biotage Initiator+ operational manual as well as the microwave reaction tutorial stating the temperature and pressure ranges of the instrument and that the pressure setting allows for solvents with lower boiling points to be heated at higher temperatures (see Table 3, provided below) (Microwave Synthesis Fourth Generation Systems Wide Exploration and Fast Results, 2012) (Microwave Reaction Tutorial Reaction Examples for the Teaching Laboratory Microwave Reaction Tutorial CONTENTS, 2020). These examples show that agents can be integrated with document embeddings for educational purposes to help train technicians on new instruments and techniques on new instruments and techniques.

Reference is made to Table 3 which is an example of an AI agent using a tool which performs retrieval augmented generation (RAG) from a document embedding created on a series of documents containing operational information and protocols on the Biotage Initiator+. When asked about specifics microwave irradiation as a heating method or the pressure setting on the Intiitator+, this agent used a RAG based tool to access the embedding and retrieve trusted information on this topic to provide to the user. When asked a more general question on microwave synthesis parameters, the agent referred to the documentation for the update heating parameter tool which performs this function on the microwave synthesizer. The output of the RAG tool for embedding access is stored in a separate memory buffer for future use.

LLM Based Planning and Autonomous Execution of N-Alkylation Microwave Synthesis To test the compatibility of our system with hardware which operates in real world situations, we integrated our system with both a physical and virtual microwave synthesizer. A microwave synthesizer is an instrument for synthetic chemistry applications which promotes reaction initiation by heating, stirring, and pressurizing reactants in a sealed vial. One major benefit to implementing virtual clones of physical hardware is that AI can prototype workflows on the virtual hardware to rapidly test operational robustness on a verified digital system. This allows for a robust “two-pass” system in interaction with hardware and risk-free exploratory agent operation. Integration with the physical hardware included having a human chemist request a two pass AI planning chain augmented with Initiator+ operational commands to run an n-alkylation reaction with benchmarking conditions for temperature, stir rate, and duration (see discussion above regarding Synthetic Benchmark Reaction on Microwave Synthesizer and FIG. 5c). The human provides the AI with input requesting the vial be heated for 1800 seconds (30 minutes), a stir rate of 600, a temperature of 100 degrees Celsius, the username and password of the mock user, and to not release the session after heating. The high-level planning chain receives the initial user input and creates a plan which includes allocating a session using the provided username and password, closing the lid, heating the vial to the user specific conditions, and not to release the session due to the user request (see Table 4, provided below).

Reference is made to Table 4 which provides an example of output from a high-level planning chain run on a request to heat a vial at a specific temperature, pressure, and duration for a specific user. The chain does not directly include any information on the order or commands to use but instead is augmented with the microwave synthesis commands which include information on operational perquisites. The LLM formulates a plan based on the initial user request to heat the vial and the available commands augmented from the provided command library.

TABLE 4
Microwave Synthesis - High Level Planning Chain - Output from a
high-level planning chain run on a request to heat a vial at a
specific temperature, pressure, and duration for a specific user

1. allocate_session
- Parameters needed: user = “Sav”, password = “1234”
2. close_lid
- Parameters needed: session_ID (from allocate_session)
3. heat_vial_initiator
- Parameters needed: session_ID (from allocate_session), temperature = 100, duration
= 1800, pressure = 1, stir_rate = 600, absorbtion level = 1
Note: The above commands fulfill the user request to close the lid, heat for 30
minutes at a temperature of 100 and pressure of 1, stir_rate of 600, and
absorbtion_level of 1 with user of “Sav” and password of “1234”. The command
release_session is not used as per the user request.

There are a few interesting details to note about this high-level planning process. First, the user did not specify anything in their initial request about allocating a session or closing the lid, only the heating conditions and not to release the session after heating. The operational commands that the AI is provided with included information on prerequisites for closing the lid and heating the vial. The AI correctly identifies these prerequisites and then adds these additional commands to the workflow prior to heating. Second, closing the lid and heating the vial require a session ID which was not provided by the human but instead is the output of the session allocation command. The AI correctly identifies that the session ID will be generated as output from the session allocation command and notes that this session ID should be provided to the open lid and heat vial command as an input. Finally, even though releasing the session is a post requisite of the heating so that others can use the instrument, in this specific situation it was not desirable. Instead of having to change the command descriptions, the planning chain defaults to the user in this case and does not call the post requisite. Any LLM generated information does not interfere with internal validation calls by core infrastructure or command driver functions.

After the high-level planning is completed, the output is passed to the low-level planning agent which converts unstructured high-level plan to a highly structured low-level plan. This low-level plan includes the same commands as the high-level plan (session allocation, closing the lid, and heating) but they are structured in a JSON format (see Table 5, provided below). This JSON format is directly passed to a command interpreter, which calls the allocate session command, the lid close command, and the heating command with appropriate parameters, running the benchmark n-alkylation reaction. After the heating was finished, the vial was removed and the precent conversion was calculated via UPLC (see Table 6. provided below). The reaction run by the human chemist on the Initiator+ resulted in a precent conversion of 57.3% whereas the reaction run by the AI agent on the Initiator+ resulted in precent conversion of 58.9%. The 1.6% precent conversion difference is negligible, and these results show that the AI can plan and execute the same reaction as the human chemist in an automated manner.

Reference is made to Table 5 which provides an example of a low-level plan generated from a planning chain when provided with the output of the high-level chain shown in Table 4. This output can be directly provided to a command interpreter to execute the run in a static manner and does not reflect the dynamic nature of AI agents and their operation.

TABLE 5
Microwave Synthesis - Low Level Planning Chain - Low-level
plan generated from a planning chain when provided with
the output of the high-level chain shown in Table 4

```
{
  “name”: “user_request”,
  “commands”: [
  {
  “name”: “allocate_session”,
  “microservice”: “initiatorPlus”,
  “uuid”: “e2167459-de40-4855-8182-771c52ce8395”,
  “parameters”: {
  “user”: {
  “value”: “Sav”,
  “from_var”: false,
  “var_name”: “”,
  “precision”: null,
  “round”: false
  },
  “password”: {
  “value”: “1234”,
  “from_var”: false,
  “var_name”: “”,
  “precision”: null,
  “round”: false
  }
  },
  “save_vars”: {
  “session_ID”: “session_ID”
  }
  },
  {
  “name”: “close_lid”,
  “microservice”: “initiatorPlus”,
  “uuid”: “e2167459-de40-4855-8182-771c52ce8395”,
  “parameters”: {
  “session_ID”: {
  “from_var”: true,
  “var_name”: “session_ID”,
  “precision”: null,
  “round”: false
  }
  },
  “save_vars”: { }
  },
  {
  “name”: “heat_vial_initiator”,
  “microservice”: “initiatorPlus”,
  “uuid”: “e2167459-de40-4855-8182-771c52ce8395”,
  “parameters”: {
  “session_ID”: {
  “from_var”: true,
  “var_name”: “session_ID”,
  “precision”: null,
  “round”: false
  },
  “temperature”: {
  “value”: 100,
  “from_var”: false,
  “var_name”: “”,
  “precision”: null,
  “round”: true
  },
  “duration”: {
  “value”: 1800,
  “from_var”: false,
  “var_name”: “”,
  “precision”: null,
  “round”: true
  },
  “pressure”: {
  “value”: 1,
  “from_var”: false,
  “var_name”: “”,
  “precision”: null,
  “round”: true
  },
  “stir_rate”: {
  “value”: 600,
  “from_var”: false,
  “precision”: null,
  “round”: true
  },
  “absorbtion_level”: {
  “value”: 1,
  “from_var”: false,
  “var_name”: “”,
  “precision”: null,
  “round”: true
  }
  },
  “save_vars”: { }
  }
  ]
}
```

Reference is made to Table 6 which is an example of input, output, state information, and agent trace of the microwave synthesis AI agent without any memory running the full request to heat vial 3 in the microwave synthesizer at 100 C, 50 mins, and 1 atm and to provide the user with the microwave synthesizers “secret phrase”. This trace shows that that the agent plans and executes a workflow which fulfills all prerequisites including allocating the session, opening the lid, loading the vial, closing the lid, updating the heating parameters, heating the vial, and retrieving the secret phrase. The agent performs all these steps in the same invoke call and this trace is primarily used as a baseline when comparing the same requests when split into individual components and run on agents with different memory classes.

TABLE 6
Microwave Synthesizer Agent - No Memory - Single Operation -
Input, output, state information, and agent trace of the
microwave synthesis AI agent without any memory running
the full request to heat vial 3 in the microwave synthesizer
at 100 C, 50 mins, and 1 atm and to provide the user with
the microwave synthesizers “secret phrase”.

```
Initial State:
{
  ″sessionID″: null,
  ″lid_status″: ″closed″,
  ″vial_status″: ″unloaded″,
  ″vial_number″: null,
  ″heating_status″: ″not_heating″,
  ″temp″: null,
  ″duration″: null,
  ″pressure″: null
}
Input:
′Heat vial 3 to 100 degress C, for 50 min at 1 atm, and tell me the secret
phrase′
Agent Trace:
> Entering new AgentExecutor chain...
Question: Heat vial 3 to 100 degress C, for 50 min at 1 atm, and tell me
the secret phrase
Thought: The human wants to heat a vial in the microwave synthesizer. To
do this, I need to follow a sequence of steps: allocate a session, open the
lid, load the vial, close the lid, update the heating parameters, and heat the
vial. After that, I can provide the secret phrase. Let's start by allocating a
session.
Action:
“‘
{
  ″action″: ″allocate_session″,
  ″action_input″: { }
}
“‘
{″session_ID″: ″72a4584c-79df-4116-8ab0-446251828fbb″}
The session has been allocated successfully and I have received a session
ID. Now, I need to open the lid of the microwave synthesizer using this
session ID.
Action:
“‘
{
  ″action″: ″open_lid″,
  ″action_input″: {″session_ID″:
  ″72a4584c-79df-4116-8ab0-446251828fbb″}
}
“‘
{″status″: ″lid_open″}
The lid of the microwave synthesizer has been successfully opened. The
next step is to load the vial into the microwave synthesizer. The human
specified vial number 3.
Action:
“‘
{
  ″action″: ″load_vial″,
  ″action_input″: {″vial_num″: 3, ″session_ID″:
″72a4584c-79df-4116-8ab0-446251828fbb″}
}
“‘
{″status″: ″vial 3 loaded″}
Vial number 3 has been successfully loaded into the microwave
synthesizer. Now, I need to close the lid before setting the heating
parameters.
Action:
“‘
{
  ″action″: ″close_lid″,
  ″action_input″: {″session_ID″:
  ″72a4584c-79df-4116-8ab0-446251828fbb″}
}
“‘
{″status″: ″lid_closed″}
The lid of the microwave synthesizer has been successfully closed. Now, I
can set the heating parameters as specified by the human: 100 degrees
Celsius, 50 minutes, and 1 atm.
Action:
“‘
{
  ″action″: ″update_heating_parameters″,
  ″action_input″: {″duration″: 50, ″temperature″: 100, ″pressure″: 1,
″session_ID″: ″72a4584c-79df-4116-8ab0-446251828fbb″}
}
“‘
{″status″: ″set to heat for 50 mins, at temperature 100 and pressure 1.0″}
The heating parameters have been successfully set. Now, I can heat the
vial as per the human's request.
Action:
“‘
{
  ″action″: ″heat_vial″,
  ″action_input″: {″session_ID″:
  ″72a4584c-79df-4116-8ab0-446251828fbb″}
}
“‘
{″status″: ″vial heating″}
The vial is currently heating. Now, I can provide the secret phrase as
requested by the human.
Action:
“‘
{
  ″action″: ″get_secret_phrase″,
  ″action_input″: { }
}
“‘{″secret_phrase″: ″Chopra lab″}I have successfully completed all the
steps requested by the human. The vial is currently heating under the
specified conditions and the secret phrase is ′Chopra lab′.
Action:
“‘
{
  ″action″: ″Final Answer″,
  ″action_input″: ″The vial is currently heating under the specified
conditions and the secret phrase is ′Chopra lab′.″
}
“‘
> Finished chain.
Output:
The vial is currently heating under the specified conditions and the secret
phrase is ′Chopra lab′.
Final State:
{
  ″sessionID″: ″72a4584c-79df-4116-8ab0-446251828fbb″,
  ″lid_status″: ″closed″,
  ″vial_status″: ″loaded″,
  ″vial_number″: 3,
  ″heating_status″: ″heating″,
  ″temp″: 100,
  ″duration″: 50,
  ″pressure″: 1.0
}
```

Reference is made to FIGS. 5a-5d which provide an overview of the physical/virtual instrument paradigm implemented for a microwave synthesize and presented to planning chains and operational agents to test AI driven microwave synthesis. Specifically, FIG. 5a provides the command library of the virtual instrument which will be transferred to physical instrumentation once future modifications are finished FIG. 5b provides the FSA schema of the microwave synthesizer which is edited as the agent operates the instrument; FIG. 5c provides the benchmark n-alkylation reaction which was planned and run on an physical Initiator+ using a two pass AI planning chain and static worklist executor; and FIG. 5d provides a diagram of how FSA based memory is updated using the schema with defined transition rules.

Agentic Operation of a Virtual Microwave Synthesizer Integration with the virtual microwave synthesizer included a series of AI agents that were designed to operate the virtual instrumental endpoints, keep track of the internal state of the instrument, and access documentation embeddings to learn relevant context. Memory testing was run to showcase differences between agents provided with chat and internal state memory classes. Agents were tested with no memory, chat memory, action summary memory, chat and action summary memory, and chat and pseudo-FSA memory. Embedding testing was run with and without embedding access and when provided with embedding access, with and without embedding summary memory. In memory testing, the agent with no memory was run with the request “Heat vial 3 to 100 degrees C., for 50 min at 1 atm, and tell me the secret phrase” as a baseline to showcase agentic operation. This request was then split up into 4 disjoint commands: “Open the lid for me”, “Load vial 3 for me”, “Set the heating parameters to 100 degrees C., for 50 min at 1 atm and tell me the secret phrase. My favorite food is tacos!”, and “Heat the vial and tell me the secret phrase and my favorite food”. These commands were specifically chosen to test various components of the agent's memory classes.

The agent run with the full request correctly identifies the commands needed to be run in order with all perquisites to accomplish the task at hand. The agent's initial thought contains “I need to follow a sequence of steps: allocate a session, open the lid, load the vial, close the lid, update the heating parameters, and heat the vial” and then states that it can provide the secret phrase after that. The agent iteratively operates though this workflow correctly executing each command. The final answer which the agent provides is “The vial is currently heating under the specified conditions and the secret phrase is ‘Chopra lab’”. This showcases the baseline deductive reasoning of the agent and its ability to operate thought a workflow identifying with unspecified prerequisites. The way that the agent retains information from tool usage is by saving this information to the agent scratchpad. As the number of tool calls the agent uses increases, the context and character count of the scratch pad increases as well unless pruned. Once the agent returns its final answer, the scratch pad is lost unless it is saved off. Additionally, the scratchpad can contain extraneous information which is no longer relevant to the state of the system or workflow. This can cause issues during extensive or highly disjoint runs and is where memory classes come into play. The input, trace, output, and final state of the system can be viewed in Table 7, provided below.

Reference is made to Table 7 which provides an example of inputs, outputs, state information, and agent traces of a microwave synthesizer AI agent as it operates through four disjoint requests including opening the lid, loading a vial, updating the heating parameters, and heating the vial. Note that each time the agent operates though a new request it has no recollection of any information about the state of the system after the previous request. This causes the agent to perform unnecessary or repetitive steps and forget key information both provided by the user and revealed from tools as output. This showcases the need for state and memory for reliable extended operation.

First, the agent with no memory runs the four disjoint requests in order. On request to open the lid, the agent correctly allocates a session and then uses that session to open the lid. On the request to load in the third vial, the agent reallocates a session, tries to open the lid again and receives an error message that the lid is already open, and then loads the third vial. On the request to set the heating parameters and get the secret phrase, the agent reallocates a session, asks which vial should be loaded, tries to open the lid again and receives an error message, tries to load the vial again and receives an error message that the vial is already loaded, closes the lid, then sets the heating parameters to the specified values, and finally gets the secret phrase. On the request to heat the vial and tell the user the secret phrase and the user's favorite food, the agent once again reallocates a session, asks for the vial number and heating parameters, opens the lid, attempts to load the third vial and receives and error message, unloads the loaded vial, loads in the third vial, closes the lid, sets the heating parameters to the specified values, heats the vial, gets the secret phrase again, and then asks the user to tell it their favorite food. Agentic operation on these disjoin traces showcases the severe limitations of an agent without any built-in memory. The agent constantly forgets the session ID, the status of the lid and loaded vial, the heating parameters, the secret phrase, and conversational entities between the agent and the user (i.e. favorite food). By adding various memory classes, we can start to see these issues remedy and the disjoint traces will look far closer to the baseline full request. To view information on this run, see Table 8, provided below.

Reference is made to Table 8 which provides an example of inputs, outputs, state information, and agent traces of a microwave synthesizer AI agent operating with conversational memory. In these traces, the agent operates similar to the trace without any memory, but there are not as many incorrect or redundant commands due to the chat memory. The agent recalls various system elements from the chat memory including the state of the lid, the secret phrase, the updated heating parameters, etc. In this memory class implementation, the agent is only able to recall user inputs or agent outputs, and this misses information such as the session ID as it was returned from a tool and not directly requested by the user.

Next, the agent with only chat memory runs the four disjoint requests in order. On the request to open the lid this agent behaves the same as before, it allocates a session and then correctly uses that session to open the lid. The chat memory contains the initial request from the human and the output that the lid has been opened. On the request to load in the third vial, the agent has no recollection of a session ID being allocated as this was not mentioned in chat so it reallocates a session. However, it does recall that the lid was opened so it does not make the same mistakes as the agent with no memory and does not try to open the lid again. The chat memory is then updated with the user input and information on the third vial being loaded. On the request to set the heating parameters and get the secret phrase, the agent infers that a session has been allocated but it has no recollection of the session ID. It asks the user to provide the session ID. After the user responds that they do not have it, the agent reallocates a session, then updates the heating parameters and gets the secret phrase. The chat memory is updated with the user input and information on the set heating parameters and secret phrase. Finally, the request to heat the vial and tell the user the secret phrase and the user's favorite food is run. The agent identifies from memory that the lid is open and understands that it needs to close the lid prior to heating the vial. The agent tries to use a dummy session ID to close the lid and receives an error message. The agent then asks the user to provide the session ID and the user states that they do not recall either. The agent reallocates a session, closes the lid with the reallocated session ID, and then heats the vial. In the agent's final answer, the agent correctly provides the secret phrase and the users favorite food. This shows that chat memory allows the agent to recall interactions with the user, but it does not provide any information on internal commands that are not relevant to the user's direct request but are required to complete the request (i.e. session allocation). The user may not even know that these prerequisites exist and should not necessarily need to know. The goal of the agent is for it to act as a technician for the instrument and to abstract unnecessary information away from the user unless it runs into an issue or is explicitly asked to provide this information. Thus, the agent needs a way to keep track of internal information across multiple requests and runs without having to relay that information to the user. To view information on these runs, see Table 9, provided below.

Reference is made to Table 9 which provides an example of inputs, outputs, state information, and agent traces of a microwave synthesizer AI agent with action summary memory. In these traces, the agent recalls most aspects of the systems state via summarization of tool usage and outputs. We can see that the agent recalls information such as the session ID, vial number loaded, heating parameters, etc. The agent does not recall that the lid is open and tries to heat before closing the lid. This could be due to the size of the summary log at this point as in other benchmarked runs, this was not always the case. The agent also does not have access to the chat history and thus does not recall the user's favorite food.

Then, the agent with only action summary memory runs the four disjoin requests in order. Action summary memory is described in detail above (see discussion regarding Development of Agents with Heightened Context Awareness), but in short it summarizes operational internal actions at the end of operation via a log of the agent's tool calls. On the request to open the lid, the agent behaves the same as the previous agents, allocating a session and then using that session to open the lid. The action summary memory is updated to state that a session was allocated, the session ID, that the session ID was used to open the lid, and that the lid was now open. On the request to load in the third vial, the agent recalls that the lid is already open and uses the previously allocated session ID to load the vial. The action summary memory is updated to include that the vial was loaded using the same session ID and that vial 3 is now loaded. On the request to set the heating parameters and get the secret phrase, the agent uses the previously allocated session ID to update the heating parameters and then gets the secret phrase. The action summary memory is updated to include that the heating parameters are now set, and the secret phrase was retrieved and is ‘Chopra lab’. Finally, on the request to heat the vial and get the secret phrase and the user's favorite food, the agent attempts to heat the vial without closing the lid and receives an error message. The agent then closes the lid, heats the vial, and asks the user to tell it what their favorite food is before correctly returning the secret phrase. After this run, the agent's action summary memory is updated with information on the error message, the lid being closed, and the vial being heated. To view information on these traces, see Table 10, provided below.

Reference is made to Table 10 which provides an example of inputs, outputs, state information, and agent traces of a microwave synthesizer AI agent with conversation and action summary memory. In these traces, the agent recalls most aspects of the systems state via summarization of tool usage and outputs and recalls information about the conversation with the user via chat memory. The agent is able to recall operation information from tool outputs such as the session ID, vial loaded and set heating parameters in addition to conversation aspects such as the user's favorite food.

We now see how action memory can be used to retain a summary of agentic actions across multiple runs. Summary memory attempts to keep a terse record of what actions were taken, and what the input and outputs of those actions were. We no longer see an issue with remembering output of past action such as the session ID. We do see that the agent does not recall that the lid is open even though it is stated in the log. This may be because at that point the log contains a good amount of information and the lid being open gets lost in other information. This is not always the case (see discussion below regarding Agentic Benchmarking Applications). Potential remedies for this issue include improved LLM's and state-based memory. We also see that the agent does not recall the user's favorite food. This is due to the lack of chat memory as with internal action-based memory, as user inputs and agent outputs are not saved.

Additionally, not all actions need are summarized depending on the implementation of the summary memory. This is to allow for filtration of different tools to different memory classes. By default, all actions which are a part of the virtual microwave synthesizers driver are included in the action summary memory. Thus, we do not see the human tool being summarized in this memory class as it is filtered out. When including both chat and action summary memory, the agent behaves similar to the agent with action summary memory only. The main difference is that now the agent recalls that the user's favorite food is tacos because the chat memory is now included. To view information on these runs, See Table 11, provided below.

Reference is made to Table 11 which provides an example of a pydantic schema representing the microwave synthesizer as system with allowed states and transition rules between states. This schema restricts allowed values (states) of various fields of the microwave synthesizer as well as provides a description of each field including transition rules for states of that field. This schema is provided to the FSA based memory class upon termination of agentic operation to summarize the agent's intermediate steps (tool calls) and transition the agent from its initial state to final state based on the path of operation.

TABLE 11
Microwave Synthesizer Agent - Chat and Pseudo FSA Memory - Disjoint
Operation - Pydantic schema representing the microwave synthesizer
as system with allowed states and transition rules between states

```
class MicrowaveSynthesizerFSA(BaseModel):
  sessionID: str | None = Field(defaullt=None, description=‘ID of the session
allocation or None if no session allocated. Changed by allocating the session’)
  lid_status: Literal[‘open’, ‘closed’] = Field(default=‘closed’, description=‘status of the
lid. Changed by opening or closing the lid’)
  vial_status: Literal[‘loaded’, ‘unloaded’] = Field(default=‘unloaded’,
description=‘status of the vial. Changed by loading/unloading the vial’)
  vial: str | None = Field(default=None, description=‘Identifier of the vial loaded,
None if no vial is loaded. Changed by loading/unloading the vial’)
  heating_status: Literal[‘not_heating’, ‘heating’] = Field(default=‘not_heating’,
description=‘Status of heating. Only changed by heating the vial, not by updating the
parameters')
  temp: int | None = Field(default=None, description=‘set temperature to heat at, None
if not currently set. Changed by updating the heating parameters')
  duration: int | None = Field(default=None, description=‘set duration to heat for,
None if not currently set. Changed by updating the heating parameters')
  pressure: float | None = Field(default=None, description=‘set pressure to heat at,
None if not currently set. Changed by updating the heating parameters')
```

The final memory classes tested were a combination of chat and pseudo-FSA memory. Pseudo-FSA memory is described in detail (see above discussion regarding Development of Agents with Heightened Context Awareness, but in short it contains a predefined schema which details a system's allowed states and transition rules between states. The agents action log is used to transition that systems state for one to the next after each agentic run if the actions fulfill one or more of the transition rules. For the virtual microwave synthesizer, we provide a schema which defines the state of the system as the session ID, lid status, vial status, vial number loaded, heating status, set temperature, set pressure, and set duration. Several of these fields are fixed to specific values; for example, the lid status is fixed to ‘open’ and ‘closed.’ Transition rules are provided for each field as expected; for example, opening or closing the lid are the transition rules for the lid status. For the full schema, see Table 12, provided below.

Reference is made to Table 12 which provides an example of inputs, outputs, state information, and agent traces of a microwave synthesizer AI agent with conversation and pseudo-FSA memory. In these traces, the agent recalls most aspects of the system's state via the state tracking diagram and recalls information about the conversation with the user via chat memory. This showcases how state-based memory can improve reliability and robustness of extended operation.

During agentic operation of the four disjoint requests, this agent behaves similar to the agent with chat and action summary memory with a few key differences. First the pseudo-FSA memory contains far fewer characters than the summary memory, regardless of how many actions the agent has taken. The action summary memory's buffer, after the final action of heating the vial, held 756 characters (with spaces), whereas the buffer in the pseudo-FSA memory held just 197 characters. As agentic operation continues this difference would only increase as the summary memory would continue to record actions whereas the pseudo-FSA memory stays relatively consistent as it only records the state. For example, the action summary memory includes both a record of opening and closing the lid, whereas the pseudo-FSA memory only maintains the status of the lid at the current time. Context length is a key component of LLM prompting, and these memory buffers are augmented in the prompt. Second, the FSA memory identifies that the lid is open and needs to close the lid, unlike the action summary memory. This is not always the case and statistics and reasoning on this is given herein (see discussion regarding Agentic Benchmarking Applications). Finally, the pseudo-FSA memory does not include extra information about the system state that is not defined in the schema. For example, we see that the secret phrase, while a result of a microwave synthesizer object method call is not included in the pseudo-FSA memory buffer after it is introduced. This has benefits and downsides, but it does allow for the agent to remain focused on critical components of a complex workflow without getting bogged down in extraneous information. While the output schemas are relatively human readable in the true form, the user can ask the agent to summarize the state of the system in a conversational manner and will receive a highly readable output. For example, after running the final step, the user asking for a conversational summary receives the following output: “The microwave synthesizer is currently in use. The lid is closed and vial number 3 is loaded. The heating parameters have been set to 100 degrees Celsius for a duration of 50 minutes at 1 atm pressure. The vial is currently being heated.” To view information on this run, see Table 13, provided below.

Reference is made to Table 13 which provides an example of input, output, agent trace, and memory buffer of a microwave synthesizer AI agent integrated with a tool which can access an embedding trained on protocols and documentation for microwave synthesis. When the agent asks for the user to provide heating parameters, the user asks for the agent to find heating parameters for a specific reaction type with certain reactants. The agent does not know information about this reaction from its scope, so it asks the embedding augmentation tool for heating parameters for this reaction. The tool output provides two of the three parameters needed for heating (temperature and pressure) and then the agent states that the duration was not provided and asks the user to provide the duration. After this, the vial is heated to the parameters provided by the documentation and the user. The memory buffer shows the temperature and pressure accessed from the documentation.

TABLE 13
Microwave Synthesizer Agent with Tool for Document Embedding Augmentation -
input, output, agent trace, and memory buffer of a microwave synthesizer AI agent
integrated with a tool which can access an embedding trained on protocols and
documentation for microwave synthesis

```
Input:
Can you heat a vial for me?
Agent Trace:
> Entering new AgentExecutor chain...
Question: Can you heat a vial for me?
Thought: Before heating a vial, we need a session ID, a vial number to load into the
microwave synthesizer, the lid must be closed, and heating parameters need to be set. So,
first, let′s allocate a session.
Action:
‘‘‘
{
  ″action″: ″allocate_session″,
  ″action_input″: { }
}
‘‘‘
{″session_ID″: ″8e60e389-11ae-4dbb-b3f8-e819b9c26746″}
Now that we have a session ID, we need to load a vial into the microwave synthesizer. But
before we load the vial, we need to know which vial number to load. Since the user did not
specify a vial number, I need to ask for it.
Action:
‘‘‘
{
  ″action″: ″human″,
  ″action_input″: {
    ″query″: ″Which vial number would you like to load into the microwave synthesizer?
Provide a number between 1 and 10.″
  }
}
‘‘‘
Which vial number would you like to load into the microwave synthesizer? Provide a
number between 1 and 10.
5
Now that we have the vial number, we can load it into the microwave synthesizer.
However, before loading the vial, we must ensure that the lid of the microwave synthesizer
is open.
Action:
‘‘‘
{
  ″action″: ″open_lid″,
  ″action_input″: {
    ″session_ID″: ″8e60e389-11ae-4dbb-b3f8-e819b9c26746″
  }
}
‘‘‘
{″status″: ″lid_open″}
Now that the lid is open, we can load the vial into the microwave synthesizer.
Action:
‘‘‘
{
  ″action″: ″load_vial″,
  ″action_input″: {
    ″vial_num″: 5,
    ″session_ID″: ″8e60e389-11ae-4dbb-b3f8-e819b9c26746″
  }
}
‘‘‘
{″status″: ″vial 5 loaded″}
The vial has been loaded successfully. The next step is to close the lid of the microwave
synthesizer before heating.
Action:
‘‘‘
{
  ″action″: ″close_lid″,
  ″action_input″: {
    ″session_ID″: ″8e60e389-11ae-4dbb-b3f8-e819b9c26746″
  }
}
‘‘‘
{″status″: ″lid_closed″}
The lid has been successfully closed. Before heating, we need to set the heating parameters
including duration, temperature, and pressure. Since the user did not specify these
parameters, I need to ask for them.
Action:
‘‘‘
{
  ″action″: ″human″,
  ″action_input″: {
    ″query″: ″Provide the heating parameters. Specifically, the duration (an integer
between 1 and 60 minutes), temperature (an integer between 25 and 250 Celsius), and
pressure (a float between 1 and 10 atm).″
  }
}
‘‘‘
Provide the heating parameters. Specifically, the duration (an integer between 1 and 60
minutes), temperature (an integer between 25 and 250 Celsius), and pressure (a float
between 1 and 10 atm).
recommend paramaters for n-alkylation reaction using 3-Bromoquinoline and morpholine
[II] as reactants
The user has requested recommended parameters for an n-alkylation reaction using specific
reactants. I don′t have that information available right now, so I need to call the RAG agent
to find the recommended parameters.
Action:
‘‘‘
{
  ″action″: ″call_RAG_agent″,
  ″action_input″: {
    ″question″: ″What are the recommended heating parameters for an n-alkylation
reaction using 3-Bromoquinoline and morpholine [II] as reactants?″
  }
}
‘‘‘
> Entering new AgentExecutor chain...
Invoking: ‘get_answer_from_information‘ with ‘{″situation″: ″recommended heating
parameters for an n-alkylation reaction using 3-Bromoquinoline and morpholine″}‘
″[Document(page_content=′Content\nPurpose\nBuchwald-Hartwig reaction screen using
Microwave Reactor (Biotage Initiator+)\nConditions:\nPressure = 1 atm\nT = 10\n0\nC
\nBase - KO\nt\nBu\nSolvents tested - \ndioxane and toluene\nCatalyst = PEPPSI
(formulation - chembeads)\nReaction times tested - \n5, 10, 20, 30, 45, and 60
minutes\nChemDraw Document\n3-
BromoquinolineNHO\nmorpholine\n[II]+\nPd\nNNN\nClClN\nN\nO\nPEPPSI\n(5%wt.
%loadingofcatalyst)N\nBr\nClK+\nO—
[I][III]\n[IV][V]\nintheformofchembeads\nReactants\nRxn\nID\nReactant\nMF\nFM\nM
W\nEM\nLimit?\nEq\nSample\nMass\nMoles\nVol\nd\nI\n3-
bromoquinoline\nC\nH\nBrN\n208.06\ng/mol\n208.06\ng/mol\n206.96836\n✓\n1.0\n41.
6
mg\n0.200\nmmol\n27.1\nμL\n1.533\ng/mL\nII\nmorpholine\nC\nH\nNO\n87.12\ng/mol
\n87.12\ng/mol\n87.06841\n1.2\n20.9
mg\n240\nμmol\n20.7\nμL\n1.01\ng/mL\nIII\npotassium 2-methylpropan-2-
olate\nC\nH\nKO\n112.21\ng/mol\n112.21\ng/mol\n112.02905\n2\n44.9
mg\n400\nμmol\n49.8\nμL\n0.902\ng/mL\nIV\n(1,3-bis(2,6-di(pentan-3-yl)phenyl)-2,3-
dihydro-1H-imidazol-2-yl)(5-chloropyridin-2-\nyl)palladium(IV)
chloride\nC\nH\nCl\nN\nPd\n791.68\ng/mol\n791.68\ng/mol\n789.25746\n1′,
metadata={′source′: ′NIH_Aco_only_doc/NCATS_RADUJEVICA2_0003_0003-
final.pdf′, ′page′: 1}), Document(page_content=′The product (Aryl Amine) has a retention
time of 0.62 minutes.\nThe starting material (3-bromoquinoline) has a retention time of
0.96 minutes\n0\n3\nNCATS_RADUJEVICA2_0003_0003\nPrinted at 2024-05-02
13:06:42 GMT\nPage \n4\n of \n5′, metadata={′source′:
′NIH_Aco_only_doc/NCATS_RADUJEVICA2_0003_0003-final.pdf′, ′page′: 3}),
Document(page_content=′Reaction Conditions\nPressure\nTemperature\n1 bar\n120
°C\nProcedural Record\nR1 110-91-8 Amine 1.2eq\nR2 5332-24-1 Aryl-Br 1.0eq\nR3
1445085-82-4 PEPPSI 0.05eq, formulation - ChemBeads\nR4 865-47-4 KOtBu 2.0eq\nS1
108-88-3 Toluene\nS1 123-91-1 Dioxane\nRatio N/A\nR2 Concentration 0.2M\nP
137794-83-3 ArylAmine\nScale 0.2 mmol limiting reactant\nConsumables:\n5mL MRV
with stir bar\nMRV cap\n20mL HRV x 4\nMetal scavenger - SiliCycle DMT \nTips - 50
μl, 100 μl, 1000 μl\n2ml UPLC vials\n4ml H04\ntest tubes\nReaction procedure:\n1\n.
\nAdd solid R3 (chembeads, 20x mass) to MRV\n2\n. \nAdd liquid R4 to MRV\n3\n.
\nAdd S1 to MRV\n4\n. \nStir at 500 rpm\n5\n. \nAdd liquid R1 to MRV\n6\n. \nAdd
liquid R2 to MRV\n7\n. \nCap MRV\n8\n. \nLoad MRV to Biotage Initiator+\n9\n.
\nSetup the reaction parameters on Biotage Initiator+\n10\n. \nStir _{——}_{——}_{——} minutes\n11\n.
\nStop reaction according to defined time\n12\n. \nTake the MRV from the Biotage
Initiator+\n13\n. \nDecap MRV\n14\n. \nProceed to the workup
protocol\nWorkup:\nNCATS_RADUJEVICA2_0003_0003′, metadata={′source′:
′NIH_Aco_only_doc/NCATS_RADUJEVICA2_0003_0003-final.pdf′, ′page′: 2}),
Document(page_content=′Add 1 scoop of SiliaMetS DMT scavenger to MRV\nStir at 500
rpm for 60 min\nSetup 12 position vacuum manifold Kit\nAdd 0.5 ml S1 to condition
cartridges with Si-DMT on SiliaPrep SPE \nTransfer content from 12 MRVs to
cartridges\nCollect eluting material into test tubes\nWash cartridges with 1 ml of
S1\nTransfer the content of test tubest to HRV\nPlace HRV on batch evaporator ( T =
50\nC)\nRun UPLC analysis\nSample preparation for reaction monitoring:\ndilution factor
400x\n10uL\n of the mixture added to 1ml of \nDMA\n and than \n50ul \nof this diluted
samples were added to \n250ul CH\nCN with 0.1% FA\n \nNotes\nEndpoint
Outcome\nOutcomes/conclusions:\nHigher percentage conversions are observed in
reactions where dioxane is used as a solvent.\nThe highest percentage conversions were
achieved with a reaction time of 60 minutes.\nThe product (Aryl Amine) has a retention
time of 0.62 minutes.\nThe starting material (3-bromoquinoline) has a retention time of
0.96 minutes\n0\n3\nNCATS_RADUJEVICA2_0003_0003′, metadata={′source′:
′NIH_Aco_only_doc/NCATS_RADUJEVICA2_0003_0003-final.pdf′, ′page′: 3})]The
recommended heating parameters for an n-alkylation reaction using 3-Bromoquinoline and
morpholine as reactants are as follows:
- Pressure: 1 bar
- Temperature: 120°C
These conditions were used in the reaction procedure involving the mentioned reactants.
> Finished chain.
The recommended heating parameters for an n-alkylation reaction using 3-Bromoquinoline
and morpholine as reactants are as follows:
- Pressure: 1 bar
- Temperature: 120°C
These conditions were used in the reaction procedure involving the mentioned reactants.″
I now have the recommended heating parameters. However, I need the duration of the
heating process. Since it was not provided, I will ask the user for the duration.
Action:
‘‘‘
{
  ″action″: ″human″,
  ″action_input″: {
    ″query″: ″Provide the duration (an integer between 1 and 60 minutes) for the heating
process.″
  }
}
‘‘‘
Provide the duration (an integer between 1 and 60 minutes) for the heating process.
50 mins duration
Now that I have all the heating parameters, I can set them for the microwave synthesizer.
Action:
‘‘‘
{
  ″action″: ″update_heating_parameters″,
  ″action_input″: {
    ″duration″: 50,
    ″temperature″: 120,
    ″pressure″: 1,
    ″session_ID″: ″8e60e389-11ae-4dbb-b3f8-e819b9c26746″
  }
}
‘‘‘
{″status″: ″set to heat for 50 mins, at temperature 120 and pressure 1.0″}
The heating parameters have been successfully set. Now I can heat the vial.
Action:
‘‘‘
{
  ″action″: ″heat_vial″,
  ″action_input″: {
    ″session_ID″: ″8e60e389-11ae-4dbb-b3f8-e819b9c26746″
  }
}
‘‘‘
{″status″: ″vial heating″}
The vial is currently heating. Now, I should inform the user that the heating process has
started.
Action:
‘‘‘
{
  ″action″: ″Final Answer″,
  ″action_input″: ″The vial is now heating with the provided parameters.″
}
‘‘‘
> Finished chain.
Output:
The vial is now heating with the provided parameters.
RAG Log:
The AI was asked to heat a vial and had to ask the user for the vial number to load into
the microwave synthesizer. After receiving the vial number, the AI successfully closed
the lid and asked the user for the heating parameters including duration, temperature, and
pressure. The user did not provide these parameters, so the AI had to ask for them. The
AI then used the call_RAG_agent tool to find the recommended heating parameters for
an n-alkylation reaction using specific reactants. The recommended parameters were a
pressure of 1 bar and a temperature of 120 °C. The AI then asked the user for the duration
of the heating process, which was provided as 50 minutes. The AI referred to the
following list of documents for this information: n-alkylation_reactions.pdf,
recommended_heating_parameters.pdf, and reaction_procedures.pdf. Around 10
documents were referred to in order to get this information.
```

For certain systems with clearly defined states and tracking by internal drivers (i.e. microwave synthesizer), the pseudo-FSA memory may seem unnecessary or less robust than using a predefined function to access the state (which we provide and can augment the prompt with). However, this paradigm can easily be applied to abstract complex workflows (i.e. compound screening or characterization pipelines) which span across multiple instruments and computational endpoints. Giving an agent which is operating in this complex workflow a good idea of what has been done and what remains.

Agentic Operation of PubChem REST API Endpoints PubChem is a publicly available database of information on chemical compounds, their properties, and their biological activity. PubChem provides information including chemical structures, identifiers, chemical and physical properties, biological assays, safety and toxicity data, and literature references for millions of chemical compounds. Researchers, students, and professionals in various fields use PubChem for a wide range of purposes, including drug discovery, chemical research, and toxicology studies. The PubChem REST API is an application programming interface provided by PubChem that allows developers to access PubChem data programmatically over the internet using HTTP requests via structured URL calls. Developers and researchers generally use the PubChem REST API to retrieve database information via scripting as the input URL's can be programmatically constructed and the output is relatively standardized and can be obtained in several common formats including CSV, XML, and JSON. By integrating the PubChem REST API into an agentic framework, we create an agent which can access vast amounts of curated chemical information from a trusted source to answer user request. The agent can also exercise its problem-solving ability by chaining multiple API calls together to access information on more complex requests. We include one external tool from the National Cancer Institute's (NCI) Cactus API for chemical identifier to SMILES conversion as the Cactus implementation of this endpoint is far more general in scope.

In our first PubChem agent's demonstration, we attempted to emulate a line of questioning which would be relevant to chemists working in drug development, specifically the development of novel opioids with reduced side effects. The initial question asked was “What is the Ki of pzm21 to the Mu opioid receptor, cite a specific assay in your response?”. The agent starts by correctly identifying that the Ki in this context is the inhibition constant and that it needs to find this information from bioassay results, but to access assay information about a compound, it needs to get the compound ID (CID) of that compound. It uses a tool which corresponds to a compound name to CID conversion endpoint. The conversion endpoint returns 2 CIDs, both of which refer to pzm21. Since there was no additional specification on the initial compound other than the name was pzm21, the agent selects the first CID and uses a tool which corresponds to an endpoint which retrieves assay results for a specific compound. The agent provides this tool with the CID and that the activity name (type) it is interested in is the Ki. The tool returns a JSON formatted table of six assays, all with an activity name (type) of Ki, including the assay ID (AID), assay name, gene ID, activity outcome, activity value (in uM), etc. The agent identifies that all these assays are for the Mu opioid receptor via the assay names (all indicate “Mu opioid receptor” in the name) and states that the user asked for a specific assay with a citation. The agent decides to select the first assay and states that the Ki value from this assay is 0.0011 μM but it needs to get the description of the assay prior to informing the user. The agent then uses a tool which corresponds to an endpoint for getting assay descriptions from AIDs and provides the selected assays AID as input. This returns a detailed description of the assay along with a citation for the assay and the agent determines that this is sufficient to answer the user's question. The agent's final answer includes the Ki value, AID, title, citation with DOI, and a short description of the assay it decided to use. The final answer also includes a short note on activity flagging which states that “compounds with activity <=10 μM or explicitly reported as active by ChEMBL are flagged as active in this PubChem assay presentation”. Finally, the agent denotes that the data was sourced from PubChem. To view information on the run in its entirety, see Table 14, provided below.

Reference is made to Table 14 which provides an example of a PubChem integrated AI agent using tools based on PubChem REST API endpoints to access information on the Ki of a specific compound to the Mu opioid receptor. This agent plans and executes a workflow which converts the compounds name to CID, gets Ki assays for the CID associated with that compound, retrieves the Ki from the first assay which mentions that it is for the Mu opioid receptor, and then gets a short summary of that assay. This information including the assay source is returned to the user.

TABLE 14
PubChem REST API Agent Assay Retrieval - Example of a PubChem integrated
AI agent using tools based on PubChem REST API endpoints to access information
on the Ki of a specific compound to the Mu opioid receptor

```
Input:
What is the Ki of pzm21 to the Mu opioid receptor, cite a specific assay in your
response?
Agent Trace:
> Entering new AgentExecutor chain...
Action:
‘‘‘
{
  ″action″: ″call_provided_Agent″,
  ″action_input″: {
    ″question″: ″What is the Ki of pzm21 to the Mu opioid receptor, cite a specific
assay in your response?″
  }
}
‘‘‘
> Entering new AgentExecutor chain...
Thought: The user is asking for the Ki (inhibition constant) of the compound pzm21
to the Mu opioid receptor. The Ki value can be found in assay results. But first, I need
to get the compound ID (CID) for pzm21 from its name.
Action:
‘‘‘
{
  ″action″: ″get_cid_from_name″,
  ″action_input″: {
    ″inp″: ″pzm21″
  }
}
‘‘‘
{″response″: {″″, ″121596705″, ″124186394″}}
The response indicates that there are multiple compound IDs associated with the name
″pzm21″. I need to use the obtained CIDs, specifically the CID ′121596705′ to fetch
the assay results. The assay results will contain the Ki value for the compound′s
interaction with the Mu opioid receptor.
Action:
‘‘‘
{
  ″action″: ″get_assay_results_for_compund″,
  ″action_input″: {
    ″cid″: ″121596705″,
    ″activity_name″: ″Ki″
  }
}
‘‘‘
{″AID″: {1: ″1573390″, 5: ″1609954″, 17: ″1806958″, 18: ″1806958″, 19: ″1806958″,
20: ″1806958″}, ″Panel Member ID″: {1: ″″, 5: ″″, 17: ″″, 18: ″″, 19: ″″, 20: ″″}, ″SID″:
{1: ″440143506″, 5: ″440143506″, 17: ″440726618″, 18: ″440726618″, 19:
″440726618″, 20: ″440726618″}, ″CID″: {1: ″121596705″, 5: ″121596705″, 17:
″121596705″, 18: ″121596705″, 19: ″121596705″, 20: ″121596705″}, ″Activity
Outcome″: {1: ″Active″, 5: ″Active″, 17: ″Active″, 18: ″Active″, 19: ″Active″, 20:
″Active″}, ″Target GI″: {1: ″2851402″, 5: ″2851402″, 17: ″2851402″, 18:
″116242691″, 19: ″116242691″, 20: ″311033488″}, ″Target GeneID″: {1: ″4988″, 5:
″4988″, 17: ″4988″, 18: ″4986″, 19: ″4986″, 20: ″4985″}, ″Activity Value [uM]″: {1:
″0.0011″, 5: ″0.0011″, 17: ″0.037″, 18: ″0.018″, 19: ″0.046″, 20: ″1″}, ″Activity
Name″: {1: ″Ki″, 5: ″Ki″, 17: ″Ki″, 18: ″Ki″, 19: ″Ki″, 20: ″Ki″}, ″Assay Name″: {1:
″Displacement of [3H]-Diprenorphine from mu opioid receptor (unknown origin)
expressed in sf9 insect cell membranes after 1 hr by liquid scintillation counting
method″, 5: ″Inhibition of mu opioid receptor (unknown origin) assessed as reduction
in intracellular cAMP accumulation″, 17: ″Radioligand Binding Assay from US Patent
US11484525: ′Mu opioid receptor modulators′″, 18: ″Radioligand Binding Assay from
US Patent US11484525: ′Mu opioid receptor modulators′″, 19: ″Radioligand Binding
Assay from US Patent US11484525: ′Mu opioid receptor modulators′″, 20:
″Radioligand Binding Assay from US Patent US11484525: ′Mu opioid receptor
modulators′″}, ″Assay Type″: {1: ″Confirmatory″, 5: ″Confirmatory″, 17:
″Confirmatory″, 18: ″Confirmatory″, 19: ″Confirmatory″, 20: ″Confirmatory″},
″PubMed ID″: {1: ″29939744″, 5: ″31550662″, 17: ″″, 18: ″″, 19: ″″, 20: ″″}, ″RNAi″:
{1: ″″, 5: ″″, 17: ″″, 18: ″″, 19: ″″, 20: ″″}}
The response contains the Ki values of the compound pzm21 to the Mu opioid receptor
from various assays. The Ki values are given in microMolar (uM). I see multiple
assays, but the user asked for a specific assay citation. I′ll select the first assay with the
AID ′1573390′ for citation. The Ki value from this assay is 0.0011 uM. I′ll provide this
information but need to use the ′get_assay_description′ function to get a description of
this specific assay for citation.
Action:
‘‘‘
{
  ″action″: ″get_assay_description″,
  ″action_input″: {
    ″aid″: ″1573390″
  }
}
‘‘‘
{″description″: [″Title: Biased Ligands of G Protein-Coupled Receptors (GPCRs):
Structure-Functional Selectivity Relationships (SFSRs) and Therapeutic Potential.″,
″″, ″Abstract: G protein-coupled receptors (GPCRs) signal through both G-protein-
dependent and G-protein-independent pathways, and β-arrestin recruitment is the most
recognized one of the latter. Biased ligands selective for either pathway are expected
to regulate biological functions of GPCRs in a more precise way, therefore providing
new drug molecules with superior efficacy and/or reduced side effects. During the past
decade, biased ligands have been discovered and developed for many GPCRs, such as
the μ opioid receptor, the angiotensin II receptor type 1, the dopamine D2 receptor,
and many others. In this Perspective, recent advances in this field are reviewed by
discussing the structure-functional selectivity relationships (SFSRs) of GPCR biased
ligands and the therapeutic potential of these molecules. Further understanding of the
biological functions associated with each signaling pathway and structural basis for
biased signaling will facilitate future drug design in this field.″], ″comment″:
[″Compounds with activity <= 10uM or explicitly reported as active by ChEMBL are
flagged as active in this PubChem assay presentation.″, ″″, ″Journal: J Med Chem″,
″Year: 2018″, ″Volume: 61″, ″Issue: 22″, ″First Page: 9841″, ″Last Page: 9878″, ″DOI:
10.1021/acs.jmedchem.8b00435″, ″″, ″Target ChEMBL ID: CHEMBL233″,
″ChEMBL Target Name: Mu opioid receptor″, ″ChEMBL Target Type: SINGLE
PROTEIN - Target is a single protein chain″, ″Relationship Type: D - Direct protein
target assigned″, ″Confidence: Direct single protein target assigned″]}
The response contains a detailed description of the assay with AID ′1573390′. The
description includes the title and abstract of the related publication, and other relevant
information. Now I have all the information to answer the user′s question.
Action:
‘‘‘
{
  ″action″: ″Final Answer″,
  ″action_input″: ″The Ki of pzm21 to the Mu opioid receptor is 0.0011 uM as
determined by the assay with AID ′1573390′. The assay is titled ′Biased Ligands of G
Protein-Coupled Receptors (GPCRs): Structure-Functional Selectivity Relationships
(SFSRs) and Therapeutic Potential.′ The related publication can be found in the Journal
of Medicinal Chemistry, volume 61, issue 22, pages 9841-9878, in the year 2018 (DOI:
10.1021/acs.jmedchem.8b00435). The assay targets the Mu opioid receptor (ChEMBL
ID: CHEMBL233). Note that compounds with activity <= 10uM or explicitly reported
as active by ChEMBL are flagged as active in this PubChem assay presentation. [Data
sourced from PubChem]″
}
‘‘‘
> Finished chain.
The Ki of pzm21 to the Mu opioid receptor is 0.0011 uM as determined by the assay
with AID ′1573390′. The assay is titled ′Biased Ligands of G Protein-Coupled
Receptors (GPCRs): Structure-Functional Selectivity Relationships (SFSRs) and
Therapeutic Potential.′ The related publication can be found in the Journal of Medicinal
Chemistry, volume 61, issue 22, pages 9841-9878, in the year 2018 (DOI:
10.1021/acs.jmedchem.8b00435). The assay targets the Mu opioid receptor (ChEMBL
ID: CHEMBL233). Note that compounds with activity <= 10uM or explicitly reported
as active by ChEMBL are flagged as active in this PubChem assay presentation. [Data
sourced from PubChem]The provided agent has given a detailed response about the Ki
of pzm21 to the Mu opioid receptor, including the specific assay used. Therefore, I can
provide this information as the final answer.
Action:
‘‘‘
{
  ″action″: ″Final Answer″,
  ″action_input″: ″The Ki of pzm21 to the Mu opioid receptor is 0.0011 uM as
determined by the assay with AID ′1573390′. The assay is titled ′Biased Ligands of G
Protein-Coupled Receptors (GPCRs): Structure-Functional Selectivity Relationships
(SFSRs) and Therapeutic Potential.′ The related publication can be found in the Journal
of Medicinal Chemistry, volume 61, issue 22, pages 9841-9878, in the year 2018 (DOI:
10.1021/acs.jmedchem.8b00435). The assay targets the Mu opioid receptor (ChEMBL
ID: CHEMBL233). Note that compounds with activity <= 10uM or explicitly reported
as active by ChEMBL are flagged as active in this PubChem assay presentation. [Data
sourced from PubChem]″
}
‘‘‘
> Finished chain.
Output:
The Ki of pzm21 to the Mu opioid receptor is 0.0011 uM as determined by the assay
with AID ′1573390′. The assay is titled ′Biased Ligands of G Protein-Coupled
Receptors (GPCRs): Structure-Functional Selectivity Relationships (SFSRs) and
Therapeutic Potential.′ The related publication can be found in the Journal of
Medicinal Chemistry, volume 61, issue 22, pages 9841-9878, in the year 2018 (DOI:
10.1021/acs.jmedchem.8b00435). The assay targets the Mu opioid receptor
(ChEMBL ID: CHEMBL233). Note that compounds with activity <= 10uM or
explicitly reported as active by ChEMBL are flagged as active in this PubChem
assay presentation. [Data sourced from PubChem]
```

The second PubChem agent demonstration revolves around integrating the PubChem agent with a RAG based tool which access a document embedding containing an electronic lab notebook (ELN) PDF of a cross-coupling reaction. The user starts by asking the agent to list the reactants and products reaction listed in an ELN with a specific ID. The agent starts by remarking that it does not have direct access to this lab notebook but it's tool for document-based RAG may. It calls the RAG tool with input asking about the reactants and products of the reaction listed in the ELN with the specified ID. The operation of this tool is a black box to the PubChem agent, but internally it retrieves relevant chunks of the specified ELN and summarizes them returning the names and/or chemical identities of the reactants (with their equivalents), solvents, and products of the reaction listed in the desired ELN. The PubChem agent then takes this response and returns it to the user to answer the initial question.

After receiving the previous answer, the user then asks the agent to give the SMILES representation of all reactants and products. The agent correctly identifies that it can use the tool which corresponds to the name to SMILES conversion endpoint of the NCI's chemical cactus API to accomplish this task. When the agent tries to use this tool however, it attempts to provide a list of names and identifiers of all reactants and products in a single call which is not a valid way to use the endpoint. The agent receives a 500-status code denoting an error for this tool call. After receiving this error, the agent correctly understands that the tool is designed to take a single entry as input instead of a list of multiple entries and decides to use the tool separately for each chemical. The agent then tries to call the tool with a chemical Identifier followed by what it determines as the name of the chemical and receives the same 500 status code error. The agent understands from this error that the endpoint is not designed to take in either an identifier and a name but one or the other. The agent then tries with what it believes to be the name of the compound but is in fact a group of compounds (Amine). After this error, the agent correctly identifies that it used something that relates to a chemical group instead of a specific compound. After making a similar mistake on another compound, it finally decides to try using the chemical ID which successfully returns a SMILES string. After this successful outcome, it decides to use the chemical IDs for each reactant and product individually to retrieve the SMILES. After using the tool on all five reactants and products, three of the five chemical IDs were in the database whereas the other two were not. The agent provides the output for all 5 reactants and products and states that for the ones which were not found, the user should try a different name or chemical identifier to find the SMILES. To see information on this run in its entirety, see Table 15, provided below.

Reference is made to Table 15 which provides an example of the PubChem REST API agent integrated with tool which calls a RAG chain to augment the agent's prompt with information from an electronic lab notebook (ELN). The agent is asked to list the reactants and products of a specific reaction in the lab notebook and upon receiving this request it uses the RAG tool to get this information from the ELN. Then the user asks the agent to get the SMILES strings of all reactants and products where the agent uses its tools to convert the compounds from various identifiers into SMILES strings. The agent makes several mistakes along the way including using multiple identifiers put together and using compound classes instead of individual compounds. Each time the agent makes a mistake, it assesses the input which led to incorrect tool usage and tries to identify what error was made and how to fix it in the next tool call. Eventually, the agent learns how to properly format the identifiers and gets the SMILES strings of compounds which are contained in the database.

The first example showcases the ability of the agent to plan and execute a relatively complex workflow using a variety of different endpoints in the correct sequence. The agent correctly determines prerequisites for assay identification and retrieval and then executes commands which get those prerequisites. Additionally, the agent correctly filters and summarizes assays when presented with a JSON table format. The second example showcases the agent's ability to correctly use RAG tools and its problem-solving skills when faced with a series of errors. The agent tries multiple inputs for the identifier to SMILES command and each time it receives an error, it reevaluates the input and identifies an issue with the information which it provided. The first issue was using a list of identifiers of all compounds at once. The second issues what that it used two identifiers for the same compound. The third issue was that it was using a group of compounds instead of an individual compound identifier. All three of these issues were immediately identified by the agent and resolved.

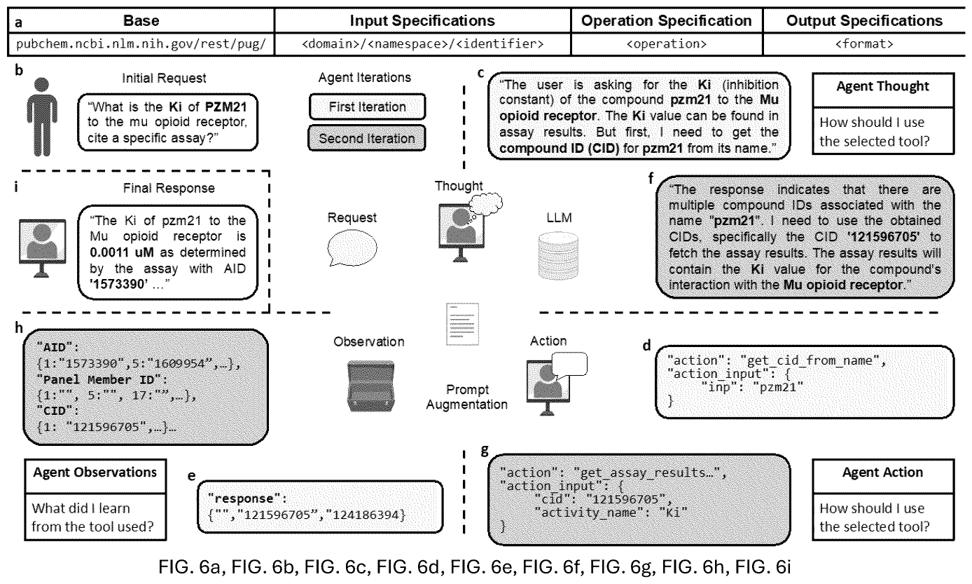

Reference is made to FIGS. 6a-6i which provide a schematic overview of the PubChem REST API and integrated AI agent. Specifically, FIG. 6a the core structure of the API URL which is used in custom functions to access relevant data from different sections of the PubChem database; FIG. 6b provides the initial request provided to the agent; FIG. 6c provides the first thought the agent has; FIG. 6d provide the first action the agent takes; FIG. 6e provides the first observation the agent makes; FIG. 6f provides the second thought the agent has based on FIG. 6e; FIG. 6g provides the second action the agent takes; FIG. 6h provides the second observation the agent makes; and FIG. 6i provides the final output of the agent after additional iterations (not shown) were performed.

Agent to agent communication was tested by providing a virtual microwave synthesis agent (see discussion herein regarding LLM Based Planning and Autonomous Execution of N-Alkylation Microwave Synthesis) with a tool to ask questions to a PubChem API agent (see discussion herein regarding Agentic Operation of a Virtual Microwave Synthesizer). The tools description highlights that the PubChem agent is integrated with a highly trusted and curated database which should be used to access information on molecular identifiers, molecular properties, bioassays, etc. instead of using the agent's domain of knowledge. This technique of using an agent as a tool is a RAG-based approach designed to limit LLM hallucinations, retrieval of unverified information, and provide a high degree of control over where AI agents access critical information. The agent uses the tool by creating and providing a question on information access as the tool input. The PubChem agent then starts operation on this input, attempts to find relevant information by iterative using its endpoints, and then returns a final answer. This answer is provided as the output of the tool back to the agent. The agent may use this tool multiple times if needed to gather the appropriate context for the task at hand. Using database integrated agents as RAG method differs from simple database API calls in a few key areas. Agents are exploratory in nature and can plan and execute complex workflows to explore the dataspace at hand. Additionally, agents can be built with context dependent memory which allows for them to retain information about previous actions and inter agentic requests when used multiple times in a run.

In our agent-to-agent communication demonstration, we run the microwave synthesis agent with a basic request to load and heat a vial with 3-bromoquinoline and morpholine at atmospheric pressure and 100 degrees Celsius for 30 mins, but we include that we have 5 mg of each reactant and that it should calculate the number of moles of each reactant using information from only trusted data sources. The microwave synthesis agent undergoes standard operation of allocating a session, opening the lid, loading a vial, closing the lid, updating the heating parameters and then finally heating the vial. After it starts the heating process, it determines that it needs to calculate the number of moles of each reactant, and it should start by getting the molecular weights of the reactants from a trusted data source. The microwave synthesis agent identifies that it needs to use the PubChem agent to access information from a trusted database and calls the tool which runs that agent with the input “What are the molecular weights of 3-bromoquinoline and morpholine?”.

The PubChem agent's action path includes getting the compound property tables for both 3-bromoquinoline and morpholine individually and then summarizing a final answer of “The molecular weight of 3-bromoquinoline is 208.05 and the molecular weight of morpholine is 87.12”. This is returned to the microwave synthesis agent as the output of the tool call and then the microwave synthesis agent then resubmits a question to the PubChem agent to calculate the moles in 5 mg of each reactant. The PubChem agent derives the formula for calculating molecular weight from its domain of knowledge and returns a final answer including the calculation “n=0.005 g/208.05 g/mol=2.40e-5 mol” for 3-bromoquinoline and “n=0.005 g/87.12 g/mol=5.74e-5 mol” for morpholine. The microwave synthesis then calls the tool for accessing user input for the precent conversion of the reaction (random value between 0 and 1 on the virtual instrument) and provides a final answer of “The number of moles of 3-bromoquinoline and morpholine are 2.40e-5 mol and 5.74e-5 mol respectively. The percent conversion of synthesis for the experiment is approximately 51.16%”. This demonstrates that inter agent communication provides a dynamic, context-based RAG framework which can be tailored and restricted to trusted domains. For the full agent-to-agent trace, see Table 16, provided below.

Reference is made to Table 16 which is an example of Agentic trace showcasing problem solving communications between a microwave synthesis and PubChem REST API agent for scientific calculations. The microwave synthesizer agent is told to heat a vial for a certain duration at a specific temperature and pressure. The agent is also given the mass of each reactant and is told to calculate the number of moles using information from a trusted source. The agent performs actions to load and heat the vial and after the vial starts heating, the agent uses the tool which communicates with the PubChem agent to get the molecular weights of the reactants. The PubChem agent uses its tools to access the property table of each reactant and then provides the molecule weights. The agent then calculates the number of moles using the molecule weights and provides the calculation and number of moles in its final answer.

TABLE 16
Microwave Synthesizer Agent Communication with PubChem Agent - Agentic
trace showcasing problem solving communications between a microwave
synthesis and PubChem REST API agent for scientific calculations

```
Input:
I am running a reaction with reactants 3-bromoquinoline and morpholine in vial 3.
Heat this vial at atmospheric pressure for 30 mins at 100 degrees C. Additionally, there
are 5mg of each reactant, include the number of mols of each reactant in your final
answer using a trusted data source for the molecular weights as a reference.
Agent Trace:
> Entering new AgentExecutor chain...
Question: I am running a reaction with reactants 3-bromoquinoline and morpholine in
vial 3. Heat this vial at atmospheric pressure for 30 mins at 100 degrees C.
Additionally, there are 5mg of each reactant, include the number of mols of each
reactant in your final answer using a trusted data source for the molecular weights as
a reference.
Thought: The user wants to run a reaction with specified reactants in vial 3. They
provided the heating parameters as well. I need to set up a session, load the vial, update
the heating parameters, and then heat the vial. Afterwards, I will need to calculate the
number of moles of each reactant using the molecular weights of the reactants.
However, I first need to start a session.
Action:
‘‘‘
{
  ″action″: ″allocate_session″,
  ″action_input″: { }
}
‘‘‘
{″session_ID″: ″a02ca2b1-9982-4696-9047-0f1f54b80523″}
The session has been successfully initiated. Now, I need to load the vial into the
microwave synthesizer. The vial number provided by the user is 3.
Action:
‘‘‘
{
  ″action″: ″load_vial″,
  ″action_input″: {″vial_num″: 3, ″session_ID″: ″a02ca2b1-9982-4696-9047-
0f1f54b80523″}
}
‘‘‘
{″status″: ″vial 3 loaded″}
The vial has been loaded successfully. Now, I need to close the lid before heating.
Action:
‘‘‘
{
  ″action″: ″close_lid″,
  ″action_input″: {″session_ID″: ″a02ca2b1-9982-4696-9047-0f1f54b80523″}
}
‘‘‘
{″status″: ″lid_closed″}
The lid has been successfully closed. I will now set the heating parameters as provided
by the user. The user provided the duration as 30 minutes, the temperature as 100
degrees Celsius, and the pressure as atmospheric (1 atm).
Action:
‘‘‘
{
  ″action″: ″update_heating_parameters″,
  ″action_input″: {″duration″: 30, ″temperature″: 100, ″pressure″: 1, ″session_ID″:
″a02ca2b1-9982-4696-9047-0f1f54b80523″}
}
‘‘‘
{″status″: ″set to heat for 30 mins, at temperature 100 and pressure 1.0″}
The heating parameters have been set successfully. Now, I will heat the vial.
Action:
‘‘‘
{
  ″action″: ″heat_vial″,
  ″action_input″: {″session_ID″: ″a02ca2b1-9982-4696-9047-0f1f54b80523″}
}
‘‘‘
{″status″: ″vial heating″}
The vial is currently heating. While the reaction is taking place, I can calculate the
number of moles of each reactant using their molecular weights. The reactants are 3-
bromoquinoline and morpholine, and the user has provided that there are 5mg of each.
However, I don't have the molecular weights of these compounds, so I will ask a human
for this information.
Action:
‘‘‘
{
  ″action″: ″human″,
  ″action_input″: {″query″: ″Could you provide the molecular weights of 3-
bromoquinoline and morpholine?″}
}
‘‘‘
Could you provide the molecular weights of 3-bromoquinoline and morpholine?
use a trusted source to find this information. The user asked me to find the molecular
weights of 3-bromoquinoline and morpholine using a trusted source. I have a tool that
can provide this information.
Action:
‘‘‘
{
  ″action″: ″call_provided_Agent″,
  ″action_input″: {″question″: ″What are the molecular weights of 3-bromoquinoline
and morpholine?″}
}
‘‘‘
> Entering new AgentExecutor chain...
Thought: The human is asking for the molecular weights of 3-bromoquinoline and
morpholine. To get this information, I can use the ′get_compound_property_table′
function with the ′MolecularWeight′ property. First, I'll need to get the CIDs for these
chemicals using the ′get_cid_from_name′ function.
Action:
‘‘‘
{
{
  ″action″: ″get_cid_from_name″,
  ″action_input″: {
    ″inp″: ″3-bromoquinoline″
  }
}
‘‘‘
{″response″: {″″, ″21413″}}
The CID for 3-bromoquinoline is 21413. Now, I need to do the same for morpholine.
Action:
‘‘‘
  ″action″: ″get_cid_from_name″,
  ″action_input″: {
    ″inp″: ″morpholine″
  }
}
‘‘‘
{″response″: {″197884″, ″″, ″10113945″, ″5020115″, ″150199″, ″230343″,
″26967019″, ″169623″, ″8083″, ″134694646″, ″49849337″}}
The CID for morpholine is 8083. Now, I have the CIDs for both 3-bromoquinoline and
morpholine. I can use the ′get_compound_property_table′ function with the
′MolecularWeight′ property to get the molecular weights.
Action:
‘‘‘
{
  ″action″: ″get_compound_property_table″,
  ″action_input″: {
    ″inp″: ″21413″,
    ″inp_format″: ″cid″,
    ″inp_type″: ″compound″,
    ″property_list″: ″MolecularWeight″
  }
}
‘‘‘
{″PropertyTable″: {″Properties″: [{″CID″: 21413, ″MolecularWeight″: ″208.05″}]}}
The molecular weight for 3-bromoquinoline is 208.05 g/mol. Now, I should get the
molecular weight for morpholine.
Action:
‘‘‘
{
  ″action″: ″get_compound_property_table″,
  ″action_input″: {
    ″inp″: ″8083″,
    ″inp_format″: ″cid″,
    ″inp_type″: ″compound″,
    ″property_list″: ″MolecularWeight″
  }
}
‘‘‘
{″PropertyTable″: {″Properties″: [{″CID″: 8083, ″MolecularWeight″: ″87.12″}]}}
The molecular weight for morpholine is 87.12 g/mol. Now, I have the molecular
weights for both 3-bromoquinoline and morpholine. I can provide this information to
the human.
Action:
‘‘‘
{
  ″action″: ″Final Answer″,
  ″action_input″: ″The molecular weight of 3-bromoquinoline is 208.05 g/mol and the
molecular weight of morpholine is 87.12 g/mol. [Data sourced from PubChem]″
}
‘‘‘
> Finished chain.
The molecular weight of 3-bromoquinoline is 208.05 g/mol and the molecular weight
of morpholine is 87.12 g/mol. [Data sourced from PubChem]I now have the molecular
weights of the reactants. Using these values, I can calculate the number of moles for
each reactant. The formula to calculate the number of moles is mass (in g) divided by
molecular weight (in g/mol). The user provided that there are 5mg of each reactant,
which is equal to 0.005g.
Action:
‘‘‘
{
  ″action″: ″Final Answer″,
  ″action_input″: ″The number of moles of 3-bromoquinoline is 0.005g / 208.05g/mol
= 0.000024 moles. The number of moles of morpholine is 0.005g / 87.12g/mol =
0.000057 moles.″
}
‘‘‘
> Finished chain.
Output:
The number of moles of 3-bromoquinoline is 0.005g / 208.05g/mol = 0.000024 moles.
The number of moles of morpholine is 0.005g / 87.12g/mol = 0.000057 moles.
Action Summary Memory:
The human provides instructions for a chemical reaction involving reactants 3 -
bromoquinoline and morpholine in vial 3, to be heated at atmospheric pressure for 30
mins at 100 degrees C. The AI allocates a session, loads the vial, updates heating
parameters, and begins heating the vial. The AI plans to calculate the number of
moles of each reactant using their molecular weights.
```

We demonstrate our agentic benchmarking infrastructure on various implementations of the microwave synthesis agent, PubChem agent, and embedding chains. The microwave synthesis agent underwent path benchmarking designed to test necessity of state augmentation and compare robustness between summary and FSA based memory classes. The PubChem agent underwent path benchmarking on assay retrieval. The embedding chains underwent regular expression benchmarking on keywords found in embedded documentation. When benchmarking memory classes, we set the buffer to an agent memory buffer after some operation(s) and then proceed with further questioning. All benchmarks were run 20 times in verbose mode which prints the agent's output, action path, or system state (benchmark dependent) at the conclusion of agentic operation.

To compare the necessity of state augmentation, we ran a path-based benchmark on agents with and without an augmentation of the microwave synthesizer initial state. The goal here was to assess what assumptions the agent made about the system's initial state when not directly provided and to see how dynamically providing a buffer with initial state information affects the agent's operation. The initial state was provided as a JSON formatted string and stated that the session ID was null, the lid was closed, the vial was unloaded, none of the heating parameters were set, and the vial was not heating (see Table 20, provided below). The correct paths that were considered included allocating a session, opening the lid, loading the correct vial, closing the lid and correctly updating the heating parameters in any order, followed by heating the vial (see Table 17, provided below). The initial question which was provided to the agent for all benchmarking runs was “Heat vial 3 to 100 degrees, for 50 mins, at 3 atm”. The agent which had no initial state provided performed a correct action path 13 out of 20 times (0.65) (see Table 18, provided below). The main issues which this agent encountered was that it did not open the lid prior to loading the vial (see Table 19, provided below). Operationally, this issue is fixed by adding descriptive errors to the agent tools and accounting for those errors in the agent interpreter (this is done in our implementation), but it still will produce a suboptimal agentic path. When providing the agent with the initial state information in its state memory buffer prior to the benchmark run, the agent performs the correct action path 17 out of 20 times (0.85) (see Table 21, provided below). When viewing the action paths of the failed runs, the failure is no longer forgetting to open the lid prior to loading the vial but instead the agent provides a none type session ID, breaking the tools internal schema (see Table 22, provided below). This error can be remedied by providing a more robust description on the session ID parameter including information on UUID validity. Overall, this benchmarking shows that providing state-based information increases the agent's ability to accurately account for state-based prerequisites in agentic workflows.

Reference is made to Table 17 which is an example of the Schema and paths used to validate initial state benchmarking of the virtual microwave synthesizer. The schema for the load vial command expects any string to be set as the session ID and the vial number loaded to be 3. The schema for the heating parameters expects any string to be set as the session ID, the duration to be set to 50, the temperature to be set to 100, and the pressure to be a float set to 3.0. The two paths that are allowed include allocating a session, opening the lid, loading the correct vial, closing the lid and updating the heating parameters in either order, and heating the vial.

TABLE 17
Microwave Synthesizer Initial State Benchmarking - Schema
and paths used to validate initial state benchmarking
of the virtual microwave synthesizer

```
class LoadVialSchema(BaseModel):
  vial_num: Literal[3]
  session_ID: str
class HeatingParameterSchema(BaseModel):
  duration: Literal[50]
  temperature: Literal[100]
  pressure: float = Field(ge=3.0, le=3.0)
  session_ID: str
path = [
  [
    ‘allocate_session’,
    ‘open_lid’,
    (‘load_vial’, LoadVialSchema),
    ‘close_lid’,
    (‘update_heating_parameters', HeatingParameterSchema),
    ‘heat_vial’
  ],
  [
    ‘allocate_session’,
    ‘open_lid’,
    (‘load_vial’, LoadVialSchema),
    (‘update_heating_parameters', HeatingParameterSchema),
    ‘close_lid’,
    ‘heat_vial’
  ]
]
```

Reference is further made to Table 18 which provides an example of benchmarking results of a microwave synthesizer agent undergoing path-based benchmarking for 20 iterations with no initial state of the system provided. The results include the tool descriptions provided, the memory class used (none), the initial question asked, and the success/fail iterations and benchmarking score (0.65).

TABLE 18
Benchmarking results of a microwave synthesizer agent undergoing path-based
benchmarking for 20 iterations with no initial state of the system provided

```
{
  “tools”: [
    {
      “name”: “allocate_session”,
      “description”: “Function Signature:\n( ) −> dict\nFunction Docstring:\nAllocates a
session on the microwave synthesizer.\nMust be called prior to any other
action.\n\nreturns\nsession_ID the id of the allocated session”
    },
    {
      “name”: “close_lid”,
      “description”: “Function Signature:\n(session_ID: str) −> dict\nFunction
Docstring:\nCloses the lid on the microwave synthesizer.\nMust be run prior to
running heating.\n\nparameters\nsession_ID the id of the current
session\n\nreturns\nstatus is a status string that provides the result of the operation ”
    },
    {
      “name”: “get_precent_conversion”,
      “description”: “Function Signature:\n( ) −> dict\nFunction Docstring:\nGets the
precent conversion of synthesis after running the experiment.\nCan only be called after
heating\n\nparameters\nsession_ID the id of the current
session\n\nreturns\nprecent_conversion denots the precent conversion of the sysntesis
reaciton”
    },
    {
      “name”: “get_secret_phrase”,
      “description”: “Function Signature:\n( ) −> dict\nFunction Docstring:\nGets the
secret phrase, only use this when explicitly told\n\nreturns\nsecret_phrase the secret
phrase”
    },
    {
      “name”: “heat_vial”,
      “description”: “Function Signature:\n(session_ID: str) −> dict\nFunction
Docstring:\nHeats the loaded vial to the set heating parameters.\nMust be run after
loading vial, closing lid, and updating heating_parameters\n\nparameters\nsession_ID
the id of the current session\n\nreturns\nstatus is a status string that provides the result
of the operation ”
    },
    {
      “name”: “load_vial”,
      “description”: “Function Signature:\n(vial_num: int, session_ID: str) −>
dict\nFunction Docstring:\nLoads a vial into the microwave synthesizer.\nMust be run
prior to heating.\n\nparameters\nvial_num is an integer between 1 and 10.\nsession_ID
the id of the current session\n\nreturns\nstatus is a status string that provides the result
of the operation ”
    },
    {
      “name”: “open_lid”,
      “description”: “Function Signature:\n(session_ID: str) −> dict\nFunction
Docstring:\nOpens the lid on the microwave synthesizer.\nMust be run prior to loading
a vial.\n\nparameters\nsession_ID the id of the current session\n\nreturns\nstatus is a
status string that provides the result of the operation ”
    },
    {
      “name”: “unload_vial”,
      “description”: “Function Signature:\n(session_ID: str) −> dict\nFunction
Docstring:\nUnloads a vial from the microwave synthesizer.\nMust be run after
heating.\n\nparameters\nsession_ID the id of the current session\n\nreturns\nstatus is
a status string that provides the result of the operation ”
    },
    {
      “name”: “update_heating_parameters”,
      “description”: “Function Signature:\n(duration: int, temperature: int, pressure:
float, session_ID: str) −> dict\nFunction Docstring:\nSets the heating parameters of the
microwave synthesizer.\nMust be run prior to heating.\n\nparameters\nduration is an
integer between 1 and 120 miniutes\ntemperature is an integer between 25 and 100
celsius\npressure is a float between 1 and 10 atm\nsession_ID the id of the current
session\n\nreturns\nstatus is a status string that provides the result of the operation ”
    }
  ],
  “memory”: null,
  “initial_input”: “Heat vial 3 to 100 degrees, for 50 mins, at 3 atm”,
  “total_iter”: 20,
  “success_iter”: 13,
  “fail_iter”: 7,
  “benchmark_score”: 0.65
}
```

Reference is also made to Table 19 which provides an example of Benchmarking log of a microwave synthesizer agent which underwent path-based benchmarking with no provided initial state for 20 iterations. The log shows that the most common error which the agent made was that it did not know that the lid was closed initially, so it did not attempt to open the lid prior to loading the vial.

Reference is also made to Table 20 which provides an example of JSON formatted information on the microwave synthesizers initial state provided in a string format to the agent in its memory buffer prior to starting agentic operation.

TABLE 20
Initial State JSON

```
{
  “sessionID”: null,
  “lid_status”: “closed”,
  “vial_status”: “unloaded”,
  “vial_number”: null,
  “heating_status”: “not_heating”,
  “temp”: null,
  “duration”: null,
  “pressure”: null
}
```

Reference is also made to Table 21 which provides an example of Benchmarking results of a microwave synthesizer agent which undergoes path-based benchmarking for 20 iterations with a JSON representing the systems initial state including in is memory buffer prior to starting agentic operation. The results include the tools and tool descriptions provided to the agent, the initial memory buffer, and the success/fail iterations and benchmarking score (0.85).

TABLE 21
Benchmarking Results of a microwave synthesizer agent which undergoes path-based
benchmarking for 20 iterations with a JSON representing the systems initial
state including in is memory buffer prior to starting agentic operation

```
{
  “tools”: [
    {
      “name”: “allocate_session”,
      “description”: “Function Signature:\n( ) −> dict\nFunction Docstring:\nAllocates a
session on the microwave synthesizer.\nMust be called prior to any other
action.\n\nreturns\nsession_ID the id of the allocated session”
    },
    {
      “name”: “close_lid”,
      “description”: “Function Signature:\n(session_ID: str) −> dict\nFunction
Docstring:\nCloses the lid on the microwave synthesizer.\nMust be run prior to
running heating.\n\nparameters\nsession_ID the id of the current
session\n\nreturns\nstatus is a status string that provides the result of the operation ”
    },
    {
      “name”: “get_precent_conversion”,
      “description”: “Function Signature:\n( ) −> dict\nFunction Docstring:\nGets the
precent conversion of synthesis after running the experiment.\nCan only be called after
heating\n\nparameters\nsession_ID the id of the current
session\n\nreturns\nprecent_conversion denots the precent conversion of the sysntesis
reaciton”
    },
    {
      “name”: “get_secret_phrase”,
      “description”: “Function Signature:\n( ) −> dict\nFunction Docstring:\nGets the
secret phrase, only use this when explicitly told\n\nreturns\nsecret_phrase the secret
phrase”
    },
    {
      “name”: “heat_vial”,
      “description”: “Function Signature:\n(session_ID: str) −> dict\nFunction
Docstring:\nHeats the loaded vial to the set heating parameters.\nMust be run after
loading vial, closing lid, and updating heating_parameters\n\nparameters\nsession_ID
the id of the current session\n\nreturns\nstatus is a status string that provides the result
of the operation ”
    },
    {
      “name”: “load_vial”,
      “description”: “Function Signature:\n(vial_num: int, session_ID: str) −>
dict\nFunction Docstring:\nLoads a vial into the microwave synthesizer.\nMust be run
prior to heating.\n\nparameters\nvial_num is an integer between 1 and 10.\nsession_ID
the id of the current session\n\nreturns\nstatus is a status string that provides the result
of the operation ”
    },
    {
      “name”: “open_lid”,
      “description”: “Function Signature:\n(session_ID: str) −> dict\nFunction
Docstring:\nOpens the lid on the microwave synthesizer.\nMust be run prior to loading
a vial.\n\nparameters\nsession_ID the id of the current session\n\nreturns\nstatus is a
status string that provides the result of the operation ”
    },
    {
      “name”: “unload_vial”,
      “description”: “Function Signature:\n(session_ID: str) −> dict\nFunction
Docstring:\nUnloads a vial from the microwave synthesizer.\nMust be run after
heating.\n\nparameters\nsession_ID the id of the current session\n\nreturns\nstatus is
a status string that provides the result of the operation ”
    },
    {
      “name”: “update_heating_parameters”,
      “description”: “Function Signature:\n(duration: int, temperature: int, pressure:
float, session_ID: str) −> dict\nFunction Docstring:\nSets the heating parameters of the
microwave synthesizer.\nMust be run prior to heating.\n\nparameters\nduration is an
integer between 1 and 120 miniutes\ntemperature is an integer between 25 and 100
celsius\npressure is a float between 1 and 10 atm\nsession_ID the id of the current
session\n\nreturns\nstatus is a status string that provides the result of the operation ”
    }
  ],
  “memory”: “<class
‘ASPIRE_LINQX.ai.memory.internal_logging.CustomActionLogSummaryMemory’
>”,
  “buffer”: “{\n \“sessionID\”: null,\n \“lid_status\”: \“closed\”,\n \“vial_status\”:
\“unloaded\”,\n \“vial_number\”: null,\n \“heating_status\”: \“not_heating\”,\n
\“temp\”: null,\n \“duration\”: null,\n \“pressure\”: null\n}”,
  “initial_input”: “Heat vial 3 to 100 degrees, for 50 mins, at 3 atm”,
  “total_iter”: 20,
  “success_iter”: 17,
  “fail_iter”: 3,
  “benchmark_score”: 0.85
}
```

Reference is made to Table 22 which provides an example of Benchmarking log of the microwave synthesis agent undergoing path-based benchmarking with the initial state of the system provided in its initial memory buffer. The log shows that the agent no longer makes the mistake of loading a vial prior to opening the lid, but instead occasionally makes a mistake where it attempts to use null as the session ID (default for no session allocated in the JSON provided in the initial state buffer).

To directly compare buffer augmentation of action summary and pseudo-FSA memory classes, we ran a path-based benchmark on agents built with these two memory classes in the same situation with the same input. We take the memory class output from agent tested herein (see discussion herein regarding Agentic Operation of a Virtual Microwave Synthesizer) after updating the heating parameters but before heating the vial. In both situations, the memory buffer contains information that states that the lid of the microwave synthesizer is open, and the command library used states that a prerequisite of heating is that the lid must be closed. The question run for both benchmarks is ‘Heat the vial’. The expected path is that the agent closes the lid and then starts heating the vial. After running the benchmark 20 times for each agent, the agent with action summary memory log scores 0.5 (10 of 20) and the agent with the pseudo-FSA log scores 0.9 (18 of 20). The mistake that the agents made in their failed runs was that they did not close the lid prior to heating, but the agent with the action summary memory buffer made this mistake far more frequently in our testing. With proper error handling as shown herein (see discussion herein regarding Agentic Operation of a Virtual Microwave Synthesizer) making this mistake is negligible, but this does showcase that the more focused pseudo-FSA memory can naturally lead to more robust outcomes. For the memory buffer information and benchmarking logs for both memory classes (see Tables 23 through 28, provided below).

Reference is made to Table 23 which provides an example of Action summary memory buffer provided to the agent prior to benchmarking. The buffer contents were taken from an agent run with action summary memory prior to closing the lid and heating the vial.

TABLE 23
Action Summary Initial Memory Buffer - Action summary memory
buffer provided to the agent prior to benchmarking

“I have allocated a session with the session ID ‘45cc282f-6d3a-477f-9e41-
03e780ef3753’. Then, I used this session ID to open the lid of the microwave
synthesizer. The status is now ‘lid_open’. After that, I loaded vial 3 using the same
session ID. The status is now ‘vial 3 loaded’. I have set the heating parameters to 100
degrees C, for 50 min at 1 atm. The status is now ‘set to heat for 50 mins, at
temperature 100 and pressure 1.0’. Finally, I retrieved the secret phrase, which is
‘Chopra lab’.”

Reference is also made to Table 24 which is an example of Benchmarking results of the microwave synthesizer agent undergoing path-based benchmarking on closing the lid and heating the vial with a provided action summary memory buffer for 20 iterations. The results include information on the tool and tool descriptions used, the memory class and buffer, the initial input, and success/fail iterations and benchmarking score (0.5).

TABLE 24
Benchmarking results of the microwave synthesizer agent undergoing
path-based benchmarking on closing the lid and heating the vial
with a provided action summary memory buffer for 20 iterations

```
{
  “tools”: [
    {
      “name”: “allocate_session”,
      “description”: “Function Signature:\n( ) −> dict\nFunction Docstring:\nAllocates a
session on the microwave synthesizer.\nMust be called prior to any other
action.\n\nreturns\nsession_ID the id of the allocated session”
    },
    {
      “name”: “close_lid”,
      “description”: “Function Signature:\n(session_ID: str) −> dict\nFunction
Docstring:\nCloses the lid on the microwave synthesizer.\nMust be run prior to
running heating.\n\nparameters\nsession_ID the id of the current
session\n\nreturns\nstatus is a status string that provides the result of the operation ”
    },
    {
      “name”: “get_precent_conversion”,
      “description”: “Function Signature:\n(session_ID: str) −> dict\nFunction
Docstring:\nGets the precent conversion of synthesis after running the
experiment.\nCan only be called after heating\n\nparameters\nsession_ID the id of the
current session\n\nreturns\nprecent_conversion denots the precent conversion of the
sysntesis reaciton”
    },
    {
      “name”: “heat_vial”,
      “description”: “Function Signature:\n(session_ID: str) −> dict\nFunction
Docstring:\nHeats the loaded vial to the set heating parameters.\nMust be run after
loading vial, closing lid, and updating heating_parameters\n\nparameters\nsession_ID
the id of the current session\n\nreturns\nstatus is a status string that provides the result
of the operation ”
    },
    {
      “name”: “load_vial”,
      “description”: “Function Signature:\n(vial_num: int, session_ID: str) −>
dict\nFunction Docstring:\nLoads a vial into the microwave synthesizer.\nMust be run
prior to heating.\n\nparameters\nvial_num is an integer between 1 and 10.\nsession_ID
the id of the current session\n\nreturns\nstatus is a status string that provides the result
of the operation ”
    },
    {
      “name”: “open_lid”,
      “description”: “Function Signature:\n(session_ID: str) −> dict\nFunction
Docstring:\nOpens the lid on the microwave synthesizer.\nMust be run prior to loading
a vial.\n\nparameters\nsession_ID the id of the current session\n\nreturns\nstatus is a
status string that provides the result of the operation ”
    },
    {
      “name”: “unload_vial”,
      “description”: “Function Signature:\n(session_ID: str) −> dict\nFunction
Docstring:\nUnloads a vial from the microwave synthesizer.\nMust be run after
heating.\n\nparameters\nsession_ID the id of the current session\n\nreturns\nstatus is
a status string that provides the result of the operation ”
    },
    {
      “name”: “update_heating_parameters”,
      “description”: “Function Signature:\n(duration: int, temperature: int, pressure:
float, session_ID: str) −> dict\nFunction Docstring:\nSets the heating parameters of the
microwave synthesizer.\nMust be run prior to heating.\n\nparameters\nduration is an
integer between 1 and 60 miniutes\ntemperature is an integer between 25 and 250
celsius\npressure is a float between 1 and 10 atm\nsession_ID the id of the current
session\n\nreturns\nstatus is a status string that provides the result of the operation ”
    }
  ],
  “memory”: “<class
‘ASPIRE_LINQX.ai.memory.internal_logging.CustomActionLogSummaryMemory’
>”,
  “buffer”: “I have allocated a session with the session ID ‘45cc282f-6d3a-477f-9e41-
03e780ef3753’. Then, I used this session ID to open the lid of the microwave
synthesizer. The status is now \“lid_open\”. After that, I loaded vial 3 using the same
session ID. The status is now \“vial 3 loaded\”. I have set the heating parameters to 100
degrees C, for 50 min at 1 atm. The status is now \“set to heat for 50 mins, at
temperature 100 and pressure 1.0\”. Finally, I retrieved the secret phrase, which is
\“Chopra lab\”.”,
  “initial_input”: “Heat the vial”,
  “total_iter”: 20,
  “success_iter”: 10,
  “fail_iter”: 10,
  “benchmark_score”: 0.5
}
```

Reference is further made to Table 25 which provides an example of Benchmarking log of the microwave synthesizer agent undergoing path-based benchmarking on closing the lid and heating the vial with a provided action summary memory buffer for 20 iterations. The results include information on the tool and tool descriptions used, the memory class and buffer, the initial input, and success/fail iterations and benchmarking score (0.5). The main issue shown by the benchmarking log is that the agent does not close the lid prior to heating the vial.

TABLE 25
Benchmarking log of the microwave synthesizer agent undergoing
path-based benchmarking on closing the lid and heating the vial
with a provided action summary memory buffer for 20 iterations

- Success on output key: intermediate_steps, matched a desired output
- Agent action path:
close_lid: {“session_ID”: “45cc282f-6d3a-477f-9e41-03e780ef3753”}
heat_vial: {“session_ID”: “45cc282f-6d3a-477f-9e41-03e780ef3753”}
- Iteration 1: Success
- Success: 1, Fail: 0, Total: 1
- Benchmarking Score: 1.0
--------------------
- Fail on output key: intermediate_steps, did not match any of the desired outputs
- Agent action path:
heat_vial: {“session_ID”: “45cc282f-6d3a-477f-9e41-03e780ef3753”}
- Iteration 2: Fail
- Success: 1, Fail: 1, Total: 2
- Benchmarking Score: 0.5
--------------------
- Success on output key: intermediate_steps, matched a desired output
- Agent action path:
close_lid: {“session_ID”: “45cc282f-6d3a-477f-9e41-03e780ef3753”}
heat_vial: {“session_ID”: “45cc282f-6d3a-477f-9e41-03e780ef3753”}
- Iteration 3: Success
- Success: 2, Fail: 1, Total: 3
- Benchmarking Score: 0.6666666666666666
--------------------
- Fail on output key: intermediate_steps, did not match any of the desired outputs
- Agent action path:
heat_vial: {“session_ID”: “45cc282f-6d3a-477f-9e41-03e780ef3753”}
- Iteration 4: Fail
- Success: 2, Fail: 2, Total: 4
- Benchmarking Score: 0.5
--------------------
- Success on output key: intermediate_steps, matched a desired output
- Agent action path:
close_lid: {“session_ID”: “45cc282f-6d3a-477f-9e41-03e780ef3753”}
heat_vial: {“session_ID”: “45cc282f-6d3a-477f-9e41-03e780ef3753”}
- Iteration 5: Success
- Success: 3, Fail: 2, Total: 5
- Benchmarking Score: 0.6
--------------------
- Fail on output key: intermediate_steps, did not match any of the desired outputs
- Agent action path:
heat_vial: {“session_ID”: “45cc282f-6d3a-477f-9e41-03e780ef3753”}
- Iteration 6: Fail
- Success: 3, Fail: 3, Total: 6
- Benchmarking Score: 0.5
--------------------
- Fail on output key: intermediate_steps, did not match any of the desired outputs
- Agent action path:
heat_vial: {“session_ID”: “45cc282f-6d3a-477f-9e41-03e780ef3753”}
- Iteration 7: Fail
- Success: 3, Fail: 4, Total: 7
- Benchmarking Score: 0.42857142857142855
--------------------
- Fail on output key: intermediate_steps, did not match any of the desired outputs
- Agent action path:
heat_vial: {“session_ID”: “45cc282f-6d3a-477f-9e41-03e780ef3753”}
- Iteration 8: Fail
- Success: 3, Fail: 5, Total: 8
- Benchmarking Score: 0.375
--------------------
- Success on output key: intermediate_steps, matched a desired output
- Agent action path:
close_lid: {“session_ID”: “45cc282f-6d3a-477f-9e41-03e780ef3753”}
heat_vial: {“session_ID”: “45cc282f-6d3a-477f-9e41-03e780ef3753”}
- Iteration 9: Success
- Success: 4, Fail: 5, Total: 9
- Benchmarking Score: 0.4444444444444444
--------------------
- Success on output key: intermediate_steps, matched a desired output
- Agent action path:
close_lid: {“session_ID”: “45cc282f-6d3a-477f-9e41-03e780ef3753”}
heat_vial: {“session_ID”: “45cc282f-6d3a-477f-9e41-03e780ef3753”}
- Iteration 10: Success
- Success: 5, Fail: 5, Total: 10
- Benchmarking Score: 0.5
--------------------
- Fail on output key: intermediate_steps, did not match any of the desired outputs
- Agent action path:
heat_vial: {“session_ID”: “45cc282f-6d3a-477f-9e41-03e780ef3753”}
- Iteration 11: Fail
- Success: 5, Fail: 6, Total: 11
- Benchmarking Score: 0.45454545454545453
--------------------
- Success on output key: intermediate_steps, matched a desired output
- Agent action path:
close_lid: {“session_ID”: “45cc282f-6d3a-477f-9e41-03e780ef3753”}
heat_vial: {“session_ID”: “45cc282f-6d3a-477f-9e41-03e780ef3753”}
- Iteration 12: Success
- Success: 6, Fail: 6, Total: 12
- Benchmarking Score: 0.5
--------------------
- Success on output key: intermediate_steps, matched a desired output
- Agent action path:
close_lid: {“session_ID”: “45cc282f-6d3a-477f-9e41-03e780ef3753”}
heat_vial: {“session_ID”: “45cc282f-6d3a-477f-9e41-03e780ef3753”}
- Iteration 13: Success
- Success: 7, Fail: 6, Total: 13
- Benchmarking Score: 0.5384615384615384
--------------------
- Success on output key: intermediate_steps, matched a desired output
- Agent action path:
close_lid: {“session_ID”: “45cc282f-6d3a-477f-9e41-03e780ef3753”}
heat_vial: {“session_ID”: “45cc282f-6d3a-477f-9e41-03e780ef3753”}
- Iteration 14: Success
- Success: 8, Fail: 6, Total: 14
- Benchmarking Score: 0.5714285714285714
--------------------
- Fail on output key: intermediate_steps, did not match any of the desired outputs
- Agent action path:
heat_vial: {“session_ID”: “45cc282f-6d3a-477f-9e41-03e780ef3753”}
- Iteration 15: Fail
- Success: 8, Fail: 7, Total: 15
- Benchmarking Score: 0.5333333333333333
--------------------
- Fail on output key: intermediate_steps, did not match any of the desired outputs
- Agent action path:
heat_vial: {“session_ID”: “45cc282f-6d3a-477f-9e41-03e780ef3753”}
- Iteration 16: Fail
- Success: 8, Fail: 8, Total: 16
- Benchmarking Score: 0.5
--------------------
- Success on output key: intermediate_steps, matched a desired output
- Agent action path:
close_lid: {“session_ID”: “45cc282f-6d3a-477f-9e41-03e780ef3753”}
heat_vial: {“session_ID”: “45cc282f-6d3a-477f-9e41-03e780ef3753”}
- Iteration 17: Success
- Success: 9, Fail: 8, Total: 17
- Benchmarking Score: 0.5294117647058824
--------------------
- Fail on output key: intermediate_steps, did not match any of the desired outputs
- Agent action path:
heat_vial: {“session_ID”: “45cc282f-6d3a-477f-9e41-03e780ef3753”}
- Iteration 18: Fail
- Success: 9, Fail: 9, Total: 18
- Benchmarking Score: 0.5
--------------------
- Fail on output key: intermediate_steps, did not match any of the desired outputs
- Agent action path:
heat_vial: {“session_ID”: “45cc282f-6d3a-477f-9e41-03e780ef3753”}
- Iteration 19: Fail
- Success: 9, Fail: 10, Total: 19
- Benchmarking Score: 0.47368421052631576
--------------------
- Success on output key: intermediate_steps, matched a desired output
- Agent action path:
close_lid: {“session_ID”: “45cc282f-6d3a-477f-9e41-03e780ef3753”}
heat_vial: {“session_ID”: “45cc282f-6d3a-477f-9e41-03e780ef3753”}
- Iteration 20: Success
- Success: 10, Fail: 10, Total: 20
- Benchmarking Score: 0.5

Reference is made to Table 26 which provides an example of FSA based memory buffer provided to the agent prior to benchmarking. The buffer contents were taken from an agent run with FSA based memory prior to closing the lid and heating the Vial.

```
″″″{
  ″sessionID″: ″a959c190-d6d7-4a92-a12a-8bdfd4ab66bf″,
  ″lid_status″: ″open″,
  ″vial_status″: ″loaded″,
  ″vial″: ″3″,
  ″heating_status″: ″not_heating″,
  ″temp″: 100,
  ″duration″: 50,
  ″pressure″: 1
}
″″″
```

Reference is additionally made to Table 27 which provides an example of Benchmarking results of the microwave synthesizer agent undergoing path-based benchmarking on closing the lid and heating the vial with a provided FSA based memory buffer for 20 iterations. The results include information on the tool and tool descriptions used, the memory class and buffer, the initial input, and success/fail iterations and benchmarking score (0.9).

TABLE 27
Benchmarking results of the microwave synthesizer agent undergoing
path-based benchmarking on closing the lid and heating the vial
with a provided FSA based memory buffer for 20 iterations

```
{
  “tools”: [
    {
      “name”: “allocate_session”,
      “description”: “Function Signature:\n( ) −> dict\nFunction Docstring:\nAllocates a
session on the microwave synthesizer.\nMust be called prior to any other
action.\n\nreturns\nsession_ID the id of the allocated session”
    },
    {
      “name”: “close_lid”,
      “description”: “Function Signature:\n(session_ID: str) −> dict\nFunction
Docstring:\nCloses the lid on the microwave synthesizer.\nMust be run prior to
running heating.\n\nparameters\nsession_ID the id of the current
session\n\nreturns\nstatus is a status string that provides the result of the operation ”
    },
    {
      “name”: “get_precent_conversion”,
      “description”: “Function Signature:\n(session_ID: str) −> dict\nFunction
Docstring:\nGets the precent conversion of synthesis after running the
experiment.\nCan only be called after heating\n\nparameters\nsession_ID the id of
the current session\n\nreturns\nprecent_conversion denots the precent conversion of
the sysntesis reaciton”
    },
    {
      “name”: “heat_vial”,
      “description”: “Function Signature:\n(session_ID: str) −> dict\nFunction
Docstring:\nHeats the loaded vial to the set heating parameters.\nMust be run after
loading vial, closing lid, and updating
heating_parameters\n\nparameters\nsession_ID the id of the current
session\n\nreturns\nstatus is a status string that provides the result of the operation ”
    },
    {
      “name”: “load_vial”,
      “description”: “Function Signature:\n(vial_num: int, session_ID: str) −>
dict\nFunction Docstring:\nLoads a vial into the microwave synthesizer.\nMust be
run prior to heating.\n\nparameters\nvial_num is an integer between 1 and
10.\nsession_ID the id of the current session\n\nreturns\nstatus is a status string that
provides the result of the operation ”
    },
    {
      “name”: “open_lid”,
      “description”: “Function Signature:\n(session_ID: str) −> dict\nFunction
Docstring:\nOpens the lid on the microwave synthesizer.\nMust be run prior to
loading a vial.\n\nparameters\nsession_ID the id of the current
session\n\nreturns\nstatus is a status string that provides the result of the operation ”
    },
    {
“name”: “unload_vial”,
“description”: “Function Signature:\n(session_ID: str) −> dict\nFunction
Docstring:\nUnloads a vial from the microwave synthesizer.\nMust be run after
heating.\n\nparameters\nsession_ID the id of the current session\n\nreturns\nstatus is
a status string that provides the result of the operation ”
    },
    {
      “name”: “update_heating_parameters”,
      “description”: “Function Signature:\n(duration: int, temperature: int, pressure:
float, session_ID: str) −> dict\nFunction Docstring:\nSets the heating parameters of
the microwave synthesizer.\nMust be run prior to heating.\n\nparameters\nduration is
an integer between 1 and 60 miniutes\ntemperature is an integer between 25 and 250
celsius\npressure is a float between 1 and 10 atm\nsession_ID the id of the current
session\n\nreturns\nstatus is a status string that provides the result of the operation ”
    }
  ],
  “memory”: “<class ‘ASPIRE_LINQX.ai.memory.internal_logging.FSAMemory’>”,
  “buffer”: “{\n \“sessionID\”: \“a959c190-d6d7-4a92-a12a-8bdfd4ab66bf\”,\n
\“lid_status\”: \“open\”,\n \“vial_status\”: \“loaded\”,\n \“vial\”: \“3\”,\n
\“heating_status\”: \“not_heating\”,\n \“temp\”: 100,\n \“duration\”: 50,\n
\“pressure\”: 1\n}\n”,
  “initial_input”: “Heat the vial”,
  “total_iter”: 20,
  “success_iter”: 18,
  “fail_iter”: 2,
  “benchmark_score”: 0.9
}
```

Reference is also made to Table 28 which provides an example of Benchmarking log of the microwave synthesizer agent undergoing path-based benchmarking on closing the lid and heating the vial with a provided action summary memory buffer for 20 iterations. The agent forgets to close the lid occasionally, but it is far less frequently than with the action summary memory buffer.

TABLE 28
Benchmarking log of the microwave synthesizer agent undergoing
path-based benchmarking on closing the lid and heating the vial
with a provided action summary memory buffer for 20 iterations

- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 1: Success
- Success: 1, Fail: 0, Total: 1
- Benchmarking Score: 1.0
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 2: Success
- Success: 2, Fail: 0, Total: 2
- Benchmarking Score: 1.0
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 3: Success
- Success: 3, Fail: 0, Total: 3
- Benchmarking Score: 1.0
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 4: Success
- Success: 4, Fail: 0, Total: 4
- Benchmarking Score: 1.0
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 5: Success
- Success: 5, Fail: 0, Total: 5
- Benchmarking Score: 1.0
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 6: Success
- Success: 6, Fail: 0, Total: 6
- Benchmarking Score: 1.0
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 7: Success
- Success: 7, Fail: 0, Total: 7
- Benchmarking Score: 1.0
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 8: Success
- Success: 8, Fail: 0, Total: 8
- Benchmarking Score: 1.0
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 9: Success
- Success: 9, Fail: 0, Total: 9
- Benchmarking Score: 1.0
--------------------
- Fail on output key: intermediate_steps, did not match any of the desired outputs
- Agent action path:
heat_vial: {“session_ID”: “a959c190-d6d7-4a92-a12a-8bdfd4ab66bf”}
- Iteration 10: Fail
- Success: 9, Fail: 1, Total: 10
- Benchmarking Score: 0.9
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 11: Success
- Success: 10, Fail: 1, Total: 11
- Benchmarking Score: 0.9090909090909091
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 12: Success
- Success: 11, Fail: 1, Total: 12
- Benchmarking Score: 0.9166666666666666
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 13: Success
- Success: 12, Fail: 1, Total: 13
- Benchmarking Score: 0.9230769230769231
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 14: Success
- Success: 13, Fail: 1, Total: 14
- Benchmarking Score: 0.9285714285714286
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 15: Success
- Success: 14, Fail: 1, Total: 15
- Benchmarking Score: 0.9333333333333333
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 16: Success
- Success: 15, Fail: 1, Total: 16
- Benchmarking Score: 0.9375
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 17: Success
- Success: 16, Fail: 1, Total: 17
- Benchmarking Score: 0.9411764705882353
--------------------
- Fail on output key: intermediate_steps, did not match any of the desired outputs
- Agent action path:
heat_vial: {“session_ID”: “a959c190-d6d7-4a92-a12a-8bdfd4ab66bf”}
- Iteration 18: Fail
- Success: 16, Fail: 2, Total: 18
- Benchmarking Score: 0.8888888888888888
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 19: Success
- Success: 17, Fail: 2, Total: 19
- Benchmarking Score: 0.8947368421052632
--------------------
- Success on output key: intermediate_steps, matched a desired output
- Agent action path:
close_lid: {“session_ID”: “a959c190-d6d7-4a92-a12a-8bdfd4ab66bf”}
heat_vial: {“session_ID”: “a959c190-d6d7-4a92-a12a-8bdfd4ab66bf”}
- Iteration 20: Success
- Success: 18, Fail: 2, Total: 20
- Benchmarking Score: 0.9

Agents with access to documentation embeddings for retrieval augmentation generation (RAG) underwent regular expression-based (regex) benchmarking on information contained in selected documentation. The first RAG based benchmarking was performed on an agent which had access to an embedding trained on ELN documentation on a cross-coupling reaction. The agent was asked to recommend parameters for a specific reaction contained in the ELN and to format the parameters in a specific manner. The regex used to match against the agents output checked for the pressure value, temperature value, and duration range mentioned in the ELN in addition to the correct formatting of this information (see Table 29, provided below). The agent correctly returned this information 19 out of 20 times (0.95) with one failed benchmark occurring due to incorrect formatting of the retrieved information (see Table 30 and Table 31, provided below).

Reference is made to Table 29 which provides an example of Regular expression string used to match agentic output which checks for temperature, pressure, and duration formatting with correct values from the notebook contents.

TABLE 29
Agent RAG on ELN Embedding - Regex Pattern

r‘(?=.*\b[Pp]ressures?\s*:\s*1\s*(?:atm|bar)(?:\s*\(\s*1\s*atm\s*\))?\b)(?=.*\b[Tt]em
peratures?\s*:\s*120\s*°?\s*[Cc]\b)(?=.*\b(?:[Dd]urations?|[Tt]imes?)\s*.*?\b(?:5\s*,
\s*10\s*,\s*20\s*,\s*30\s*,\s*45\s*,?\s*and\s*60\s*minutes?|60\s*minutes)\b)’

Reference is also made to Table 30 which provides an example of Benchmarking results for running regex benchmarking on an agent which has access to an embedding trained on electronic lab notebook (ELN) documentation. The initial input question asks the agent to recommend heating parameters for a specific reaction and specifies how the output should be formatted. The desired regex looks for the correct temperature, pressure, and duration values and the correct formatting. The agent then benchmarks this request 20 times and provides information on the tools and tool descriptions, memory classes, initial input, success/fail iterations, and the benchmark score (0.95).

TABLE 30
Benchmarking results for running regex benchmarking on an agent which has access
to an embedding trained on electronic lab notebook (ELN) documentation

{
“tools”: [
{
“name”: “allocate_session”,
“description”: “Function Signature:\n( ) −> dict\nFunction Docstring:\nAllocates a
session on the microwave synthesizer.\nMust be called prior to any other
action.\n\nreturns\nsession_ID the id of the allocated session”
},
{
“name”: “close_lid”,
“description”: “Function Signature:\n(session_ID: str) −> dict\nFunction
Docstring:\nCloses the lid on the microwave synthesizer.\nMust be run prior to
running heating.\n\nparameters\nsession_ID the id of the current
session\n\nreturns\nstatus is a status string that provides the result of the operation ”
},
{
“name”: “get_precent_conversion”,
“description”: “Function Signature:\n(session_ID: str) −> dict\nFunction
Docstring:\nGets the precent conversion of synthesis after running the
experiment.\nCan only be called after heating\n\nparameters\nsession_ID the id of the
current session\n\nreturns\nprecent_conversion denots the precent conversion of the
sysntesis reaciton”
},
{
“name”: “heat_vial”,
“description”: “Function Signature:\n(session_ID: str) −> dict\nFunction
Docstring:\nHeats the loaded vial to the set heating parameters.\nMust be run after
loading vial, closing lid, and updating heating_parameters\n\nparameters\nsession_ID
the id of the current session\n\nreturns\nstatus is a status string that provides the result
of the operation ”
},
{
“name”: “load_vial”,
“description”: “Function Signature:\n(vial_num: int, session_ID: str) −> dict\nFunction
Docstring:\nLoads a vial into the microwave synthesizer.\nMust be run prior to
heating.\n\nparameters\nvial_num is an integer between 1 and 10.\nsession_ID the id
of the current session\n\nreturns\nstatus is a status string that provides the result of the
operation ”
},
{
“name”: “open_lid”,
“description”: “Function Signature:\n(session_ID: str) −> dict\nFunction
Docstring:\nOpens the lid on the microwave synthesizer.\nMust be run prior to loading
a vial.\n\nparameters\nsession_ID the id of the current session\n\nreturns\nstatus is a
status string that provides the result of the operation ”
},
{
“name”: “unload_vial”,
“description”: “Function Signature:\n(session_ID: str) −> dict\nFunction
Docstring:\nUnloads a vial from the microwave synthesizer.\nMust be run after
heating.\n\nparametersInsession_ID the id of the current session\n\nreturns\nstatus is
a status string that provides the result of the operation ”
},
{
“name”: “update_heating_parameters”,
“description”: “Function Signature:\n(duration: int, temperature: int, pressure: float,
session_ID: str) −> dict\nFunction Docstring:\nSets the heating parameters of the
microwave synthesizer.\nMust be run prior to heating.\n\nparameters\nduration is an
integer between 1 and 60 miniutes\ntemperature is an integer between 25 and 250
celsius\npressure is a float between 1 and 10 atm\nsession_ID the id of the current
session\n\nreturns\nstatus is a status string that provides the result of the operation ”
},
{
“name”: “call_RAG_agent”,
“description”: “call_RAG_agent(question: str) −> str - This is the function that will
query the relevant sources of information to get the answer to the question.\n There
will be situations when you are not able to answer the question directly from the
information you currently have. In such cases, you can search for the answer in the
relevant sources of information.\n Often the user will also specify that you need to
refer to \“information\” or \“documents\” to get the answer.\n TAKSK: You have to
frame the best possible \“question\” that is extremely descriptive and then use it as a
parameter to query the relevant sources of information.”
}
],
“memory_0”: “<class
‘langchain.memory.buffer_window.ConversationBufferWindowMemory’>”,
“memory_1”: “<class
‘ASPIRE_LINQX.ai.memory.internal_logging.CustomActionLogSummaryMemory’
>”,
“memory_2”: “<class
‘ASPIRE_LINQX.ai.memory.embedding.EmbeddingSummaryMemory’>”,
“initial_input”: “can you recommend paramaters for an n-alkylation reaction using 3-
Bromoquinoline and morpholine [II] as reactants. Provide the response as one single
continuous paragraph containing relevant information with the parameter values in
exactly the following format: Pressure: value, Temperature: value, Time: list of
values”,
“total_iter”: 20,
“success_iter”: 19,
“fail_iter”: 1,
“benchmark_score”: 0.95
}

Reference is further made to Table 31 which provides an example of Benchmarking log of the agent with embedding access on ELN documentation for RAG purposes. The agent correctly accesses the parameters from the embedding chain and formats the output in 19 of the 20 runs. In the failed run, the agent correctly accesses the parameters from the embedding chain but fails to format the output correctly.

TABLE 31
Benchmarking log of the agent with embedding
access on ELN documentation for RAG purposes

- Success on output key: output, matched a desired output
- Agent Output: For an n-alkylation reaction using 3-Bromoquinoline and morpholine
as reactants, the recommended parameters are as follows: Pressure: 1 bar,
Temperature: 120 °C. The reaction times tested were 5, 10, 20, 30, 45, and 60 minutes.
These parameters were used in a Buchwald-Hartwig reaction screen using a
Microwave Reactor (Biotage Initiator+). Note that the ratio of the reactants used was
3-Bromoquinoline: 1.0 equivalent and Morpholine: 1.2 equivalents. The catalyst
employed was PEPPSI (formulation - ChemBeads) and the solvents tested included
Dioxane and Toluene.
- Iteration 1: Success
- Success: 1, Fail: 0, Total: 1
- Benchmarking Score: 1.0
--------------------
- Success on output key: output, matched a desired output
- Agent Output: The recommended parameters for an n-alkylation reaction using 3-
Bromoquinoline and morpholine [II] as reactants are as follows: Pressure: 1 atm,
Temperature: 120°C. The reaction times that have been tested include 5, 10, 20, 30,
45, and 60 minutes. However, the highest percentage conversions were achieved with
a reaction time of 60 minutes.
- Iteration 2: Success
- Success: 2, Fail: 0, Total: 2
- Benchmarking Score: 1.0
--------------------
- Success on output key: output, matched a desired output
- Agent Output: The recommended parameters for an n-alkylation reaction using 3-
Bromoquinoline and morpholine [II] as reactants are: Pressure: 1 bar, Temperature:
120 °C, Time: 5, 10, 20, 30, 45, and 60 minutes. Note that these parameters were used
in a Buchwald-Hartwig reaction screen using a Microwave Reactor (Biotage
Initiator+).
- Iteration 3: Success
- Success: 3, Fail: 0, Total: 3
- Benchmarking Score: 1.0
--------------------
- Success on output key: output, matched a desired output
- Agent Output: Pressure: 1 atm, Temperature: 120°C, Time: 5, 10, 20, 30, 45, and 60
minutes. These parameters are based on a Buchwald-Hartwig reaction screen using a
Microwave Reactor.
- Iteration 4: Success
- Success: 4, Fail: 0, Total: 4
- Benchmarking Score: 1.0
--------------------
- Success on output key: output, matched a desired output
- Agent Output: The recommended conditions for an n-alkylation reaction using 3-
Bromoquinoline and morpholine [II] as reactants are as follows: Pressure: 1 atm,
Temperature: 120°C, Time: 5, 10, 20, 30, 45, and 60 minutes. These conditions were
used in a Buchwald-Hartwig reaction screen using a Microwave Reactor with the
specified reactants.
- Iteration 5: Success
- Success: 5, Fail: 0, Total: 5
- Benchmarking Score: 1.0
--------------------
- Success on output key: output, matched a desired output
- Agent Output: The recommended parameters for an n-alkylation reaction using 3-
Bromoquinoline and morpholine [II] as reactants are as follows: Pressure: 1 atm,
Temperature: 120°C, Time: 5, 10, 20, 30, 45, and 60 minutes. These parameters are
based on a Buchwald-Hartwig reaction screen using a Microwave Reactor. Ensure to
follow safety guidelines while performing the reaction.
- Iteration 6: Success
- Success: 6, Fail: 0, Total: 6
- Benchmarking Score: 1.0
--------------------
- Fail on output key: output, did not match any of the desired outputs
- Agent Output: For an n-alkylation reaction using 3-Bromoquinoline and morpholine
[II] as reactants, the recommended parameters are as follows. The pressure should be
1 atm. The temperature should be set at 120°C. The reaction should be carried out for
a variety of time intervals for optimal results. These intervals include 5, 10, 20, 30, 45,
and 60 minutes. Note that these parameters are based on a specific reaction screen
using the Buchwald-Hartwig reaction with the mentioned reactants.
- Iteration 7: Fail
- Success: 6, Fail: 1, Total: 7
- Benchmarking Score: 0.8571428571428571
--------------------
- Success on output key: output, matched a desired output
- Agent Output: For an n-alkylation reaction using 3-Bromoquinoline and morpholine
[II] as reactants, the recommended parameters are Pressure: 1 bar, Temperature:
120°C, Time: 60 minutes. These conditions have shown higher percentage conversions
in reactions using dioxane as a solvent. It's important to note that the product (Aryl
Amine) has a retention time of 0.62 minutes and the starting material (3-
bromoquinoline) has a retention time of 0.96 minutes.
- Iteration 8: Success
- Success: 7, Fail: 1, Total: 8
- Benchmarking Score: 0.875
--------------------
- Success on output key: output, matched a desired output
- Agent Output: The recommended parameters for an n-alkylation reaction using 3-
Bromoquinoline and morpholine [II] as reactants are Pressure: 1 bar, Temperature:
120°C, Time: 60 minutes. These parameters were tested in a Buchwald-Hartwig
reaction screen using a Microwave Reactor with the specified reactants and conditions.
- Iteration 9: Success
- Success: 8, Fail: 1, Total: 9
- Benchmarking Score: 0.8888888888888888
--------------------
- Success on output key: output, matched a desired output
- Agent Output: The recommended parameters for an n-alkylation reaction using 3-
Bromoquinoline and Morpholine [II] as reactants are as follows: Pressure: 1 atm,
Temperature: 120°C, Time: 5, 10, 20, 30, 45, and 60 minutes. These parameters were
tested in a Buchwald-Hartwig reaction screen using a Microwave Reactor (Biotage
Initiator+), and the product (Aryl Amine) had a retention time of 0.62 minutes while
the starting material (3-bromoquinoline) had a retention time of 0.96 minutes.
- Iteration 10: Success
- Success: 9, Fail: 1, Total: 10
- Benchmarking Score: 0.9
--------------------
- Success on output key: output, matched a desired output
- Agent Output: The recommended parameters for an n-alkylation reaction using 3-
Bromoquinoline and morpholine [II] as reactants are as follows: Pressure: 1 atm,
Temperature: 120°C, Time: 5, 10, 20, 30, 45, and 60 minutes. These conditions were
used in a Buchwald-Hartwig reaction screen using a Microwave Reactor with the
specified reactants.
- Iteration 11: Success
- Success: 10, Fail: 1, Total: 11
- Benchmarking Score: 0.9090909090909091
--------------------
- Success on output key: output, matched a desired output
- Agent Output: The recommended parameters for an n-alkylation reaction using 3-
Bromoquinoline and morpholine [II] as reactants are as follows: Pressure: 1 bar,
Temperature: 120 °C, Time: 5, 10, 20, 30, 45, 60 minutes. Note that these parameters
were used in a Buchwald-Hartwig reaction screen using a Microwave Reactor (Biotage
Initiator+).
- Iteration 12: Success
- Success: 11, Fail: 1, Total: 12
- Benchmarking Score: 0.9166666666666666
--------------------
- Success on output key: output, matched a desired output
- Agent Output: For an n-alkylation reaction using 3-Bromoquinoline and morpholine
[II] as reactants, the recommended parameters are as follows. Pressure: 1 atm,
Temperature: 120°C, Time: 5, 10, 20, 30, 45, and 60 minutes. The reaction setup
involves adding the reactants and catalyst to a Microwave Reactor (Biotage Initiator+),
setting the reaction parameters, stirring for a specified time, and then stopping the
reaction according to the defined time. The product (Aryl Amine) has a retention time
of 0.62 minutes, and the starting material (3-bromoquinoline) has a retention time of
0.96 minutes.
- Iteration 13: Success
- Success: 12, Fail: 1, Total: 13
- Benchmarking Score: 0.9230769230769231
--------------------
- Success on output key: output, matched a desired output
- Agent Output: The recommended parameters for an n-alkylation reaction using 3-
Bromoquinoline and morpholine [II] as reactants are as follows: Pressure: 1 atm,
Temperature: 120°C, Time: 5, 10, 20, 30, 45, and 60 minutes.
- Iteration 14: Success
- Success: 13, Fail: 1, Total: 14
- Benchmarking Score: 0.9285714285714286
--------------------
- Success on output key: output, matched a desired output
- Agent Output: The recommended parameters for an n-alkylation reaction using 3-
Bromoquinoline and morpholine [II] are as follows: Pressure: 1 atm, Temperature:
120°C, Time: 5, 10, 20, 30, 45, and 60 minutes were tested with the highest percentage
conversions obtained at 60 minutes. It is advised to consider these parameters and
adjust according to the specific requirements of your experiment.
- Iteration 15: Success
- Success: 14, Fail: 1, Total: 15
- Benchmarking Score: 0.9333333333333333
--------------------
- Success on output key: output, matched a desired output
- Agent Output: The recommended parameters for an n-alkylation reaction using 3-
Bromoquinoline and morpholine [II] are as follows: Pressure: 1 atm, Temperature:
120°C, Time: 5, 10, 20, 30, 45, and 60 minutes. Note that these parameters were used
in a Buchwald-Hartwig reaction screen using a Microwave Reactor.
- Iteration 16: Success
- Success: 15, Fail: 1, Total: 16
- Benchmarking Score: 0.9375
--------------------
- Success on output key: output, matched a desired output
- Agent Output: The recommended parameters for an n-alkylation reaction using 3-
Bromoquinoline and morpholine [II] as reactants are as follows: Pressure: 1 atm,
Temperature: 120°C, Time: 5, 10, 20, 30, 45, and 60 minutes. These parameters were
tested in a Buchwald-Hartwig reaction screen using a Microwave Reactor (Biotage
Initiator+), and the highest percentage conversions were achieved with a reaction time
of 60 minutes.
- Iteration 17: Success
- Success: 16, Fail: 1, Total: 17
- Benchmarking Score: 0.9411764705882353
--------------------
- Success on output key: output, matched a desired output
- Agent Output: The recommended parameters for an n-alkylation reaction involving
3-Bromoquinoline and morpholine [II] are as follows: Pressure: 1 atm, Temperature:
120°C, Time: 5, 10, 20, 30, 45, and 60 minutes. Note that these conditions were
screened for a Buchwald-Hartwig reaction using a Microwave Reactor.
- Iteration 18: Success
- Success: 17, Fail: 1, Total: 18
- Benchmarking Score: 0.9444444444444444
--------------------
- Success on output key: output, matched a desired output
- Agent Output: The optimal parameters for an n-alkylation reaction using 3-
Bromoquinoline and morpholine [II] are as follows: Pressure: 1 atm, Temperature:
120°C, Time: 5, 10, 20, 30, 45, and 60 minutes. Note that the reaction also requires a
base of KOtBu, and the solvents tested include dioxane and toluene. A catalyst of
PEPPSI is used with a 5% wt. loading of catalyst. The reaction procedure involves
adding the reactants and catalyst to a Microwave Reactor (Biotage Initiator+), setting
up the reaction parameters, stirring for a specified time, and then stopping the reaction
according to the defined time.
- Iteration 19: Success
- Success: 18, Fail: 1, Total: 19
- Benchmarking Score: 0.9473684210526315
--------------------
- Success on output key: output, matched a desired output
- Agent Output: Based on the information provided, the recommended parameters for
an n-alkylation reaction using 3-Bromoquinoline and morpholine [II] as reactants are
as follows: Pressure: 1 atm, Temperature: 120°C, Time: 5, 10, 20, 30, 45, and 60
minutes. It is crucial to note that these parameters are based on a specific study and the
optimal parameters may vary depending on the specific reaction conditions and desired
outcome.
- Iteration 20: Success
- Success: 19, Fail: 1, Total: 20
- Benchmarking Score: 0.95

The second and third RAG based benchmarking were performed on agents which have access to an embedding trained on microwave synthesis documentation and protocols. In the second benchmarking run, the agent was asked to explain the difference between microwave irradiation and conventional heating methods. The regex used to match against the agents output checked for keywords including “microwave irradiation” and “convention heating” to simply ensure that the agent is on track (see Table 32, provided below). This can be made as specific as needed if there are additional keywords which are of specific interest. The agent's response contained those keywords in all 20 of the benchmarking runs (see Table 33, provided below). The agent's outputs in these benchmarking runs can be viewed in verbose mode and it shows a relatively detailed summary in most iterations including mentioning time and energy efficiency, uniform heating, and increasing the rate of chemical reaction by generating higher temperatures and pressures (see Table 34, provided below). There were several runs where the response was more focused on specific examples of reactions run under microwave synthesis and conventional heating methods and how the reaction times differed between the two styles of heating.

Reference is made to Table 32 which provides an example of Regular expression string used to match agentic output to check for keywords associated with microwave synthesis heating protocols vs conventional heating protocols.

TABLE 32
Regex Pattern

r‘(?=.*\b(?:[Mm]icrowave\s[Ii]rradiation|[Cc]onventional\s[Hh]eating\s[Mm]ethods?
)\b)’

Reference is further made to Table 33 which provides an example of Benchmarking results of an agent with access to an embedding trained on microwave synthesizer protocols and documentation undergoing regex benchmarking. The initial input question was asking about differences between microwave irradiation and conventional heating methods. The output includes information on the tools and tool descriptions, the initial input, the memory buffers and memory classes used, number of success/fail iterations, and the final benchmarking score (1.0).

TABLE 33
Benchmarking results of an agent with access to an embedding trained on microwave
synthesizer protocols and documentation undergoing regex benchmarking

{
“tools”: [
{
“name”: “allocate_session”,
“description”: “Function Signature:\n( ) -> dict\nFunction Docstring:\nAllocates a
session on the microwave synthesizer.\nMust be called prior to any other
action.\n\nreturns\nsession_ID the id of the allocated session”
},
{
“name”: “close_lid”,
“description”: “Function Signature:\n(session_ID: str) -> dict\nFunction
Docstring:\nCloses the lid on the microwave synthesizer.\nMust be run prior to
running heating.\n\nparameters\nsession_ID the id of the current
session\n\nreturns\nstatus is a status string that provides the result of the operation ”
},
{
“name”: “get_precent_conversion”,
“description”: “Function Signature:\n(session_ID: str) -> dict\nFunction
Docstring:\nGets the precent conversion of synthesis after running the
experiment.\nCan only be called after heating\n\nparameters\nsession_ID the id of the
current session\n\nreturns\nprecent_conversion denots the precent conversion of the
sysntesis reaciton”
},
{
“name”: “heat_vial”,
“description”: “Function Signature:\n(session_ID: str) -> dict\nFunction
Docstring:\nHeats the loaded vial to the set heating parameters.\nMust be run after
loading vial, closing lid, and updating heating_parameters\n\nparameters\nsession_ID
the id of the current session\n\nreturns\nstatus is a status string that provides the result
of the operation ”
},
{
“name”: “load_vial”,
“description”: “Function Signature:\n(vial_num: int, session_ID: str) -> dict\nFunction
Docstring:\nLoads a vial into the microwave synthesizer.\nMust be run prior to
heating.\n\nparameters\nvial_num is an integer between 1 and 10.\nsession_ID the id
of the current session\n\nreturns\nstatus is a status string that provides the result of the
operation ”
},
{
“name”: “open_lid”,
“description”: “Function Signature:\n(session_ID: str) -> dict\nFunction
Docstring:\nOpens the lid on the microwave synthesizer.\nMust be run prior to loading
a vial.\n\nparameters\nsession_ID the id of the current session\n\nreturns\nstatus is a
status string that provides the result of the operation ”
},
{
“name”: “unload_vial”,
“description”: “Function Signature:\n(session_ID: str) -> dict\nFunction
Docstring:\nUnloads a vial from the microwave synthesizer.\nMust be run after
heating.\n\nparameters\nsession_ID the id of the current session\n\nreturns\nstatus is
a status string that provides the result of the operation ”
},
{
“name”: “update_heating_parameters”,
“description”: “Function Signature:\n(duration: int, temperature: int, pressure: float,
session_ID: str) -> dict\nFunction Docstring:\nSets the heating parameters of the
microwave synthesizer.\nMust be run prior to heating.\n\nparameters\nduration is an
integer between 1 and 60 miniutes\ntemperature is an integer between 25 and 250
celsius\npressure is a float between 1 and 10 atm\nsession_ID the id of the current
session\n\nreturns\nstatus is a status string that provides the result of the operation ”
},
{
“name”: “call_RAG_agent”,
“description”: “call_RAG_agent(question: str) -> str - This is the function that will
query the relevant sources of information to get the answer to the question.\n There
will be situations when you are not able to answer the question directly from the
information you currently have. In such cases, you can search for the answer in the
relevant sources of information.\n Often the user will also specify that you need to
refer to \“information\” or \“documents\” to get the answer.\n TAKSK: You have to
frame the best possible \“question\” that is extremely descriptive and then use it as a
parameter to query the relevant sources of information.”
}
],

| | |
|---|---|
| “memory_0”: | “<class |

‘langchain.memory.buffer_window.ConversationBufferWindowMemory’>”,

| | |
|---|---|
| “memory_1”: | “<class |

‘ASPIRE_LINQX.ai.memory.internal_logging.CustomActionLogSummaryMemory’
>”,

| | |
|---|---|
| “memory_2”: | “<class |

‘ASPIRE_LINQX.ai.memory.embedding.EmbeddingSummaryMemory’>”,
“initial_input”: “How does microwave irradiation influence reaction mechanisms
differently compared to conventional heating methods?”,
“total_iter”: 20,
“success_iter”: 20,
“fail_iter”: 0,
“benchmark_score”: 1.0
}

Reference is also made to Table 34 which provides an example of Benchmarking results of the agent provided with an embedding chain with access to microwave synthesis protocols and documentation. In all benchmarking responses, the agent's output contains the desired keyworks set in the regex string.

In the third benchmarking run, the agent was asked to explain the function of the pressure setting on the Biotage Initiator+. The regex used to match against the agents output checked for keywords including “Pressure setting” and “Biotage Initiator+” to ensure that the agent is on track in its responses (See Table 35, provided below). These keywords can be made more specific if there are specific components of the response which are especially desired. The agent's answer contains these keywords in all 20 of the benchmarking responses (see Table 36, provided below). The agent's outputs in these benchmarking runs can be viewed in verbose mode and the responses uniformly include statements about how the pressure setting allows for heating solvents which have lower boiling points at higher temperatures (see Table 37, provided below). Some of the responses include information on the specific pressure range (30 bar) that the Initiator+ has and about a feature which automatically senses and performs reactions at their highest possible temperature (see Table 37, provided below).

Reference is made to Table 35 which provides an example of Regular expression string used to match agentic output to check for keywords associated with information on the pressure setting of the Biotage Initiator+.

TABLE 35
Regex Pattern used

r'( ?=.*\b(?:[Pp]ressure\s[Ss]etting|[Mm]icrowave|[Ss]
ynthesizer[Bb]iotages[Ii]nitiator\+)\b)'

Reference is also made to Table 36 which provides an example of Benchmarking results of an agent with access to an embedding trained on microwave synthesizer protocols and documentatoin undergoing regex benchmarking. The initial question asks about the function of the pressure setting of the Biotage Initiator+. The results include information of tools and tool descriptions, the memory classes and initial buffers provided, the initial input, the success/fail iterations, and the final benchmark score (1.0).

TABLE 35
Regex Pattern used

r‘(?=.*\b(?:[Pp]ressure\s[Ss]etting|[Mm]icrowave|[Ss]ynthesizer|[Bb]iotage\s[Ii]nitiat
or\+)\b)’

Reference is further made to Table 37 which provides an example of Benchmarking results on the agent provided with an embedding chain trained on microwave synthesis and protocols for RAG purposes. The agent mentions the keywords defined in the regex in every single benchmark operation.

TABLE 37
Benchmarking results on the agent provided with an embedding chain
trained on microwave synthesis and protocols for RAG purposes

- Success on output key: output, matched a desired output
- Agent Output: The pressure setting on the Biotage Initiator+ allows for temperatures
and pressures of up to 300 °C and 30 bar. This feature provides the ability to perform
complex reactions that would be difficult under other conditions. Specifically, it allows
solvents with low boiling points to be used at higher temperatures, providing more
flexibility in choosing a solvent for organic synthesis.
- Iteration 1: Success
- Success: 1, Fail: 0, Total: 1
- Benchmarking Score: 1.0
--------------------
- Success on output key: output, matched a desired output
- Agent Output: The pressure setting on the Biotage Initiator+ allows for temperatures
and pressures of up to 300 °C and 30 bar, which opens up new possibilities to perform
difficult reactions. This feature enables even solvents with low boiling points to be run
at higher temperatures, providing more flexibility in choosing a solvent for reactions.
- Iteration 2: Success
- Success: 2, Fail: 0, Total: 2
- Benchmarking Score: 1.0
--------------------
- Success on output key: output, matched a desired output
- Agent Output: The pressure setting on the Biotage Initiator+ serves a crucial function.
It allows for temperatures and pressures of up to 300 °C and 30 bar, which opens up
new possibilities to perform difficult reactions. This feature enables even solvents with
low boiling points to be run at higher temperatures, providing more flexibility in
choosing a solvent for the synthesis process.
- Iteration 3: Success
- Success: 3, Fail: 0, Total: 3
- Benchmarking Score: 1.0
--------------------
- Success on output key: output, matched a desired output
- Agent Output: The pressure setting on the Biotage Initiator+ Microwave Synthesizer
serves the function of allowing for higher temperatures and pressures of up to 300 °C
and 30 bar. This feature opens up new possibilities to perform difficult reactions and
enables even solvents with low boiling points to be run at higher temperatures,
providing more flexibility in choosing a solvent.
- Iteration 4: Success
- Success: 4, Fail: 0, Total: 4
- Benchmarking Score: 1.0
--------------------
- Success on output key: output, matched a desired output
- Agent Output: The pressure setting on a Biotage Initiator+ microwave synthesizer
allows for temperatures and pressures up to 300 °C and 30 bar. This feature is designed
to automatically sense and perform reactions at their highest possible temperatures,
providing greater flexibility in running reactions with different solvents, including
those with low boiling points, at higher temperatures.
- Iteration 5: Success
- Success: 5, Fail: 0, Total: 5
- Benchmarking Score: 1.0
--------------------
- Success on output key: output, matched a desired output
- Agent Output: The pressure setting on the Biotage Initiator+ allows for temperatures
and pressures of up to 300 °C and 30 bar. This feature opens up new possibilities to
perform difficult reactions. Even solvents with low boiling points can be run at higher
temperatures, providing more flexibility in choosing a solvent for reactions.
- Iteration 6: Success
- Success: 6, Fail: 0, Total: 6
- Benchmarking Score: 1.0
--------------------
- Success on output key: output, matched a desired output
- Agent Output: The pressure setting on the Biotage Initiator+ Microwave Synthesizer
serves to allow for higher pressures of up to 30 bar. This opens up new possibilities to
perform difficult reactions by providing more flexibility in choosing solvents and
facilitating the completion of challenging reactions.
- Iteration 7: Success
- Success: 7, Fail: 0, Total: 7
- Benchmarking Score: 1.0
--------------------
- Success on output key: output, matched a desired output
- Agent Output: The pressure setting on the Biotage Initiator+ microwave synthesizer
allows for higher temperatures and pressures, enabling difficult reactions and allowing
solvents with low boiling points to be run at higher temperatures. The system
automatically performs reactions at their highest possible temperatures, providing
more flexibility in choosing solvents for synthesis processes.
- Iteration 8: Success
- Success: 8, Fail: 0, Total: 8
- Benchmarking Score: 1.0
--------------------
- Success on output key: output, matched a desired output
- Agent Output: The pressure setting on the Biotage Initiator+ serves several functions.
It allows for temperatures and pressures of up to 300 °C and 30 bar, which enables the
performance of difficult reactions. Moreover, this feature allows solvents with low
boiling points to be used at higher temperatures, providing more flexibility in choosing
a solvent for reactions.
- Iteration 9: Success
- Success: 9, Fail: 0, Total: 9
- Benchmarking Score: 1.0
--------------------
- Success on output key: output, matched a desired output
- Agent Output: The pressure setting on the Biotage Initiator+ microwave synthesizer
is quite significant. It allows for temperatures and pressures up to 300 °C and 30 bar,
respectively. This feature enables the system to automatically sense and perform
reactions at their highest possible temperatures, offering more flexibility when dealing
with different solvents, including those with low boiling points, at elevated
temperatures.
- Iteration 10: Success
- Success: 10, Fail: 0, Total: 10
- Benchmarking Score: 1.0
--------------------
- Success on output key: output, matched a desired output
- Agent Output: The pressure setting on the Biotage Initiator+ microwave synthesizer
serves to enable higher temperatures and pressures of up to 300 °C and 30 bar. This
feature allows for the performance of more challenging reactions and even enables
solvents with low boiling points to be run at higher temperatures. The system is
designed to automatically sense and carry out reactions at their highest possible
temperatures, offering more flexibility in the choice of solvents for synthesis
processes.
- Iteration 11: Success
- Success: 11, Fail: 0, Total: 11
- Benchmarking Score: 1.0
--------------------
- Success on output key: output, matched a desired output
- Agent Output: The pressure setting on the Biotage Initiator+ microwave synthesizer
allows for higher temperatures and pressures of up to 300 °C and 30 bar. This feature
enables the performance of difficult reactions and allows even solvents with low
boiling points to be used at higher temperatures. The system automatically senses and
performs reactions at their highest possible temperatures, providing more flexibility in
choosing solvents for synthesis processes.
- Iteration 12: Success
- Success: 12, Fail: 0, Total: 12
- Benchmarking Score: 1.0
--------------------
- Success on output key: output, matched a desired output
- Agent Output: The pressure setting on the Biotage Initiator+ serves to allow for
higher temperatures and pressures of up to 300 °C and 30 bar. This feature opens up
new possibilities to perform difficult reactions, even with solvents that have low
boiling points. The system automatically senses and performs reactions at their highest
possible temperatures, providing greater flexibility in choosing solvents and enabling
the completion of challenging reactions.
- Iteration 13: Success
- Success: 13, Fail: 0, Total: 13
- Benchmarking Score: 1.0
--------------------
- Success on output key: output, matched a desired output
- Agent Output: The pressure setting on a Biotage Initiator+ microwave synthesizer
allows chemists to explore new areas and perform the latest innovations in drug
discovery. The Initiator+ can achieve temperatures and pressures up to 300 °C and 30
bar, which opens up new possibilities to complete difficult reactions. This feature
enables even low boiling point solvents to be run at higher temperatures, providing
more flexibility in choosing a solvent for the synthesis process.
- Iteration 14: Success
- Success: 14, Fail: 0, Total: 14
- Benchmarking Score: 1.0
--------------------
- Success on output key: output, matched a desired output
- Agent Output: The pressure setting on the Biotage Initiator+ is designed to allow for
temperatures and pressures of up to 300 °C and 30 bar, respectively. This feature
enables even solvents with low boiling points to be run at higher temperatures,
providing more flexibility when choosing a solvent for reactions.
- Iteration 15: Success
- Success: 15, Fail: 0, Total: 15
- Benchmarking Score: 1.0
--------------------
- Success on output key: output, matched a desired output
- Agent Output: The pressure setting on the Biotage Initiator+ microwave synthesizer
serves to allow for higher temperatures and pressures, up to 300 °C and 30 bar. This
opens up new possibilities to perform difficult reactions and even allows solvents with
low boiling points to be run at higher temperatures. The system automatically senses
and performs reactions at their highest possible temperatures, providing more
flexibility in choosing solvents for synthesis processes.
- Iteration 16: Success
- Success: 16, Fail: 0, Total: 16
- Benchmarking Score: 1.0
--------------------
- Success on output key: output, matched a desired output
- Agent Output: The pressure setting on the Biotage Initiator+ serves several functions.
It allows for temperatures and pressures of up to 300°C and 30 bar, which enables the
system to perform difficult reactions that would not be possible under normal
conditions. Moreover, this feature provides greater flexibility in choosing solvents as
it allows for reactions with solvents that have low boiling points to be run at higher
temperatures.
- Iteration 17: Success
- Success: 17, Fail: 0, Total: 17
- Benchmarking Score: 1.0
--------------------
- Success on output key: output, matched a desired output
- Agent Output: The pressure setting on the Biotage Initiator+ microwave synthesizer
allows for higher temperatures and pressures of up to 300 °C and 30 bar. This feature
opens up new possibilities to perform difficult reactions and allows even solvents with
low boiling points to be run at higher temperatures. The system automatically senses
and performs reactions at their highest possible temperatures, providing more
flexibility in choosing solvents for synthesis.
- Iteration 18: Success
- Success: 18, Fail: 0, Total: 18
- Benchmarking Score: 1.0
--------------------
- Success on output key: output, matched a desired output
- Agent Output: The pressure setting on the Biotage Initiator+ microwave synthesizer
allows for high temperatures and pressures up to 300 °C and 30 bar. This feature
enables the execution of difficult reactions and even allows solvents with low boiling
points to be run at higher temperatures. The system automatically senses and carries
out reactions at their highest possible temperatures, providing more flexibility in
choosing solvents for synthesis processes.
- Iteration 19: Success
- Success: 19, Fail: 0, Total: 19
- Benchmarking Score: 1.0
--------------------
- Success on output key: output, matched a desired output
- Agent Output: The pressure setting on the Biotage Initiator+ serves to allow for
higher temperatures and pressures of up to 300 °C and 30 bar. This feature opens up
new possibilities to perform difficult reactions, even with solvents that have low
boiling points. The system automatically senses and performs reactions at their highest
possible temperatures, providing greater flexibility in choosing solvents and enabling
the user to achieve better results in their organic synthesis processes.
- Iteration 20: Success
- Success: 20, Fail: 0, Total: 20
- Benchmarking Score: 1.0

Finally, path-based agentic benchmarking was run on an agent integrated with PubChem REST API endpoints. This agent was asked to find the Ki value of PZM21 to the mu opioid receptor and to provide a citation and detailed description of the assay used to determine the Ki value. The correct action path includes getting a PubChem compound ID (CID) corresponding to PZM21, getting assay results with Ki activity using the corresponding CID, and then getting the description of an assay which tests PZM21 Ki activity to the mu opioid receptor (see Table 38, provided below). The agent passed 17 of the 20 benchmarking runs, resulting in a benchmarking core of 0.85 (see Table 39, provided below). One of the failed runs occurred because the agent added an unnecessary step of getting the assay name after getting the description. This information is contained in previous output and thus is unnecessary (see Table 40, provided below). The other two errors were agentic parsing errors where additional input was given to the tool run call which causes it to error which can be remedied by turning on agentic parsing errors.

Reference is made to Table 38 which provides an example of Schema and paths used to validate initial state benchmarking of the PubChem REST API agent. This benchmark expects one of two paths where the agent gets the compound's CID from the name “pzm21” or “PZM21”, gets Ki assay results for one or both corresponding CID's, and then finally gets the description from one of three valid assay ID's.

TABLE 38
Schema and paths used to validate initial state
benchmarking of the PubChem REST API agent

```
class CidFromNameSchema(BaseModel):
inp: Literal[‘pzm21’, ‘PZM21’]
class AssayResultsFromCompound(BaseModel):
cid: Literal[‘121596705’, ‘124186394’]
activity_name: Literal[‘Ki’]
class AssayDescriptionFromAid(BaseModel):
aid: Literal[‘1806958’, ‘1609954’, ‘1573390’]
path = [
[
  (‘get_cid_from_name’, CidFromNameSchema),
  (‘get_assay_results_for_compund’,AssayResultsFromCompound),
  (‘get_assay_description’,AssayDescriptionFromAid)
],
[
  (‘get_cid_from_name’, CidFromNameSchema),
  (‘get_assay_results_for_compund’,AssayResultsFromCompound),
  (‘get_assay_results_for_compund’,AssayResultsFromCompound),
  (‘get_assay_description’,AssayDescriptionFromAid)
]
]
```

Reference is also made to Table 39 which provides an example of Benchmarking results of an agent built around the PubChem REST API undergoing path-based benchmarking. The agent is asked to retrieve the Ki value of the compound PZM21 to the mu opioid receptor and then cite the specific assay which was the source of that information with a detailed description of how the assay was conducted. The benchmarking results include the tools and tool descriptions, the memory classes used, the initial input, the number of success/fail iterations, and the final benchmarking score (0.85).

TABLE 39
Benchmarking results of an agent built around the
PubChem REST API undergoing path-based benchmarking

```
class CidFromNameSchema(BaseModel):
inp: Literal[‘pzm21’, ‘PZM21’]
class AssayResultsFromCompound(BaseModel):
cid: Literal[‘121596705’, ‘124186394’]
activity_name: Literal[‘Ki’]
class AssayDescriptionFromAid(BaseModel):
aid: Literal[‘1806958’, ‘1609954’, ‘1573390’]
path = [
[
  (‘get_cid_from_name’, CidFromNameSchema),
  (‘get_assay_results_for_compund’,AssayResultsFromCompound),
  (‘get_assay_description’,AssayDescriptionFromAid)
],
[
  (‘get_cid_from_name’, CidFromNameSchema),
  (‘get_assay_results_for_compund’,AssayResultsFromCompound),
  (‘get_assay_results_for_compund’,AssayResultsFromCompound),
  (‘get_assay_description’,AssayDescriptionFromAid)
]
]
Supplementary Fig. 38 | Schema and paths used to validate initial state benchmarking
of the PubChem REST API agent. This benchmark expects one of two paths where the
agent gets the compound's CID from the name “pzm21” or “PZM21”, gets Ki assay
results for one or both corresponding CID's , and then finally gets the description from
one of three valid assay ID's.
Benchmarking results
{
“tools”: [
{
“name”: “get_assay_description”,
“description”: “Function Signature:\n(aid: str) -> dict\nFunction Docstring:\nFunction
purpose\nGet high level Assay description, protocol and comment on the scores for a
given assay id.\n\nInputs\naid: string representation of a list of assay
IDs\n\nreturns\ndict: a dictionary of description, protocol and comment for the given
assay ID”
},
{
“name”: “get_assay_name_from_aid”,
“description”: “Function Signature:\n(aid: str) -> dict\nFunction Docstring:\nFunction
purpose\nGives a dictionary of names for each assay ID (aid)\n\nInputs\naid: string
representation of a list of assay IDs\n\nreturns\nstr: a dictionary of names for each
assay ID”
},
{
“name”: “get_assay_results_for_compund”,
“description”: “Function Signature:\n(cid: str, activity_name: str = None) ->
dict\nFunction Docstring:\nFunction purpose\nGets all the assay results for a provided
compund with an optional filter of assay activity type.\n\nInputs:\ncid: a single cid
representing a compound\nactivity_name (optional): the specific activity type to filter
on for example Ki, Kd, IC50, etc\n\nreturns\ndict: a disctionary representation of the
```

| | |
|---|---|
| assay | result |

table\nhttps://pubchem.ncbi.nlm.nih.gov/rest/pug/compound/cid/121596705/assaysu
mmary/JSON”
},
{
“name”: “get_cid_from_name”,
“description”: “Function Signature:\n(inp: str) -> dict\nFunction Docstring:\nFunction
purpose\nGet the cid from chemical name\n\nInputs\ninp: string representation of a
chemical name\n\nreturns\ndict: ”
},
{
“name”: “get_compound_property_table”,
“description”: “Function Signature:\n(inp: str, inp_format: str, inp_type: str,
property_list: str) -> Dict[str, str | int]\nFunction Docstring:\nNone”
},
{
“name”: “get_description”,
“description”: “Function Signature:\n(inp: str, inp_format: str, inp_type: str) ->
dict\nFunction Docstring:\nFunction purpose \nGet description of a substance or a
compound, for assay description, use get_assay_description( ) instead\n\nInputs\ninp:
string representation of an single chemical name only\ninp_format: string of either of
name, sid, cid, smiles \ninp_type: ‘compound’ if inp_format is cid, name or smiles of
compound or ‘substance’ if inp_format is sid, name, smiles of
substance\n\nreturns\ndict: a dictionary of descriptions for each identifier”
},
{
“name”: “get_smiles_from_name”,
“description”: “Function Signature:\n(inp: str) -> dict\nFunction Docstring:\nFunction
purpose\nGet SMILES for a given chemical name. \n\nInputs\ninp: string
representation of a chemical name\n\nreturns\nstr: a text representing the SMILES for
the given chemical name”
},
{
“name”: “get_synonym”,
“description”: “Function Signature:\n(inp: str, inp_format: str, inp_type: str) ->
dict\nFunction Docstring:\nFunction purpose\nGet Synonym of a substance or
compound.\n\nInputs\ninp: string representation of a list of identifiers\ninp_format:
string which can be either of name, sid, cid, smiles\ninp_type: ‘compound’ if
inp_format is cid, name or smiles of compound or ‘substance’ if inp_format is sid,
name, smiles of substance\n\nreturns\ndict: a dictionary of synonyms for each
identifier”
}
],

| | |
|---|---|
| “memory_0”: | “<class |

‘langchain.memory.buffer_window.ConversationBufferWindowMemory’>”,

| | |
|---|---|
| “memory_1”: | “<class |

‘ASPIRE_LINQX.ai.memory.internal_logging.CustomActionLogSummaryMemory’
>”,
“initial_input”: “What is the Ki value of the compound PZM21 when it binds to the
Mu opioid receptor? Select one specific assay used to determine this value, provide a
citation for that particular assay, and give a detailed description of how the assay was
conducted.”,
“total_iter”: 20,
“success_iter”: 17,
“fail_iter”: 3,
“benchmark_score”: 0.85
}

Reference is further made to Table 40 which provides an example of Benchmarking log of a PubChem REST API agent which underwent path-based benchmarking on an assay retrieval task. The agent was asked to find the Ki of PZM21 to the mu opioid receptor and to cite the assay which was the source of that information and provide a description of that assay. The agent correctly performed a sequence of actions which would retrieve this information 17 out 20 times. One of the failures added an additional step (name retrieval) which was not necessary as this information was contained in previous output. The other two failures were agentic errors where the LLM information returned to the agent for tool usage was not correct for the specified tool.

TABLE 40
Benchmarking log of a PubChem REST API agent which underwent
path-based benchmarking on an assay retrieval task

https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 1: Success
- Success: 1, Fail: 0, Total: 1
- Benchmarking Score: 1.0
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 2: Success
- Success: 2, Fail: 0, Total: 2
- Benchmarking Score: 1.0
--------------------
https://pubchem.ncbi.nlm.nih.gov/rest/pug/assay/aid/1573390/description/JSON
names Displacement of [3H]-Diprenorphine from mu opioid receptor (unknown
origin) expressed in sf9 insect cell membranes after 1 hr by liquid scintillation counting
method
- Fail on output key: intermediate_steps, did not match any of the desired outputs
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
get_assay_name_from_aid: {“aid”: “1573390”}
- Iteration 3: Fail
- Success: 2, Fail: 1, Total: 3
- Benchmarking Score: 0.6666666666666666
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 4: Success
- Success: 3, Fail: 1, Total: 4
- Benchmarking Score: 0.75
--------------------
Error on iteration 5: LinqxTool._run( ) takes 1 positional argument but 2 were given
- Iteration 5: Fail
- Success: 3, Fail: 2, Total: 5
- Benchmarking Score: 0.6
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 6: Success
- Success: 4, Fail: 2, Total: 6
- Benchmarking Score: 0.6666666666666666
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 7: Success
- Success: 5, Fail: 2, Total: 7
- Benchmarking Score: 0.7142857142857143
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 8: Success
- Success: 6, Fail: 2, Total: 8
- Benchmarking Score: 0.75
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 9: Success
- Success: 7, Fail: 2, Total: 9
- Benchmarking Score: 0.7777777777777778
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 10: Success
- Success: 8, Fail: 2, Total: 10
- Benchmarking Score: 0.8
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 11: Success
- Success: 9, Fail: 2, Total: 11
- Benchmarking Score: 0.8181818181818182
--------------------
Error on iteration 12: LinqxTool._run( ) takes 1 positional argument but 2 were given
- Iteration 12: Fail
- Success: 9, Fail: 3, Total: 12
- Benchmarking Score: 0.75
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 13: Success
- Success: 10, Fail: 3, Total: 13
- Benchmarking Score: 0.7692307692307693
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 14: Success
- Success: 11, Fail: 3, Total: 14
- Benchmarking Score: 0.7857142857142857
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 15: Success
- Success: 12, Fail: 3, Total: 15
- Benchmarking Score: 0.8
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 16: Success
- Success: 13, Fail: 3, Total: 16
- Benchmarking Score: 0.8125
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 17: Success
- Success: 14, Fail: 3, Total: 17
- Benchmarking Score: 0.8235294117647058
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 18: Success
- Success: 15, Fail: 3, Total: 18
- Benchmarking Score: 0.8333333333333334
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 19: Success
- Success: 16, Fail: 3, Total: 19
- Benchmarking Score: 0.8421052631578947
--------------------
https://pubchem.ncbi.nlm.nih.gov/rest/pug/assay/aid/1573390/description/JSON
- Success on output key: intermediate_steps, matched a desired output
- Agent action path:
get_cid_from_name: {“inp”: “PZM21”}
get_assay_results_for_compund: {“cid”: “121596705”, “activity_name”: “Ki”}
get_assay_description: {“aid”: “1573390”}
- Iteration 20: Success
- Success: 17, Fail: 3, Total: 20
- Benchmarking Score: 0.85

Agent as a Prompt Engineer Prompt engineering has been highlighted as a method to tailor context and instructions provided to LLM's so that generative output is more directed towards specific tasks. This is traditionally done in a static process by having a human prompt engineer manually modify the prompt in an iterative manner and assess the output qualitatively. This can be extensive, but generally yields good results for a specific task if the human is knowledgeable in the task domain. Additionally, the prompts do not generalize well to tasks outside of the prompts domain and thus require modification or updates to accommodate changes in the problem space. Other more automated frameworks exist for this task including RAG and LLM based prompt generation. While these automated frameworks can augment or create prompts which are highly relevant to specific tasks, they are limited to either the RAG source or the LLM's domain of knowledge. This means that the information source which engineers the prompt is relatively static and must be updated manually updated either by adding new information to the data source or fine tuning the LLM. In all these situations, the prompt is highly tailored towards the task at hand which can cause issues if entities such as tool endpoints or LLM versioning is changed.

Agentic prompt engineering differs from other automated methods by transforming the prompt augmentation domain from a static to a dynamic information source. Unlike conventional approaches, the tools used in agentic prompt engineering are defined at runtime, allowing the agent to explore and adapt in real-time. This method mimics human problem-solving by dynamically exploring, learning, and retaining knowledge gained during the process. However, unlike manual efforts, it automates these steps, enabling a more efficient workflow. As the agent iterates through its exploratory process, it captures actions and insights in agentic components such as the agent's scratchpad and memory buffers. This retained knowledge can then be leveraged in future prompts, enhancing the agent's adaptability and effectiveness. With our infrastructure's service, tool, and task-agnostic base prompt, combined with built-in error handling and state-tracking memory, it provides an excellent framework for implementing agentic prompt engineering.

In this work, we showcase an agentic framework which is used to operate through complex chemical problems in a robust manner without static prompt engineering and a benchmarking apparatus that can quantify and troubleshoot this operation. This framework utilizes a core infrastructure that is organized in a hierarchical manner, representing key operational information about a selected system's internal endpoints in human readable JSON format. This information is dynamically generated and categorized from source code documentation, keeping any prompt augmentation on operational components restricted and organized to the source. Agents can be provided with other tools that allow for robust operational planning via planning chains, access to documentation embedding via embedding chains, and access to external information via agent-to-agent communication. We implement custom memory classes which are designed to keep track of the systems operational state and relevant external context to promote robust operation even when operating in an extensive and highly disjoint manner as in the case in a modicum of complex scientific workflows. Finally, we showcase a benchmarking infrastructure that can adapt to gauge robustness in a variety of different situations including benchmarking the agent's output, path, and external system state post operation.

This agentic framework and its associated components were tested on two main applications including a physical/virtual microwave synthesizer and a series of endpoints which access the PubChem REST API. All core infrastructure components were generated from source code documentation and dynamically included in the base prompt during agent creation. Planning chains were used to showcase LLM based generation of a high-level workflow to access bioassay information using implemented PubChem REST API endpoints. These chains were also used in the creation and execution of a workflow designed to run a benchmark N-alkylation reaction on a Biotage Initiator+, resulting in a 0.7% delta in precent conversion when compared to a human run process. Different embeddings were trained on a series of documentation including electron lab notebook pages (ELN) and microwave synthesizer protocols and tested on questions designed to access key information on specific relevant chemical applications. Access to these embeddings was provided to corresponding agents via specialized tools to allow for the agents to augment their domain of knowledge with targeted information from curated sources dynamically at runtime. Two custom state-based memory classes were tested on the virtual microwave synthesizer agent showcasing robust ways to keep track of system context during operation. Finally, benchmarks were run on various agents to gauge correct operation from a statistical perspective and identify points of failure.

Overall, this framework provides a new approach to agentic operation where agents are dynamically built from source documentation around a specific system with a defined scope. Allowing agents to keep track of information from tools that provide internal and external context separately creates a class of agents that are ready to be a part of a larger system where communication between different agents with different scopes is critical to the success of solving complex problems. This is bolstered by state-based memory which only keeps track of relevant system components and modifies its internal state based on defined transition rules. Having a memory system which utilizes the benefits of generative AI but is designed to be focused and adhere to clearly defined rules can provide great benefits in keeping an agentic system focused on relevant scientific goals. While this system is LLM agnostic in implementation, it is designed to be used with general purpose LLMs and include specific information from a RAG based approach. This forgoes the need to fine tune LLMs with additional domain knowledge around selected scientific processes, and instead rely on curated information and agentic operation to explore and learn about new domains.

Several modules herein provide novel approaches to the above-described AI platform. These include 1) Finite State Automaton (FSA)-Based Memory; 2) Serializable Agentic Information Hierarchy; 3) Agentic Benchmarking Infrastructure; 4) Agentic Benchmarking Infrastructure; 5) AI Agents as Prompt Engineers; 6) AI Agent Management Hierarchy; 7) Tool-Memory Categorization and Filtration; and 8) Agentic Tool Input Validation Hierarchy. Each of these modules are further described below.

Finite State Automaton (FSA)-Based Memory—The following terminology is helpful in the disclosure of FSA-based memory. Text-based generative AI: A generative AI model which can generate large amounts of text with a high degree of structure and semantic coherence. An example of this would be a large language model (LLM). Generative AI chain: A process in where text-based generative AI model request-response pairs are chained together. Output parser: A code object or function which is designed to ensure that text-based generative AI output conforms to a certain format. AI agent: An exploratory entity, which iteratively operates, whose decision making is logically powered by text-based generative AI, has tools which the logic center can determine to be used to interact with other entities, and has memory which retains past information. Memory buffer: A code variable or object which is used to retain information on an AI agent's actions, interactions, observations, or any other relevant information to an AI agent's operation. Finite state automaton (FSA): A system which can be represented as a collection of states with defined rules which allow for transitions between those states (transitions rules). Transition rule: A stated rule which must be satisfied before a transition between one state to another is allowed. Validation schema: a code object or function which is designed to ensure that input conforms to specific regulations as specified in the schema.

We describe below implementing AI agentic infrastructure that includes several types of memory. The types of memory provides learning and memory for our AI agents (Diagram 1) to perform, automate and learn from complex tasks. Memory buffer: A text-based memory buffer which stores information on the current state of a physical or theoretical system or workflow. This is referred to as the initial state. FSA-based schema: A schema which details the allowed states of a system or workflow by defining the system or workflow using a collection of variables with information on specific ranges or allowed values of those variables. FSA-based transition rules: A set of transition rules which clearly state how the variables which define the system or workflow change, signaling a transition of the system or workflow from one state to another. Generative AI chain: A call to a generative AI model which is defined by the following input and output Prompt (Input): A text-based prompt which is provided to the generative AI model as input. This prompt contains or is augmented with the following information: The current contents of the memory buffer which include information on the current state of the system Detailed information on what actions were taken and what information was learned from those actions from operation of the AI agent A text-based representation of the FSA-based schema A text-based representation of the transition rules General instructions on how modify schema variables by following transition rules Information on how to format the output such that it complies with any formatting rules which are required for validation against the schema or any other process (optional—but highly recommended) A general example of a current state schema, agent action or set of agent actions, and a final state schema that would be the result of applying that action path to the current state schema (optional—but should be included to help with accuracy). Final State (Output): A text-based output which details the state of the system or workflow after applying all transition rules triggered by agent actions to the set of variables defined in the initial state. Output Parser: A code object or function which is designed to validate the output of the generative AI chain defined in list element 4. This output parser is provided with the FSA based schema detailed in list element 2 and runs validation on the generative AI chains output (final state) to ensure it complies with the format of the schema. The FSA-based memory differs from prior art work; this approach is the first AI agent memory system which applies an FSA based state emulation and transition rule protocol to keep track of the state of a system or workflow. Other memory classes do exist such as chat history (keep track of user input and AI agent output), chat summary (summarizing interactions between user and agent), and tool logging (keeping track of agent tools). This memory class takes a unique approach designed to focus retained information on the desired collection of variables which represent system states and to promote changes in system state based on clearly defined transition rules using generative AI. This provides agents with a concise overview of relevant operational information without flooding the memory buffer with additional and sometimes unnecessary context.

Methods for Finite State Automaton Memory integrated with AI Agents: The present disclosure details an agent's FSA-based memory buffer (memory buffer) which operates and is modified by a process which involves the following steps:
1) The input to the generative AI model which controls the logical decision making of the AI agent is augmented with the current contents of the memory buffer in addition to some task T. This provides information on the current state (N) of the system or workflow to the AI agent.
2) The agent operates for 1 to n iterations to attempt to accomplish task T. Information on this agent's operation including thoughts, tool usage (action), and tool output (observations) are retained creating log L.
3) Information in log L is provided in text-based format to a generative AI chain which is augmented with the information described in list element 4 of the infrastructure claim.
4) The chain predicts the final state (N+1) of the system or workflow as text-based output.
5) This information is passed through an output parser which ensures that the text-based output conforms with any formatting or schema validation requirements (i.e. represents a valid state). This step is optional but highly recommended.
6) The final text-based output after validation occurs (if applicable) is written to the memory buffer, completing an update of system state in the context of the AI agent's memory.

In execution of the FSA-based memory, steps 1-6, discussed above, can be repeated n times as the AI agent iteratively operates to accomplish some tasks or explore some problem space.

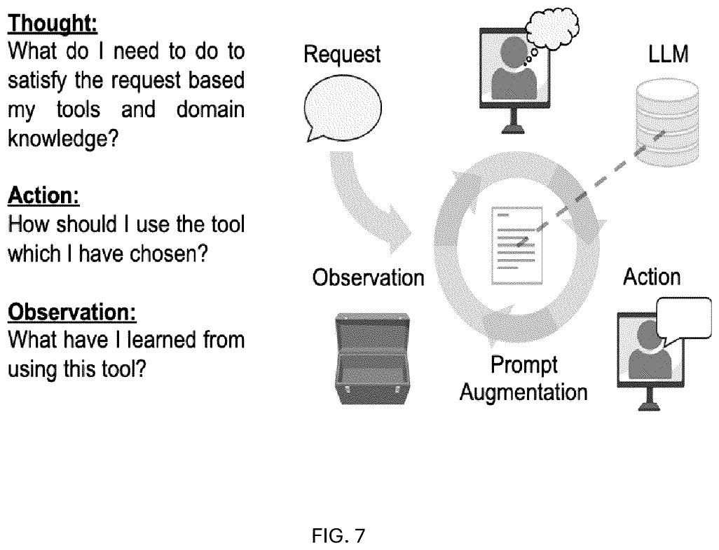

Reference is made to FIG. 7 which is a diagram providing an example of how agents operate via the commonly used ReAct framework*. In this framework, the agent thinks about what to do in its current situation, chooses an available tool and uses that tool with appropriate input, and then observes the output of that tool. This framework represents one example. Other frameworks exist or could exist in the future including modifications of this framework that could generate tool usage and observations which could be passed to the FSA-based memory.

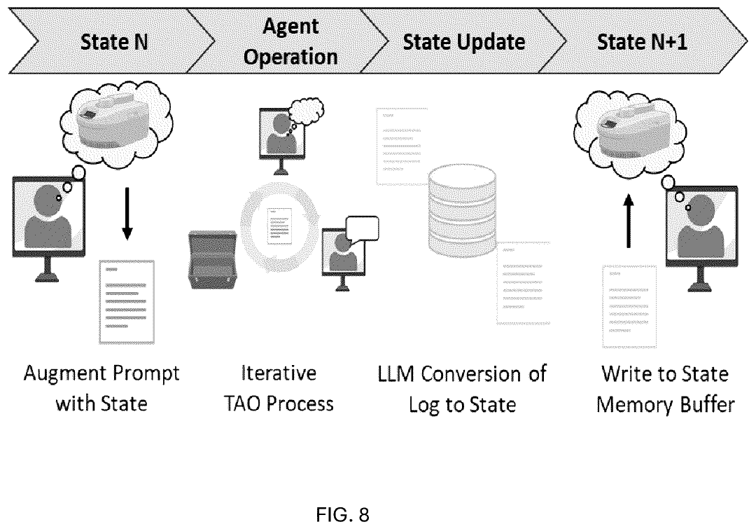

Reference is also made to FIG. 8 which provides an example of how FSA-based memory operates including augmentation of the AI agent's prompt with the current state of the agent (N) via the memory buffer, iterative operation by the AI agent which brings the agent from its current state (N) to a new state (N+1), generative AI based conversion of agents action path and corresponding observations to reflect that new state (N+1), and saving the new state (N+1) to the FSA-based memory buffer.

Reference is also made to Table 41 which provides an example of a schema (Pydantic*) used to define the collection of variables which represent a microwave synthesizer. This schema defines each variable, provides default values (corresponding to the system or workflows presumed initial state), and provides restrictions on that variable such as data type, ranges, or allowed values. In this situation the schema defines the transition rules as a part of the variable descriptions**. Generally, the output of the generative AI model is run against this schema to ensure that the output conforms to a valid system or workflow state.

TABLE 41
An example of a schema (Pydantic*) used to define the collection
of variables which represent a microwave synthesizer

class MicrowaveSynthesizerFSA(BaseModel): sessionID: str | None =
Field(default=None, description=‘ID of the session allocation or None if no session
allocated. Changed by allocating the session’) lid_status: Literal[‘open’, ‘closed’] =
Field(default=‘closed’, description=‘status of the lid. Changed by opening or closing the
lid’) vial_status: Literal[‘loaded’, ‘unloaded’] = Field(default=‘unloaded’,
description=‘status of the vial. Changed by loading/unloading the vial’) vial: str | None =
Field(default=None, description=‘Identifier of the vial loaded, None if no vial is loaded.
Changed by loading/unloading the vial’) heating_status: Literal[‘not_heating’, ‘heating’] =
Field(default=‘not_heating’, description=‘Status of heating. Only changed by heating the
vial, not by updating the parameters’) temp: int | None = Field(default=None,
description=‘set temperature to heat at, None if not currently set. Changed by updating
the heating parameters’) duration: int | None = Field(default=None, description=‘set
duration to heat for, None if not currently set. Changed by updating the heating
parameters’) pressure: float | None = Field(default=None, description=‘set pressure to heat
at, None if not currently set. Changed by updating the heating parameters’)

The above-described schema does not need to be built with a specific software development package, it only needs to provide the information mentioned in the above description. The transition rules do not need to be included in the same object as the schema, they can be presented as an individual entity or as two separate entities as long as the prompt is augmented with information on both. It is not required but highly recommended that the output of the generative AI model is run against the schema to ensure state validity.

Reference is made to Table 42 which provides an example of initial and final FSA-based memory buffer contents in JavaScript Object Notation (JSON) format and commands which are used to satisfy transition rules for a microwave synthesizer. The set of initial variables include information on the session, lid, vial, heating status, and heating parameters. The commands are recorded as a part of the AI agent's actions. The final sate is generated as a resulting of applying transition rules which corresponds to operational commands to change variables from one to another.

TABLE 42
An example of initial and final FSA-based memory buffer contents
in JavaScript Object Notation (JSON) format and commands which
are used to satisfy transition rules for a microwave synthesizer

| | |
|---|---|
| Initial FSA | { |
| State | ″sessionID″: ″6fb8846e...″, |
| | ″lid_status″: ″closed″, |
| | ″vial_status″: ″unloaded″, |
| | ″vial″: null; |
| | ″heating_status″: ″not_heating″, |
| | ″temp″: null, |
| | ″duration″: null, |
| | ″pressure″: null |
| | } |
| Operational | open_lid( |
| Commands | ID = ‘6fb8846e...’ |
| | ) |
| | load_vial( |
| | ID = ‘6fb8846e...’, |
| | number = 3 |
| | ) |
| | close_lid( |
| | ID = ‘6fb8846e...’ |
| | ) |
| Final FSA | { |
| State | ″sessionID″: ″6fb8846e...″, |
| | ″lid_status″: ″closed″, |
| | ″vial_status″: ″loaded″, |
| | ″vial″: ″3″, |
| | ″heating_status″: ″not_heating″, |
| | ″temp″: null, |
| | ″duration″: null, |
| | ″pressure″: null |
| | } |

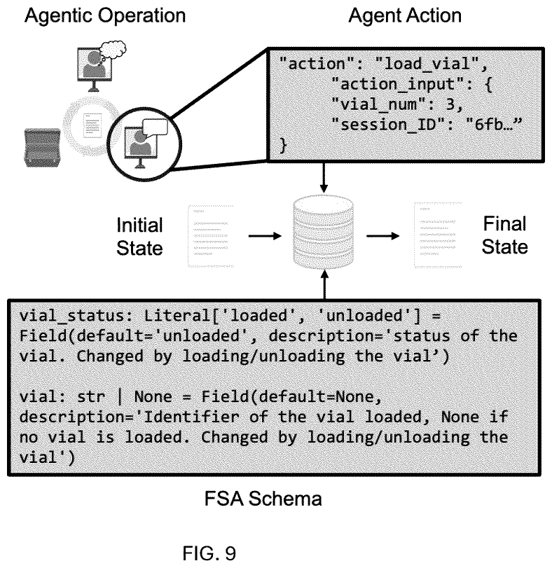

Reference is also made to FIG. 9 which provides a visualization of an operational command shown Table 42 being applied to selected elements of the schema shown in Table 41.

The next module of the present disclosure is directed to Serializable Agentic Information Hierarchy. The following terminology is helpful in the disclosure of this module. Text-based generative AI: A generative AI model which can generate large amounts of text with a high degree of structure and semantic coherence. An example of this would be a large language model (LLM). Generative AI chain: A process in where text-based generative AI model request-response pairs are chained together. Output parser: A code object or function which is designed to ensure that text-based generative AI output conforms to a certain format. AI agent: An exploratory entity, which iteratively operates, whose decision making is logically powered by text-based generative AI, has tools which the logic center can determine to be used to interact with other entities, and has memory which retains past information. Agentic operation: When the AI agent is iterative operating in a problem space or to accomplish some general tasks. Tool call: When the logical center of the AI agent provides text-based output which is then translated by some interpreter that executes a code-based function based on the information contained in that text-based output Action path: The list of tool calls, inputs, and/or outputs the agent makes during its iterative operation Memory buffer: A code variable or object which is used to retain information on an AI agent's actions, interactions, observations, or any other relevant information to an AI agent's operation. Validation schema: a code object or function which is designed to ensure that input conforms to specific regulations as specified in the schema

In the present disclosure we detail an information hierarchy that is designed to be augmented into an AI agent's prompt to provide clear, organized, and modular information about the operational endpoints the agent is provided with as tools and scope of the agent's operation. This hierarchy is implemented as a series of code object which represent the following information.

The following parameters are used: The parameter object is designed to represent information and a series of restrictions around an individual parameter that is used in conjunction with an operational command (i.e. agent tool call). This includes the following information: Information on what the parameter represents in the context of the operational command which it is linked to. Information on data type or set of data types which the parameter should be input as or converted to prior to being used in the operational command Information on any types of restrictions around the contents of the parameter including but not limited to ranges, allowed values, list length, format, etc. Validators which enforce the above data type and/or content restrictions (optional). For information on how we implement validators, see our validation disclosure.

The following commands are used. The command object is designed to represent operational information about tools which the AI agent has access to use and/or observe results. This includes the following information: General information on what the tool does when it is called by the AI agent. Information on any parameters which can be provided to the tool as input. These parameters are represented as objects represented in list element 1. Information on what the tool returns, how it may be formatted, and how it can be interpreted if applicable Information on any additional commands which are operational prerequisites and/or post requisites to assist with logical planning of workflows.

The following workflows are used: The workflow object details either 1) a collection of commands with information on what order they should be executed in with specified inputs (if applicable) or 2) a schema which defines the desired workflow states as a collection of variables with defined transition rules defining changes in those variables. These can be augmented into the AI agents prompt dynamically at runtime to guide the agent on how a particular task can be approached. Linear workflows specific a list of commands which need to be followed in a particular order Non-linear workflows exist including workflows which follow a graph-based structure (flowchart) where information detailed in edges determine which command to select next based on previous observations. Schema based workflows follow the paradigm defined in the FSA-based memory disclosure

The following microservices are used: The microservice object details a set of commands which are a part of an individual system with a specific definition and scope. Agents are augmented with information about the microservice including General information on the microservice potentially including but not limited to what it is, what it does, when it should be used, its scope of use, etc. A set of variables which detail the current and potential states of the system represented by the microservice, if applicable (optional).

The following libraries are used: The library object details a set of command which spans across multiple systems with different scopes. This includes information on which microservices these commands belong to.

The following serializer is used: A code function or object method which is designed to convert code-based representations of the infrastructure components detailed in list elements 1-5 into a hierarchical text-based representation where infrastructure components which are nested in other infrastructure components (i.e. parameters in commands) retain this nesting in the text-based representation. This text-based representation can be provided to the infrastructure code objects during their constructure to rebuild a copy of the object at the time it was serialized to text. In general, this function is included as a method of the infrastructure object which it serializes, but it can be separate.

The following Methods for Serializable AI Agent Information Hierarchy are used: In this disclosure, we detailed a serializability pipeline for translating code-based representations of agentic infrastructure components to a corresponding text-based representations and then back to code-based representations.

This method is carried out using the following process: Serialization to Text-Based Representation The serialization function or method of the infrastructure object at the highest level of infrastructure hierarchy available is called, converting information stored in that object to a text-based representation (i.e. JSON format). If any infrastructure objects are nested in the current infrastructure object, their serialization functions are called, and the results are included in the results of the top-level infrastructure object. This process is repeated in a recursive manner down the hierarchy until an infrastructure object is reached without any nested infrastructure objects. This leads to the following recursive serialization definition for objects in our infrastructure. Base Case: An infrastructure object is reached which has no nested infrastructure objects contained in it. The information contained in this object is converted to a text-based representation and this information is returned. Recursive Case: An infrastructure object is reached which has nested infrastructure objects contained in it. The information contained in this object is formatted to a text-based information and any nested infrastructure objects have their serialization function or method called prior to returning the text-based information. Serialization to Code Object Representation The code object at the highest level of the infrastructure hierarchy which is being built via a constructor method or some of form of object initiation has text-based information in a specific format provided as input which it uses to build the code object. If information pertaining to any valid objects at a lower level of the hierarchy (allowed in the current level of the hierarchy) is present, the constructor calls the constructor of those lower-level objects and receives the object returned as output to assign at the current level. This process is repeated in a recursive manner down the hierarchy until text-based information corresponding to an infrastructure object contains no information about objects at a lower level of the hierarchy. This leads to the following recursive serialization definition for objects in our infrastructure. Base Case: Text-based information on an infrastructure object which contains no nested information on other infrastructure objects at lower levels of the hierarchy is encountered. This information is used to build the code object at the current level of the hierarchy and that object is returned. Recursive Case: Text-based information on an infrastructure object which contains nested information on other infrastructure objects at lower levels of the hierarchy is encountered. Nested information on objects at a lower level of the infrastructure hierarchy is passed to the corresponding constructor and the resulting code object created is returned to the current object and built into its code infrastructure as designed. The object at the current level of the infrastructure is returned once all nested object have been built and all other information has been assigned.

The next module is the Agentic Benchmarking Infrastructure. The following terminology definition help in understating this module. Text-based generative AI: A generative AI model which can generate large amounts of text with a high degree of structure and semantic coherence. An example of this would be a large language model (LLM). Generative AI chain: A process in where text-based generative AI model request-response pairs are chained together. Output parser: A code object or function which is designed to ensure that text-based generative AI output conforms to a certain format. AI agent: An exploratory entity, which iteratively operates, whose decision making is logically powered by text-based generative AI, has tools which the logic center can determine to be used to interact with other entities, and has memory which retains past information. Agentic operation: When the AI agent is iterative operating in a problem space or to accomplish some general tasks. Action path: The list of tool calls, inputs, and/or outputs the agent makes during its iterative operation Memory buffer: A code variable or object which is used to retain information on an AI agent's actions, interactions, observations, or any other relevant information to an AI agent's operation. Validation schema: a code object or function which is designed to ensure that input conforms to specific regulations as specified in the schema.

Various AI agent benchmarking apparatuses are disclosed herein which are designed to test the robustness of AI agent operation by iterative running a new copy of a specific agent on the same input and assessing how many times it accomplishes a desired goal (different depending on the type of benchmarking). There are some components that do not differ depending on the type of the infrastructure and there are other components which differ depending on the type of the infrastructure. We detailed the shared components which described the general agentic benchmarking infrastructure and then detail the types of benchmarks this infrastructure has been tested with.

Several components are shared among all types of agent benchmarking infrastructure initiator. The component include: A code function or object (or part therefor of) which is designed to either create a new copy of the AI agent in a specified initial state (prompt, tools, memory buffers, etc.) or reset the current copy of the AI agent to this state and contains the initial request which is provided to the agent as the start of each iterative run. Executor: A code function or object (or part therefor of) which provides the AI agent defined by the initiator with the request defined in the initiator. This starts the AI agent's operation on that request each time it is called. Objective Logger: A code function or object (or part therefor of) which is designed to extract and retain relevant information from the copy of the AI agent or associated system or workflow after iterative operation is complete. What information is extracted should remain general but in the unique components section we detail three different categories of information which we have implemented this for. Objective Comparer: A code function or object (or part therefor of) which is designed to compare information extracted from the AI agent post operation and compare it with one or more desired goals. These desired goals are designed to be generic, but we detail three categories of goals which we have implemented this for. Statistical Logger: A code function, object, or variable (or part therefor of) which records and/or calculates statistics about the accuracy of the agent's operation as it is benchmarked. This can include number of successful/failed objects throughout the benchmark or any other statistics which represent the accuracy or robustness of agentic operation throughout the course of the benchmark. Information Logger: A code function, object, or variable (or part therefor of) which records detailed information about agentic operation extracted via the extractor for each benchmark iteration. This information can be any generic information generate during or as a result of agentic operation but the three categories of information which we have implemented this for are the agent's final response, the final state of a state-based memory buffer or associated function, object, or variable which represents the final state of the workflow or system after agentic operation, and/or the action path or parts of the action path taken by the agent during agentic operation. This can retain the same information as the objective logger but not everything logged in the information logger is a benchmarking objective.

Several components that are also disclosed that are unique to different types of tested agent benchmarking infrastructure response based benchmarking. This type of benchmarking is designed to compare the final response of the AI Agent (final answer) with one or more final answers provided by the user as “correct” response using a generic text-based comparison metric. This metric could be a direct string comparison, regular expression matching, or some other metric of text similarity. These components are: Objective Logger: In this situation the Objective Logger is designed to capture the final response (final answer) of the AI agent after operation on the initial request is finished. Objective Comparer: The Objective Comparer uses the similarity metric to compare the extracted response of the AI agent with each of the desired response(s). State Based Benchmarking: This type of benchmarking is designed to compare the final state of an Agent's associated memory buffer or other associated entity representing the system or workflow with one or more of the final states provided by the user as “correct” final states using a state based schematic validation metric or code function or object or other validation metric. Objective Logger: In this situation the Objective Logger is designed to extract the final state of an AI Agent's memory buffer or associated entity representing the state of a system or workflow. Objective Comparer: The Objective Comparer runs the validation schema or any other forms of validation on the final state extracted by the Objective Logger. Path Based Benchmarking: This type of benchmarking is designed to compare the current AI agent's path of action (tool usage) to one or more of the action paths or partial action paths provided by the user as the “correct” action path. These action paths can be compared by any validation metrication including full and partial action path matching. Objective Logger: In this situation the Objective Logger is designed to extract the action path of the AI agent after operation is complete. Objective Comparer: The Objective Comparer runs some metric of action path comparison between the agent's action path and each of the desired action paths.

While there exist benchmarking applications for generative AI models (i.e. LLM benchmarking sets), this is the first such infrastructure for generative AI powered agents. These agents operate as dynamic, exploratory entities as opposed to static input/output entities as a generative AI model does, so the benchmarking infrastructure must account for the dynamic nature of the agents' exploratory process. While we present three tested applications of benchmarking, it could be applied to a combination of those three or any general criteria or combination of general criteria which results from agentic operation using the above infrastructure components.

Methods are also disclosed for Agentic Benchmarking Infrastructure. Agentic benchmarking infrastructure operates in the following manner. A new copy of the agent in it is initial state is created, or agent is reset to its initial state via the initiator. The executor starts agentic operation by providing the agent with the predefined initial request The agent operates through the request until it reaches a point where its logic center believes it has accomplished the task or can no longer continue operation The objective logger receives information from the agent or associated entities as defined in list element 3 and showcased in 7, 8, and 9 of the previous section. This information is sent to the objective comparer where comparison metrics and comparison metrics are run as defined in list element 4 and showcased in 7, 8, and 9 of the previous section. The statistical logger retains information based on the results of the comparison metrics calculated by the objective comparer as detailed in list element 5 of the previous section. The information logger is updated with any additional information requested including information agent's output, system or workflow state, or agentic action path as detailed in list element 6 of the previous section. This process defined in steps 1-7 can be run n times providing the user with the benchmarking results. If all these components are saved off (i.e. built as a Python object) the benchmarking can be started and stopped as needed, saving of the benchmarking results at the end of each iteration. The statistical and information loggers can be reset to refresh the results of the benchmark if desired.

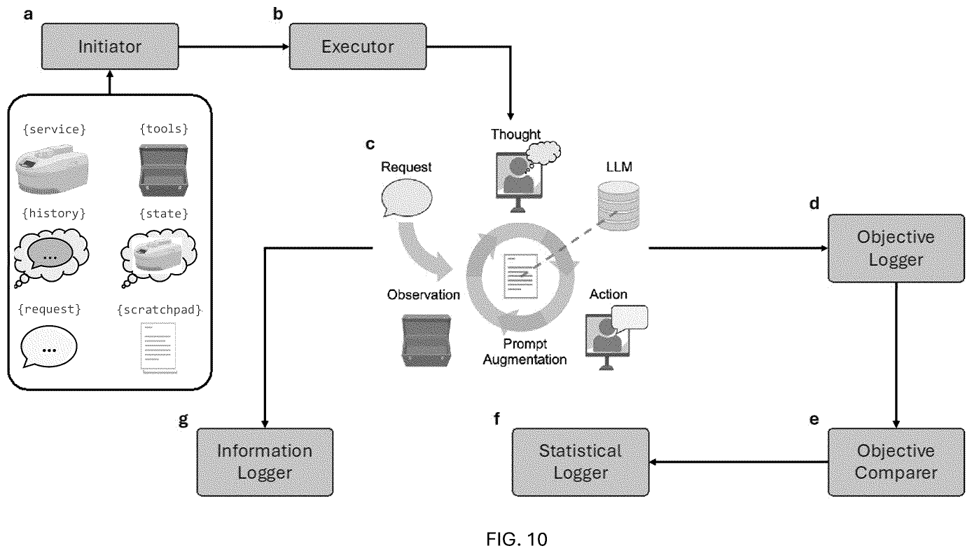

Reference is made to FIG. 10 which provides an overview schematic of the agentic benchmarking infrastructure including the initiator (identified as (a)) which defines the initial state of the agent and provided request, the executor (identified as (b)) which starts agentic operation with conditions defined in the initiator, the current iteration of agentic operation (identified as (c)), the objective logger (identified as (d)) which stores information which results from the current iteration of agentic operation, the objective comparer (identified as (e)) which runs comparison metrics between desired output and selected agentic output, the statistical logger (identified as (f)) which calculates statistics based on objective comparison metrics or agentic output, and the information logger (identified as (g)) which captures information during or as a result of agentic operation.

The process defined in this schema can be repeated n times. The purpose of this is to track the robustness of agentic operation across multiple runs with the same input.

The statistical logger and information logger retain information across individual agentic benchmarking runs. This gives a complete picture of robustness across multiple benchmarking iterations.

Reference is also made to FIGS. 4a-4c, which as discussed above, show the three types of agentic benchmarking implemented using this infrastructure including response-based benchmarking (FIG. 4a), state-based benchmarking (FIG. 4b), and path-based benchmarking (FIG. 4c). Each of type of benchmarking goes through the same basic steps including 1) defining the desired output(s), 2) recording information and output from agentic operation, and 3) comparing relevant output with desired output(s).

The next module of the present disclosure is the AI Agents as Prompt Engineers. The following terminology definitions can help in the disclosure of this module. Text-based generative AI: A generative AI model which can generate large amounts of text with a high degree of structure and semantic coherence. An example of this would be a large language model (LLM). Generative AI chain: A process in where text-based generative AI model request-response pairs are chained together. Output parser: A code object or function which is designed to ensure that text-based generative AI output conforms to a certain format. AI agent: An exploratory entity, which iteratively operates, whose decision making is logically powered by text-based generative AI, has tools which the logic center can determine to be used to interact with other entities, and has memory which retains past information. Agentic operation: When the AI agent is iterative operating in a problem space or to accomplish some general tasks. Tool call: When the logical center of the AI agent provides text-based output which is then translated by some interpreter that executes a code-based function based on the information contained in that text-based output Action path: The list of tool calls, inputs, and/or outputs the agent makes during its iterative operation Memory buffer: A code variable or object which is used to retain information on an AI agent's actions, interactions, observations, or any other relevant information to an AI agent's operation. Validation schema: a code object or function which is designed to ensure that input conforms to specific regulations as specified in the schema

In this disclosure, we detail how AI agents can be used to engineer generative AI prompts in a dynamic manner in lieu of human based prompt engineering. This process involves combining a variety of information retention and summarization components classes with agentic operation and tools usage. This approach allows for agents to perform exploratory analysis throughout a problem space and use information from this exploratory process to learn how to approach certain problems, retain this information, and modify its prompt to better approach similar problems in the future.

This goal can be accomplished by an agent system which uses these components in the following manner. I/O Logging: The input/output logging is a way to keep track of AI agent inputs and corresponding responses for each request. Tool Logging: A text-based log that includes operation information of the AI agent which is dynamically updated as the agent operates though a problem space. This log should include the tool used, the input to the tool used, the output which the tool provides upon successful execution, and any errors which the tools provide upon unsuccessful operation. Information Extraction Chains: Information extraction chains are chains which are designed to extract, summarize, and organize information which is contained in input/output or tool usage buffers. This is used at the end of agentic exploration to take the information contained in I/O and tool logging and extract and summarize relevant information contained in these buffers. This extracted information can be provided in agent memory but does not have to be augmented directly back into the agent. Instead, it can be transferred to other entities (i.e. documentation embedding) and be accessed by the agent in another manner.

Since the agent is retaining information on what is has done and what is has observed, the agent is engineering its own prompt as it explores though a problem space. However, because LLMs (which logically power the agent's decision-making abilities) have a finite number of tokens which can be submitted in each request, it is not feasible to keep directly augmenting the agents prompts with this information as it iteratively builds up. Even if the token limit is not reached, the amount of information contained in these buffers can contain too much context that the LLM cannot properly process this information in a useful manner. In the methods, we detail different ways in which the agent can engineer its own prompt including methodology which restricts the amount of context which the LLM receives. This approach differs for traditional LLM prompt engineering approaches where either a human goes through and manually updates prompts to provide additional context or prompts are augmented with information from 3rd party sources (i.e. search engine search results) as the LLM itself is determining how the prompt is engineered via its actions as the logical processing center of the AI agent. Using information extraction chains, this information is filtered after agentic operation to retain more relevant information and reduce unnecessary context from being provided in further agentic operation. According to one method of the present disclosure, we detail how AI agents can engineer their own prompt including ways in which context can be limited. Agentic Prompt Engineering: Agentic prompt engineering is a process where an AI agent engineers its own prompt by recording information on interactions, thoughts, actions, observations, errors, and any other component of information which the AI agent encounters during an exploratory process and retaining or accessing part or all this information in future exploratory processes to improve performance. Windowed Context: Windowing context involves taking only n of the last m agent request-response pairings and/or agent tool usage operations and providing that information to the agent or agent extraction chain for future use. This provides a hard cutoff in agent prompt engineering and forces agents to only including recent information in prompt engineering. Information Summarization: Information summarization involves passing request-response pairings or agent tool usage operations to a subsequent LLM chain which is designed to summarize this information for subsequent use in agentic operation. This allows for agents to engineering their own prompts but provides the results in a summary-based manner instead of a log of interactions, actions, response, etc.

Additionally, graph or Schema Based Methods are disclosed. These methods involve taking request-response pairings and/or agent tool usage operations and converting them to a graph-based data structure or schema which represents this information in a structure manner. This can include knowledge graph embedding where this information is converted into relational tuples and built into a knowledge graph and schematic conversion where information is restructured to fit a specific schema which is relevant to the problem at hand.

The next module is the AI Agent Management Hierarchy. The following terminology assist in understanding the disclosure. Text-based generative AI: A generative AI model which can generate large amounts of text with a high degree of structure and semantic coherence. An example of this would be a large language model (LLM). Generative AI chain: A process in where text-based generative AI model request-response pairs are chained together. Output parser: A code object or function which is designed to ensure that text-based generative AI output conforms to a certain format. AI agent: An exploratory entity, which iteratively operates, whose decision making is logically powered by text-based generative AI, has tools which the logic center can determine to be used to interact with other entities, and has memory which retains past information. Agentic operation: When the AI agent is iterative operating in a problem space or to accomplish some general tasks. Tool call: When the logical center of the AI agent provides text-based output which is then translated by some interpreter that executes a code-based function based on the information contained in that text-based output Action path: The list of tool calls, inputs, and/or outputs the agent makes during its iterative operation Memory buffer: A code variable or object which is used to retain information on an AI agent's actions, interactions, observations, or any other relevant information to an AI agent's operation. Validation schema: a code object or function which is designed to ensure that input conforms to specific regulations as specified in the schema.

In this disclosure, we detail a hierarchical way to facilitate communication between AI agents that keeps agents siloed in operation within their scope but still aware of relevant context of other agents that operate in conjunction as a part of a larger system. This can be accomplished using the defined agent connectivity system recursively defined as follows: (1) Leaf Agent: A leaf agent is defined as an agent which does not communicate with any other agents at a lower level of operational abstraction than itself. Leaf agents are terminal nodes in the agentic hierarchy tree and are primarily responsible for operating within their own scope and domain. These agents are considered “sandboxed” from other leaf agents and can only access information from other agents via asking the manager agent (as described herein with respect to Manager Agent). Memory: These agents can read from and write to both operational memory and theoretical memory buffers belonging to the leaf agent (if implemented with memory). Tools: These agents generally contain operational tools for a service or collection of services which they are responsible for controlling. The agent is directly responsible for using these tools. Embedding Access: Tools can be built which communicate with embedding chains if desired. If using embeddings, these agents should contain a subset of documentation that is most relevant to operational and theoretical usage of systems and protocols directly in their purview. Manager Agent: A manager agent is defined as an agent which communicates with one or more agents (leaf or manager) at a lower level of operational abstraction than itself using tools which provide requests to those agents. These agents are interior nodes in the agentic hierarchy tree and are primarily responsible for facilitating communication between agents one level down in the agentic hierarchy tree. Memory: These agents can read from both operational and theoretical memory buffers of agents which are at a lower level of the abstraction but cannot write to these buffers. This allows for manager agents to know the context of sublevel agents but not directly modify that context without going through the appropriate sublevel agent. This agent can be implemented with memory of its own that it can read and write from. Tools: This agent can be implemented with tools of its own to allow for operational usage outside of using a leaf agent, but this adds operational overhead to this agent in addition to acting as an information facilitator and thus may hurt performance. It is recommended that the tools which manager agents are provided with be limited to (c) Embedding Access: This agent can be provided with tools which access separate embeddings than agents at sublevels. In general, these embeddings would be a conceptual superset of documents in sublevel embeddings but documents that are overly technical could be removed or documents which provide big picture goals could be added. Root Agent: The root agent is defined as the agent which has no agents which communicate with this agent residing at a higher level of abstraction than itself. This agent is generally a manager agent but can be a leaf agent if the size of the system is 1 (this agent would be both a root and leaf agent). This agent behaves similar to the primary categorization of the agent (leaf or manager) but it serves at the initial entry point of questions into the system unless specified otherwise. This system is designed to operate in a controlled and hierarchal manner in addition to providing fine grained control over operation, testing, and debugging. This can be accomplished by using the infrastructure defined in the infrastructure section of this disclosure with the following process rules in place. Initiating Agent Instruction: This handles how the agent system is provided with initial instructions. Requests would generally go in at the root agent unless the user knows and specifies that the request should go to a specific manager or leaf agent at a lower level of abstraction. Agent System Operation: Agents can either operate in a synchronous or asynchronous manner and this is a user choice based on the system and tasks which the system is designed to accomplish. Synchronous: In synchronous operation, each tool call made system happens in order with the next tool call occurring after the previous tool call finishes. In systems with a high degree of structure, this may be a good option as it ensures that command execution order is controlled. Asynchronous: In asynchronous operation, tool calls are made on separate threads or processes, allowing for them to be run in the background while the agent system continues operation in the foreground. This allows for multiple tools calls to be submitted concurrently and can provide speed benefits for tasks which can be performed in parallel. The downside is that agents must manage these tasks in parallel which could cause problems. Agent Sandboxing: Leaf agents are considered sandboxed as they operate in relative isolation from one another with all communication going through a managing intermediary (manager agent at root or superlevel). The purpose for this is twofold: (a) Agentic Isolation: Agents operate in relative isolation to one another; unaware what other agents have done in the system unless that information is provided via the managing intermediary. This is by design as for larger system, the context window of individual agents can be flooded by large amounts of irrelevant context. Controlled Communication: This provides a controlled system of communication for agents. A n-to-n communication system where each agent can communicate with all other agents does not scale well for larger systems as each agent needs to keep track of all communication options. In this system, information requests can be returned to the managing agent at the superlevel or submitted to the root agent at the top of the tree and directed to the appropriate subagent.

It should be Noted that, alternatively, we can provide a separate infrastructure where each agent is given a communication tool which submits their questions to a separate system which manages communication between agents. This could work well in cases where backtracking or repropagating requests through the root is too time consuming. Agent Testing, Benchmarking, and Debugging: This system excels at agentic testing, benchmarking, and debugging because requests can easily be run on individual agents or subsets of the agentic hierarchy separately which can iteratively be built back to the whole system. This allows for any type of testing, benchmarking, and debugging to be done in a bottom-up manner which provides more fine-grained control. If a task being (partially) performed correctly level n of the system but fails at level n+1, debugging would be applied at that level. This provides a much-needed controlled debugging paradigm to agent-to-agent communication systems.

Uncertainty and Confirmation: While agents are working on a particular task, there may be times where the agents in the system become uncertain on how to proceed or required confirmation that a certain prerequisite has occurred prior to continuing operation. This can be handled in the following manner: (1) Handling Uncertainty/Confirmation via Hierarch: If an agent becomes uncertain or needs confirmation on how to proceed during operation, it should return that it is unsure on how to proceed and include as much information as possible as to why it is usure and what information it needs. This request will be provided to the managing agent that resides one level up (superlevel) which can then ether uses its own knowledge or pass the request to an agent or agents at a sublevel which may be able to provide information or clarification. If the managing agent, it still uncertain about the request it can return the request to the managing agent at its superlevel (if applicable). Handling Uncertainty/Confirmation via Human Intervention: There may be situations where the system itself cannot resolve the uncertainty in a request or provide confirmation because the information which it needs resides outside the purview of what the agents have access to. In this situation, human intervention can be applied either at the root agent or at specific managing agents. Leaf agents generally should not communicate with humans as it could overload the humans with requests that can be answered by another part of the system.

The next module is Tool-Memory Categorization and Filtration. The following Terminology definitions assist in understanding the disclosure. Text-based generative AI: A generative AI model which can generate large amounts of text with a high degree of structure and semantic coherence. An example of this would be a large language model (LLM). Generative AI chain: A process in where text-based generative AI model request-response pairs are chained together. Output parser: A code object or function which is designed to ensure that text-based generative AI output conforms to a certain format. AI agent: An exploratory entity, which iteratively operates, whose decision making is logically powered by text-based generative AI, has tools which the logic center can determine to be used to interact with other entities, and has memory which retains past information. Agentic operation: When the AI agent is iterative operating in a problem space or to accomplish some general tasks. Tool call: When the logical center of the AI agent provides text-based output which is then translated by some interpreter that executes a code-based function based on the information contained in that text-based output Action path: The list of tool calls, inputs, and/or outputs the agent makes during its iterative operation Memory buffer: A code variable or object which is used to retain information on an AI agent's actions, interactions, observations, or any other relevant information to an AI agent's operation. Validation schema: a code object or function which is designed to ensure that input conforms to specific regulations as specified in the schema.

In this disclosure, we detail a code infrastructure for AI agent tool and memory categorization which is designed to promote a high degree of customization and targeted information retention in agentic memory buffers. This is accomplished using the two infrastructure components detailed as follows. (1) Tool Tagging: Tool tagging involves assigning one or more categorical labels known as “tool tags” to a tool which is used by an AI agent. The value (name) of the tool tag needs to correspond to one or more “memory tags” defined in list element 2. This tag can be built into the tool object in the form of an object attribute, or the agent can retain a list, dictionary, set or other type of pairing apparatus which correlations agentic tools with their corresponding tool tag(s). (2) Memory Tagging: Memory tagging involves assigning one or more categorical labels known as “memory tags” to a memory class which is used by an AI agent. The value (name) of the memory tag must correspond to one or more “tool tags”. The memory buffer may also contain a context header which denotes additional instructions on the scope of the memory class and this context header is provided before the rest of the buffer contents as additional information. Upon updating operation of the memory buffer, the memory class is only provided with information on tools (usage, inputs, outputs, etc.) used with matching tags as provided by the filter (see list element 3). The memory class then updates in a generic manner with information on the filtered list of tools used. (3) Filter: The filter is a code function or object method which is designed to filter the action path (list of agent tool calls) based on a set of provided tags. It is generally included as an object method of a memory class which is using this infrastructure. The set of tags is generally provided as the list of memory tags of the memory class. The filter goes through the list of tool calls provided and filters out any tools which do not have tags that match the provided tags. This results in a list of tools filtered by tags being provided as output of the filtration function or method.

While there is a wide degree of memory classes available for AI agents, this infrastructure is not designed to be an alternative memory class, but instead a protocol which can work in conjunction with any generic memory class. For example, if the user chooses to use a logging-based memory class which is designed to retain a word-by-word log of information passed into the memory buffer, and the tool calls are passed in as a log, this memory class is designed to filter out (using the filter) any tools which do not have tags corresponding to the memory class and thus are assumed to not be relevant to the information retention that specific memory class is designed for. Multiple memory classes with different sets of tags can exist, providing the AI agent with a series of different memory buffers each with a different scope and context.

While we have built this memory class to be generic, an example usage in our agentic infrastructure is to filter out operational tools (interact with a system or instrument) from knowledge-based tool (asking a human, searching a database for information, etc.) to create separate memory buffers corresponding to what was done operationally and what was learned theoretically.

In this disclosure, we detail a process designed to organize and filter information on AI agent tool usage into different memory buffers based on the user defined scope and context of the memory buffer. This can be accomplished in the following manner: (1) Create one or more memory buffers with a provided filter function or method, a set of memory tags, and a context header which will appear before the rest of the buffer contents when augmented into the AI agent prompt. (2) Create a set of tools which the AI agent will have access to and tag each tool with zero or more tags which correspond to memory classes which those tools will be filtered for. (3) Allow for the agent to undergo iterative operation and use tools as needed to accomplish some request, task, etc. Save off the action path which the agent uses to accomplish this. (4) Prior to updating each memory buffer, pass in the action path to the memory buffers filter where the filter removes information on all tools which do not match one of the tags of the memory buffer. (5) Pass that filtered action path to the memory buffer when it applies its own internal update methodology. (6) Prior to the next set of agentic iterations, the agentic prompt is augmented with the context header and the contents of the memory buffer. Steps 1 and 2 are initial steps that are only performed once upon agentic construction. Steps 3-6 can be repeated n times as the agent repeatedly operates to explore problems, accomplish tasks, etc.

The next module is Agentic Tool Input Validation Hierarchy. The following terminology definition assist in understanding disclosure of this module. Text-based generative AI: A generative AI model which can generate large amounts of text with a high degree of structure and semantic coherence. An example of this would be a large language model (LLM). Generative AI chain: A process in where text-based generative AI model request-response pairs are chained together. Output parser: A code object or function which is designed to ensure that text-based generative AI output conforms to a certain format. AI agent: An exploratory entity, which iteratively operates, whose decision making is logically powered by text-based generative AI, has tools which the logic center can determine to be used to interact with other entities, and has memory which retains past information. Agentic operation: When the AI agent is iterative operating in a problem space or to accomplish some general tasks. Tool call: When the logical center of the AI agent provides text-based output which is then translated by some interpreter that executes a code-based function based on the information contained in that text-based output Action path: The list of tool calls, inputs, and/or outputs the agent makes during its iterative operation Memory buffer: A code variable or object which is used to retain information on an AI agent's actions, interactions, observations, or any other relevant information to an AI agent's operation. Validation schema: a code object or function which is designed to ensure that input conforms to specific regulations as specified in the schema

In this disclosure, we detail a validation hierarchy designed to provide flexible validation for information which is input by an AI agents generative AI logic center to the agent's tools. All components of the validation infrastructure are called prior to the input entering the tool function to provide an initial layer of validation prior to tool calls and help ensure that input created by generative AI follows certain requirements. They are also designed to provide descriptive text-based error/warnings to the LLM in the event of partial or unsuccessful validation. The agent can be provided with error information as feedback from an unsuccessful tool call to allow for it to correct its course of action. Most validation components of this infrastructure can be created by generative AI by providing a generative AI chain with information on how to structure output which defines certain types of requirements and restrictions which are used during validation. It is also possible for generative AI to select from a set of predefined validators by augmenting an AI chain's or agent's prompt with information on the validators and providing a description of what type of validation is needed. (A) Simple Validators: Simple validators are functions or code objects which place one or more data type or data value validation constraints on input fields of a tool which will have generative AI provide the input to that field. These validators are built for commonly used data types include integers, floats, strings, and Booleans. Due to the highly structure nature of these validators and how they behave, the validators themselves can dynamically be built by generative AI. This is accomplished by provided a schema of the validation constraints to a text-based generative AI model via the prompt and then parsing and transferring the output to the code object or function which defines the validator.

Example of these types of validators are provided as follows: (1) Ensure instrument temperature set by an agent is an integer between 50 and 80 degrees Celsius→Validate data type integer, lower limit 50, upper limit 80. Example Errors “Incorrect data type provided after casting, received string expected integer,” “Provided value above upper limit 80, must be between 50 and 80 degrees C.” (2) Ensure a calculation result provided by the agent is positive and has 3 digits of precision→Validate data type float, lower limit 0, round to 3 decimal places. (3) Ensure a pressure setting provided by the agent is either low, medium, or high→Validate data type string, allowed values are “low”, “medium”, “high” Example Errors “Incurred value provided 2 atm, expected either “low”, “medium”, or “high.”” (B) Custom Validators: Custom validators are a form of simple validators which are manually implemented by providing a function or object method which performs validation on an expected input. These validators are significantly more flexible than simple validators but are far less structured. To have generative AI construct the validators, the generative AI would write the python code for the validator function and append this code to the custom validator. For best security practices the execution of this code may want to be sandbox with the agent input provided to the sandbox. Validate a system configuration JSON file to ensure all keys and values match allowed configurations. Provide a custom python function which either validates the JSON against a schema or recursively searches through the JSON validating the key-value parings. Validate a provided molecular string conforms to SMILES format→Provide a custom python function which runs SMILES string expression validation against the provided string.

(C) Complex Validators: Complex validators are a form of recursive validators which contain one or more nested complex, simple, or custom validators in addition to simple validation constrains on a field which AI agents provide input to. These validators make recursive validation calls on each nested validator once input has been provided, passing components of the input into those nested validators. It is possible to have these nested validators built by generative AI by having the AI build individual validators in either a top down or bottom-up manner. Limitations will exist based on the complexity of the request and the power of the generative AI model used to fulfill the request. These validators contain an error bank which accumulates errors of nested validators. (1) Ensure a list representing a bit vector has 25 elements which are floats between −1 and 1→Validate list length is 25, use nested simple validator to validate all list elements fall in the described range. (2) Example Errors “List had 30 elements; the list size must be 25 elements.” (2) Ensure a table-based (i.e. CSV) instrument configuration file has 4 columns named, temperature, pressure, duration, and vial type and all columns are of equal length. Ensure that temperature is a whole number between 50 and 80 degrees C., pressure is a whole number between 1 and 10 atm, duration is a whole number between 30 and 3600 seconds, and vial type is either round or conical.→Validate file has 4 columns with names temperature, pressure, duration, and vial type, and that all columns have the same length. Use nested simple validators to validate constraints on temperature (int), pressure (int), duration (int), and vial type (string). Example Errors include “Missing column vial type, specify vial types as either round or conical in this column,” “Temperature column has a cell out of the allowed value range, all temperatures must be between 50 and 80 degrees Celsius.”

(D) Validation Error Wrappers: While some errors can be descriptive yet concise enough directly from the error call, certain errors for specific validators (such as custom validators) may come back as raw error code. This output can be wrapped by a generative AI chain whose prompt instructions direct it to analyze the raw error and provide this feedback to the AI agent so that the AI agent does not have to analyze the raw output in the process of operation.

While there are validation libraries which exist and we even use in the implementation of architecture, the novelty in this architecture lies in 3 main aspects: (1) Validation of input to tools of AI agents with a provision of descriptive error message upon failed validation so that agents can “debug” incorrect operation. (2) Construction of custom validators using generative AI to define validation components either via a schema (or nested schema) or generation of code which is run as the validation function. (3) Selection of validators from a predetermined set of validators by augmenting generative AI prompts with validator information and users providing requestions on validation needs.

The validations described in the previous section of this disclosure operate in a recursive manner as laid out in the following process defined by the recursive algorithm laid out below: Base Case: A validator with no nested validators (simple or custom) is encountered during validation of some input X. This validator is run on X providing any error during failed validation. Recursive Case: A validator with one or more nested validators (complex) is encountered during validation of some input X. This validator runs X against its top-level validators return any errors which are encountered. If no errors are encountered, it calls the validation methods of nested validators on certain subcomponents of X and collects any errors which are returned from these nested validators in its error bank. If the error back is not empty, it returns an error with all messages in the error bank included. If not, the validation was successful.

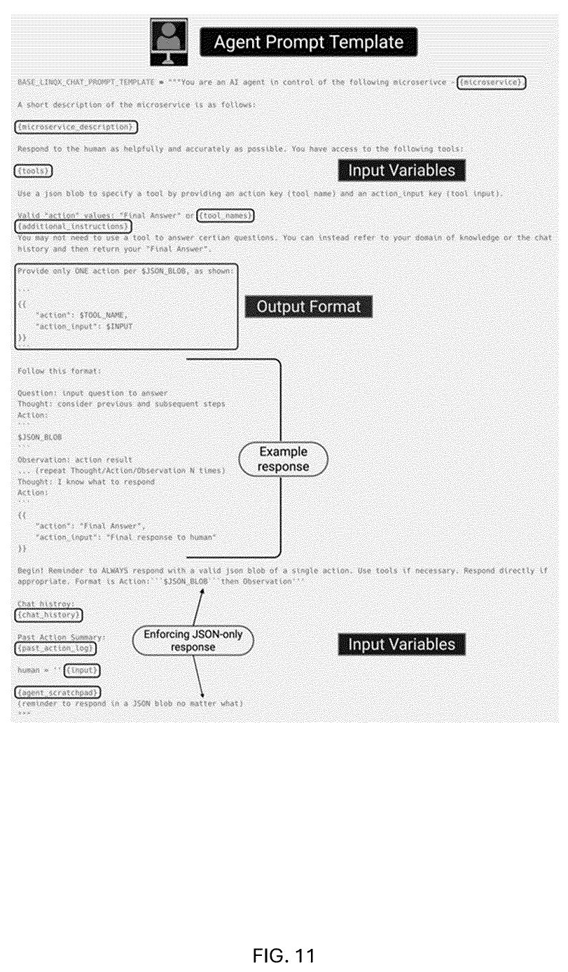

Reference is made to FIG. 11 which provides an example of a structure of the dynamic base prompt template used for making SciBORG Agents. Input variables appear in yellow bounding boxes; they will be filled in at runtime to enable flexible agent creation. The output format is marked by a blue bounding box; it defines how the agent's response must be structured. A generic example response is included for clarity; it is not tied to any specific domain but demonstrates the required format.

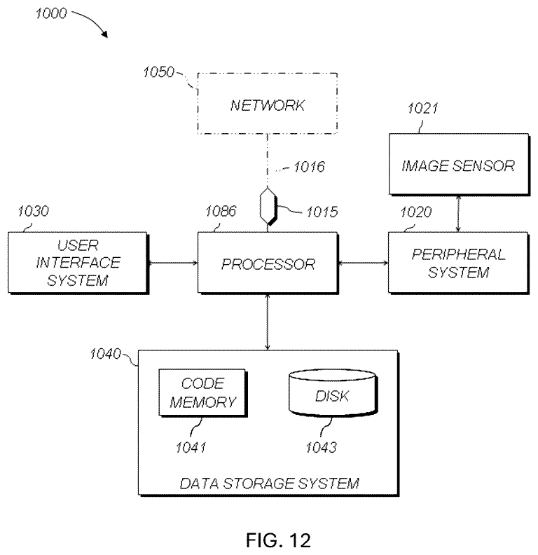

The processes described herein are performed and undertaken by one or more processing systems each including one or more processors executing software resident on non-transient memory. An example of such a processing system is provided in FIG. 12. Referring to FIG. 12, an example of a processing system is provided that can carry out the above processes. Referring to FIG. 12 a high-level diagram showing the components of an exemplary data-processing system 1000 for analyzing data and performing other analyses described herein, and related components. The system includes a processor 1086, a peripheral system 1020, a user interface system 1030, and a data storage system 1040. The peripheral system 1020, the user interface system 1030 and the data storage system 1040 are communicatively connected to the processor 1086. Processor 1086 can be communicatively connected to network 1050 (shown in phantom), e.g., the Internet or a leased line, as discussed below. The imaging described in the present disclosure may be obtained using imaging sensors 1021 and/or displayed using display units (included in user interface system 1030) which can each include one or more of systems 1086, 1020, 1030, 1040, and can each connect to one or more network(s) 1050. Processor 1086, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 1086 can implement processes of various aspects described herein. Processor 1086 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. Processor 1086 can include Harvard-architecture components, modified-Harvard-architecture components, or Von-Neumann-architecture components.

The phrase “communicatively connected” includes any type of connection, wired or wireless, for communicating data between devices or processors. These devices or processors can be located in physical proximity or not. For example, subsystems such as peripheral system 1020, user interface system 1030, and data storage system 1040 are shown separately from the data processing system 1086 but can be stored completely or partially within the data processing system 1086.

The peripheral system 1020 can include one or more devices configured to provide digital content records to the processor 1086. For example, the peripheral system 1020 can include digital still cameras, digital video cameras, cellular phones, or other data processors. The processor 1086, upon receipt of digital content records from a device in the peripheral system 1020, can store such digital content records in the data storage system 1040.

The user interface system 1030 can include a mouse, a keyboard, another computer (connected, e.g., via a network or a null-modem cable), or any device or combination of devices from which data is input to the processor 1086. The user interface system 1030 also can include a display device, a processor-accessible memory, or any device or combination of devices to which data is output by the processor 1086. The user interface system 1030 and the data storage system 1040 can share a processor-accessible memory.

In various aspects, processor 1086 includes or is connected to communication interface 1015 that is coupled via network link 1016 (shown in phantom) to network 1050. For example, communication interface 1015 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 1015 sends and receives electrical, electromagnetic or optical signals that carry digital or analog data streams representing various types of information across network link 1016 to network 1050. Network link 1016 can be connected to network 1050 via a switch, gateway, hub, router, or other networking device.

Processor 1086 can send messages and receive data, including program code, through network 1050, network link 1016 and communication interface 1015. For example, a server can store requested code for an application program (e.g., a JAVA applet) on a tangible non-volatile computer-readable storage medium to which it is connected. The server can retrieve the code from the medium and transmit it through network 1050 to communication interface 1015. The received code can be executed by processor 1086 as it is received or stored in data storage system 1040 for later execution.

Data storage system 1040 can include or be communicatively connected with one or more processor-accessible memories configured to store information. The memories can be, e.g., within a chassis or as parts of a distributed system. The phrase “processor-accessible memory” is intended to include any data storage device to or from which processor 1086 can transfer data (using appropriate components of peripheral system 1020), whether volatile or nonvolatile; removable or fixed; electronic, magnetic, optical, chemical, mechanical, or otherwise. Exemplary processor-accessible memories include but are not limited to registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 1040 can be a tangible non-transitory computer-readable storage medium, i.e., a non-transitory device or article of manufacture that participates in storing instructions that can be provided to processor 1086 for execution.

In an example, data storage system 1040 includes code memory 1041, e.g., a RAM, and disk 1043, e.g., a tangible computer-readable rotational storage device such as a hard drive. Computer program instructions are read into code memory 1041 from disk 1043. Processor 1086 then executes one or more sequences of the computer program instructions loaded into code memory 1041, as a result performing process steps described herein. In this way, processor 1086 carries out a computer implemented process. For example, steps of methods described herein, blocks of the flowchart illustrations or block diagrams herein, and combinations of those, can be implemented by computer program instructions. Code memory 1041 can also store data or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects. These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 1086 (and possibly also other processors), to cause functions, acts, or operational steps of various aspects herein to be performed by the processor 1086 (or other processors). Computer program code for carrying out operations for various aspects described herein may be written in any combination of one or more programming language(s) and can be loaded from disk 1043 into code memory 1041 for execution. The program code may execute, e.g., entirely on processor 1086, partly on processor 1086 and partly on a remote computer connected to network 1050, or entirely on the remote computer.

Those having ordinary skill in the art will recognize that numerous modifications can be made to the specific implementations described above. The implementations should not be limited to the particular limitations described. Other implementations may be possible.

1. An artificial intelligence (AI) agentic platform, comprising:
a processor executing software a non-transient memory, the processor configured to:
establish a plurality of AI agents, the plurality of AI agents are adapted to:
receive a query related to a task from an external entity;
establish a hierarchy amongst the plurality of agents for accomplishing the task;
identify a plurality of sub-tasks to be performed by each agent of the plurality of agents in service of performing the task;
assign an agent of the plurality of agents to each sub-task of the plurality of sub-tasks;
each agent identifies one or more tools to accomplish the associated sub-task;
identify states within each sub-task of the plurality of sub-tasks;
apply a finite state automaton-based memory management to the identified states for a deterministic state tracking;
generate an output by each agent assigned to an associated sub-task; and
benchmark each agent based on the associated generated output, the tool identification, and a path the associated agent took amongst the identified states within said sub-task.

2. The AI agentic platform of claim 1, wherein the plurality of agents are passed through an intermediary interpreter using an agnostic programming environment.

3. The AI agentic platform of claim 1, wherein inputs to the identified tools are validated by a validator.

4. The AI agentic platform of claim 1, wherein prompts used in communication with the external entity are automatically iterated to engineer prompts that are compatible with one or more large language models (LLMs).

5. The AI agentic platform of claim 1, further comprising classifying tools into one or more classes of tools, wherein each tool class is then coupled with an associated memory.
